(19) United States
(12) Patent Application Publication
(10) Pub. No.: US 2025/0047560 A1
(43) Pub. Date: Feb. 6, 2025

(54) APPARATUS, SYSTEM, AND METHOD OF CONFIGURING A NETWORK

(71) Applicant: OPTIMALNETS LTD, Modiin-Macabim-Reut (IL)

(72) Inventor: Lior Asher Friedman, Modiin-Macabim-Reut (IL)

(73) Assignee: OPTIMALNETS LTD, Modiin-Macabim-Reut (IL)

(21) Appl. No.: 18/788,260

(22) Filed: Jul. 30, 2024

Related U.S. Application Data
(60) Provisional application No. 63/517,056, filed on Aug. 1, 2023.

(51) Int. Cl. H04L 41/0816; H04L 43/0876

(52) U.S. Cl. CPC H04L 41/0816; H04L 43/0876

(57) ABSTRACT

For example, a network configuration controller may monitor a plurality of node-related flow information sets based on flow information corresponding to a plurality of data flows via a network, the plurality of node-related flow information sets corresponding to a plurality of networking nodes connecting between a plurality of network inputs of the network and a plurality of network outputs of the network. For example, a node-related flow information set corresponding to a networking node of the plurality of networking nodes may include information corresponding to one or more data flows communicated via the networking node. For example, network configuration controller may determine a network-configuration setting to configure the network based on the plurality of node-related flow information sets and at least one target End to End (E2E) performance parameter corresponding to an E2E performance of the plurality of data flows.

### CROSS REFERENCE

This application claims the benefit of, and priority from, U.S. Provisional Patent Application No. 63/517,056 entitled “End to End Predictive Network Optimization based on AI”, filed Aug. 1, 2023, the entire disclosure of which is incorporated herein by reference.

### BACKGROUND

Various types of systems may utilize one or more types of networks to communicate data between devices.

For example, the Internet may be considered as a huge network having an infrastructure, which is dominated by several main global cloud providers and regional Telephone companies (Telcos) and/or Internet Service Providers (ISPs).

For example, Content Application Providers (CAP) may generate internet traffic, which may be communicated to and/or from end consumers, e.g., home\mobile users.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a conceptual illustration of a Machine Learning (ML) based network-configuration scheme, in accordance with some demonstrative aspects.

FIG. 3 is a schematic illustration of a ML-based network-configuration system, in accordance with some demonstrative aspects.

FIG. 4 is a schematic illustration of a system including a network configuration controller to controllably set a configuration of a network, in accordance with some demonstrative aspects.

FIG. 5 is a schematic illustration of a computing cluster, in accordance with some demonstrative aspects.

FIG. 6 is a schematic illustration of a buffer occupancy scheme to illustrate the occupancy of physical buffers of a plurality of networking nodes and corresponding flow control signals, in accordance with some demonstrative aspects.

FIG. 7 is a schematic illustration of a system including a network configuration controller to controllably set a configuration of at least one communication network, in accordance with some demonstrative aspects.

FIG. 8 is a schematic illustration of components of a network configuration controller to controllably set a configuration of at least one communication network, in accordance with some demonstrative aspects.

FIGS. 9A, 9B, 9C, 9D, 9E and 9F are conceptual illustrations of states of a system implementing a network configuration controller, in accordance with some demonstrative aspects.

FIG. 10 is a schematic flow-chart illustration of a method of configuring a network, in accordance with some demonstrative aspects.

FIG. 11 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled, directly or indirectly, to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may include one or more wired or wireless links, may utilize one or more components of wireless communication, may utilize one or more methods or protocols of wireless communication, or the like. Some aspects may utilize wired communication and/or wireless communication.

Some aspects may be implemented by one or more elements of a computing system including one or more computing devices.

For example, a computing system may be implemented using suitable hardware components and/or software components, for example, processors, controllers, memory units, storage units, input units, output units, communication units, operating systems, applications, or the like.

In some demonstrative aspects, the computing system may include, for example, one or more of a processor, an input unit, an output unit, a memory unit, and/or a storage unit. The computing device may optionally include other suitable hardware components and/or software components. In some demonstrative aspects, some or all of the components of one or more of the computing device may be enclosed in a common housing or packaging, and may be interconnected or operably associated using one or more wired or wireless links. In other aspects, components of the computing device may be distributed among multiple or separate devices.

In some demonstrative aspects, the processor may include, for example, a Central Processing Unit (CPU), a Graphics Processing Unit (GPU), an Auxiliary Processing Unit (xPU), a Neural Processing Unit (NPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller.

In some demonstrative aspects, the input unit may include, for example, a keyboard, a keypad, a mouse, a touch-screen, a touch-pad, a track-ball, a stylus, a microphone, or other suitable pointing device or input device. The output unit may include, for example, a monitor, a screen, a touch-screen, a Light Emitting Diode (LED) display unit, a flat panel display, a Liquid Crystal Display (LCD) display unit, a plasma display unit, one or more audio speakers or earphones, or other suitable output devices.

In some demonstrative aspects, the memory unit may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. The storage unit may include, for example, a hard disk drive, a Solid State Drive (SSD), or other suitable removable or non-removable storage units. For example, the memory unit and/or the storage unit, for example, may store data processed by the computing device.

In some demonstrative aspects, the computing system may be configured to communicate with one or more other devices via a wireless and/or wired network.

In some demonstrative aspects, the computing system may be configured to perform and/or to execute one or more operations, modules, processes, procedures, and/or the like, e.g., as described below.

In some demonstrative aspects, the computing system may include at least one application, which may be implemented by, as part of, and/or in the form of, at least one service, module, and/or controller, e.g., as described below.

In some demonstrative aspects, the application may include, or may be implemented as, software, a software module, an application, a program, a subroutine, instructions, an instruction set, computing code, words, values, symbols, and/or the like.

In some demonstrative aspects, the application may include a local application to be executed by a computing device.

In some demonstrative aspects, the memory unit and/or storage unit of the computing device may store instructions resulting in the application, and/or the processor may be configured to execute the instructions resulting in the application and/or to perform one or more calculations and/or processes of the application, e.g., as described below.

In other aspects, the application may include a remote application to be executed by a suitable computing system, e.g., a server.

In some demonstrative aspects, the server may include at least a remote server, a web-based server, a cloud server, and/or any other server.

In some demonstrative aspects, the computing device may communicate with the server, for example, via the network.

In some demonstrative aspects, the server may include a suitable memory and/or storage unit having stored thereon instructions resulting in the application, and a suitable processor to execute the instructions.

In some demonstrative aspects, the application may include a combination of a remote application and a local application.

In one example, the application may be downloaded and/or received by the computing device from another computing system, e.g., the server, such that the application may be executed locally by the computing device. For example, some or all of the instructions of the application may be received and stored, e.g., temporarily, in a memory or any suitable short-term memory or buffer of the computing device, e.g., prior to being executed by the processor of the computing device.

In another example, the application may include a front-end to be executed locally by the computing device, and a backend to be executed by the server. For example, the front end may include and/or may be implemented as a local application, a web application, a web site, a web client, or the like.

For example, one or more first operations of the application may be performed locally, for example, by the computing device, and/or one or more second operations of the application may be performed remotely, for example, by the server.

In other aspects, the application may include and/or may be implemented by any other suitable computing arrangement and/or scheme.

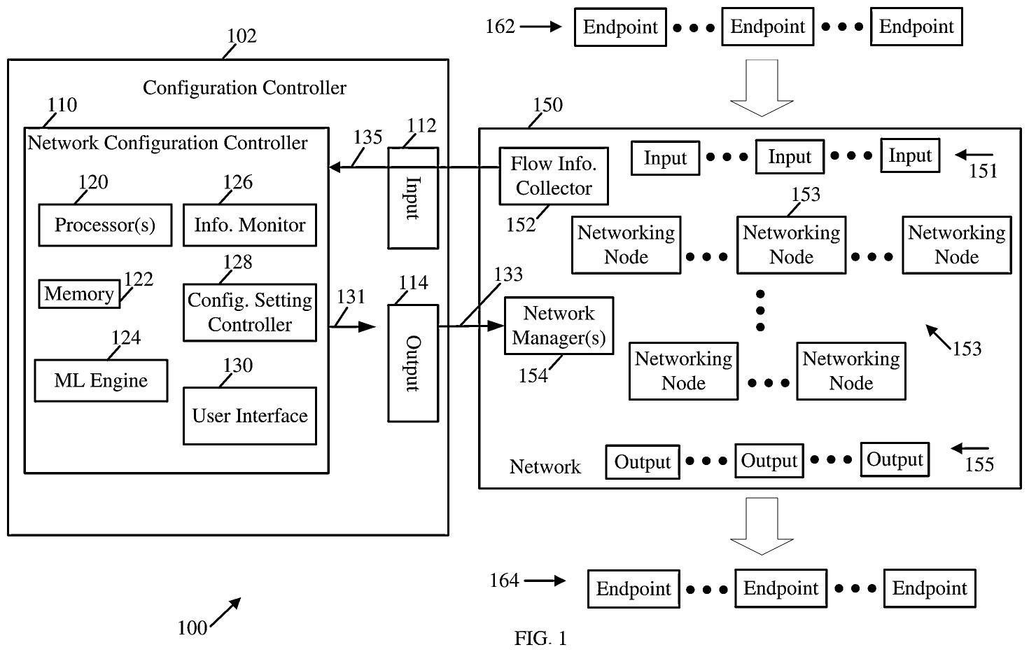

Reference is made to FIG. 1, which schematically illustrates a system 100, in accordance with some demonstrative aspects.

In some demonstrative aspects, system 100 may include a configuration controller 102, which may be configured to controllably set a configuration of a network 150, e.g., as described below.

In some demonstrative aspects, network 150 may be configured to communicate data between a plurality of endpoint nodes (also referred to as “endpoints”), for example, including a plurality of endpoints 162 and/or a plurality of endpoints 164, e.g., as described below.

In some demonstrative aspects, the plurality of endpoint nodes 162 may include one or more devices and/or systems, which may be configured to generate, provide, and/or distribute, data to be communicated via the network 150, e.g., to one or more of the plurality of endpoints 164.

In some demonstrative aspects, the plurality of endpoint nodes 164 may include one or more devices and/or systems, which may be configured to receive and/or process data communicated via the network 150, e.g., from one or more of the plurality of endpoints 162.

In some demonstrative aspects, one or more, e.g., some or all, of the endpoints in system 100 may be configured to perform the functionality of an endpoint 162, e.g., to send data to one or more other endpoints 164; and to perform the functionality of an endpoint 164, e.g., to receive data from one or more other endpoints 162.

In some demonstrative aspects, one or more, e.g., some or all, of the endpoints in system 100 may be configured to either perform the functionality of an endpoint 162, e.g., to send data to one or more other endpoints 164; or to perform the functionality of an endpoint 164, e.g., to receive data from one or more other endpoints 162.

In some demonstrative aspects, one or more endpoints of the plurality of endpoints 162 and/or the plurality of endpoints 164 may include, for example, a processor device, a computing device, an accelerate device, a server device, a processor system, a computing system, an accelerate system, a Central Processing Unit (CPU), a Graphic Processing Unit (GPU), an xPU, a Neural Processing Unit (NPU), a Mchine Learning (ML) unit, an ML accelerator, an Artificial Intelligence (AI) unit, an AI accelerator, and/or any other additional or alternative processor, computing, and/or accelerate device, unit, or system.

In some demonstrative aspects, one or more endpoints of the plurality of endpoints 162 and/or the plurality of endpoints 164 may include, for example, a user device, a User Equipment (UE), a Mobile Device (MD), a station (STA), a Personal Computer (PC), a desktop computer, a mobile computer, a laptop computer, a notebook computer, a tablet computer, a handheld computer, a handheld device, a wearable device, a sensor device, an Internet of Things (IoT) device, a mobile or portable device, a consumer device, a non-mobile or non-portable device, a wireless communication station, a wireless communication device, a video device, an audio device, an audio-video (A/V) device, or the like.

In some demonstrative aspects, network 150 may include a plurality of network inputs 151 to receive a plurality of data flows, which may be provided, for example, from the plurality of endpoints 162, e.g., as described below.

In some demonstrative aspects, network 150 may include a plurality of network outputs 155 to output the plurality of data flows, which may be provided, for example, to the plurality of endpoints 164, e.g., as described below.

In some demonstrative aspects, network 150 may include a plurality of networking nodes 153 to connect between the plurality of network inputs 151 and the plurality of network outputs 155 of the network 150.

In some demonstrative aspects, one or more of, e.g., some or all of, network inputs 151 and/or one or more of, e.g., some or all of, network outputs 155 may be implemented separately from the networking nodes 153. For example, one or more of, e.g., some or all of, network inputs 151 may be implemented in the form of any suitable input units, input interface units or the like, which may interface between the endpoints 162 and the networking nodes 153; and/or one or more of, e.g., some or all of, network outputs 155 may be implemented in the form of any suitable output units, output interface units or the like, which may interface between the endpoints 164 and the networking nodes 153.

In some demonstrative aspects, one or more of, e.g., some or all of, network inputs 151 and/or one or more of, e.g., some or all of, network outputs 155 may be implemented as part of one or more of the networking nodes 153.

In some demonstrative aspects, a networking node 153 of the plurality of networking nodes 153 may include, for example, a network device, a network node, a networking Hardware (HW), a switch, a router, a bridge, a bridging router (Brouter), a relay node, a data communication node, and/or any other suitable device, component and/or network element, which may be configured to switch, route, relay, and/or communicate the plurality of data flows in network 150, for example, from one or more network inputs 151 and/or from one or more other networking nodes 153, to one or more other networking nodes 153 and/or one or more network outputs 155.

In some demonstrative aspects, network 150 may include a lossless network, e.g., as described below. For example, one or more, e.g., some or all, of the plurality of networking nodes 153 may be configured to prevent packet loss for one or more traffic flows according to one or more suitable protocols and/or lossless communication technologies.

In some demonstrative aspects, network 150 may include a lossy network, e.g., as described below. For example, one or more, e.g., some or all, of the plurality of networking nodes 153 may be configured to allow packet loss (packet dropping) for one or more traffic flows according to one or more suitable protocols and/or technologies.

In some demonstrative aspects, network 150 may include a hybrid lossy-lossless network. For example, one or more, e.g., some or all, of the plurality of networking nodes 153 may be configured to handle one or more traffic flows according to one or more lossless protocols, and one or more other traffic flows according to one or more lossy protocols, e.g., on a per Traffic Class (TC) per port basis.

For example, one or more, e.g., some or all, of the plurality of networking nodes 153 may be configured according to a Remote Direct Memory Access (RDMA) technology, an RDMA over Converged Ethernet (RoCE) technology, an InfiniBand over Ethernet (IBoE) technology, or the like.

In some demonstrative aspects, network 150 may include a Clos network, which may be configured according to a Clos architecture, e.g., as described below.

In one example, the Clos architecture may be implemented according to a leaf-spine layout, which may include a spine layer, e.g., including a plurality of networking nodes 153 in a “middle” stage, and a leaf layer, e.g., including a plurality of networking nodes 153 in an ingress stage and an egress stage, e.g., as described below.

In another example, the Clos architecture may include additional stages, for example, by “breaking-up” the spine layer into a smaller Clos network, e.g., having its own ingress, middle and egress stages.

In some demonstrative aspects, network 150 may include a scheduled-fabric network, which may be configured according to a scheduled-fabric architecture.

In some demonstrative aspects, network 150 may include a network connecting between a plurality of processors of an Artificial Intelligence (AI) training cluster, e.g., as described below.

For example, the plurality of endpoint nodes 162 and/or the plurality of endpoint nodes 164 may include the components of the AI training cluster, for example, processors, accelerators, servers, or the like, e.g., as described below.

In some demonstrative aspects, network 150 may include a communication network to communicate content between one more content providers and a plurality of end users, for example, endpoint user devices, e.g., as described below.

For example, the plurality of endpoint nodes 162 may include communication nodes of the one more content providers, and/or the plurality of endpoint nodes 164 may include client/user nodes if the plurality of end users, e.g., as described below.

In other aspects, network 150 may include any other additional or alternative type of network, which may be configured according to any other additional or alternative network architecture.

In some demonstrative aspects, configuration controller 102 may be configured to control and/or manage one or more settings to configure the network 150, e.g., as described below.

In some demonstrative aspects, configuration controller 102 may be configured to process flow information 135 corresponding to the plurality of data flows via the network 150, e.g., as described below.

In some demonstrative aspects, configuration controller 102 may include an input 112 to input the flow information 135, e.g., as described below.

In some demonstrative aspects, input 112 may include any suitable input interface, input unit, input module, input component, input circuitry, memory interface, memory access unit, memory reader, digital memory unit, bus interface, processor interface, or the like, which may be capable of receiving the flow information 135, for example, from a memory, a processor, and/or any other suitable component to provide the flow information 135.

In some demonstrative aspects, input 112 may be configured in the form of, or as part of, a suitable communication interface, which may be configured to receive the flow information 135, for example, from one or more flow information collectors 152.

In some demonstrative aspects, the flow information 135 may include information according to an Internet Protocol Flow Information Export (IPFIX) protocol.

In some demonstrative aspects, the flow information 135 may include information according to a net-flow (NETFLOW) protocol.

In some demonstrative aspects, the flow information 135 may include information according to a Sampled Flow (SFLOW) protocol.

In other aspects, the flow information 135 may include information according to any other suitable additional or alternative protocol and/or format.

In some demonstrative aspects, configuration controller 102 may be configured to determine a network-configuration setting 131 to configure the network 150, for example, based on the flow information 135, e.g., as described below.

In some demonstrative aspects, configuration controller 102 may be configured to generate and/or provide output information (also referred to as “network-configuration information”) 133, which may be based on the network-configuration setting 131 to configure the network 150, e.g., as described below.

In some demonstrative aspects, the output information 133, may include the network-configuration setting 131 to configure the network 150, e.g., as described below.

In some demonstrative aspects, the output information 133, may include information which may be based on, partially or entirely, the network-configuration setting 131 to configure the network 150, e.g., as described below.

In some demonstrative aspects, configuration controller 102 may be configured to provide the network-configuration information 133 to one or more network managers 154 of the network 150, e.g., as described below.

In some demonstrative aspects, the network-configuration information 133 may be provided to the one or more network managers 154 in the form of a network configuration recommendation, which may include a recommendation to apply the network-configuration setting 131 to configure the network 150, e.g., as described below.

In some demonstrative aspects, the output information 133 may be provided to the one or more network managers 154 in the form of a network configuration instruction, which may include an instruction to apply the network-configuration setting 131 to configure the network 150, e.g., as described below.

In other aspects, the output information 133 may be provided in any other suitable additional or alternative form and/or configuration.

In some demonstrative aspects, configuration controller 102 may include an output 114 to provide the output information 133.

In some demonstrative aspects, output 114 may any suitable output interface, output unit, output module, output component, output circuitry, memory interface, memory access unit, memory writer, digital memory unit, bus interface, processor interface, or the like, which may be capable of outputting the output information 133 to a memory, a processor, and/or any other suitable component to handle the output information 133.

In some demonstrative aspects, output 114 may be configured in the form of, or as part of, a suitable communication interface, which may be configured to communicate the output information 133 to the one or more network managers 154.

In some demonstrative aspects, configuration controller 102 may be configured to implement one or more operations and/or functionalities of a network configuration mechanism, which may be configured to determine the output information 133, for example, according to at least one target End to End (E2E) performance parameter, e.g., as described below.

In some demonstrative aspects, the at least one target E2E performance parameter may correspond to an E2E performance of the plurality of data flows via the network 150, for example, between the plurality of endpoints 162 and the plurality of endpoints 164, e.g., as described below.

For example, the at least one target E2E performance parameter may include at least one performance parameter corresponding to the performance of the plurality of data flows, which may be based on, and/or may take into consideration one or more requirements, settings, and/or configurations, of the plurality of endpoints 162 and/or the plurality of endpoints 164, e.g., as described below.

In some demonstrative aspects, the at least one target E2E performance parameter may correspond to a network E2E performance of the plurality of data flows, for example, between the plurality of network inputs 151 and the plurality of network outputs 155, e.g., as described below.

For example, in some use cases, implementations and/or deployments, the E2E performance of the plurality of data flows, for example, between the plurality of endpoints 162 and the plurality of endpoints 164, may be based on, and/or may be configurable by, the network E2E performance of the plurality of data flows, for example, between the plurality of network inputs 151 and the plurality of network outputs 155, e.g., as described below.

For example, in some use cases, implementations and/or deployments, the E2E performance of the plurality of data flows, for example, between the plurality of endpoints 162 and the plurality of endpoints 164, may include, or may be similar to, the network E2E performance of the plurality of data flows, for example, between the plurality of network inputs 151 and the plurality of network outputs 155, e.g., as described below. In other use cases, implementations and/or deployments, the E2E performance of the plurality of data flows, for example, between the plurality of endpoints 162 and the plurality of endpoints 164, may include, or may be different from the network E2E performance of the plurality of data flows, for example, between the plurality of network inputs 151 and the plurality of network outputs 155.

In some demonstrative aspects, configuration controller 102 may be configured to determine the output information 133 according to the at least one target E2E performance parameter, for example, to provide a technical solution to support configuration of the network 150 according to an approach, e.g., a holistic approach, which may take into consideration the network E2E performance of the network 150, e.g., as described below.

In some demonstrative aspects, configuration controller 102 may be configured to determine the network-configuration information 133 according to the at least one target E2E performance parameter, for example, to provide a technical solution to support improved E2E performance via the network 150, e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of Job Completion Time (JCT), e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of Quality of Experience (QoE), e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of Quality of Service (QOS), e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of latency (delay), e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of bandwidth utilization, e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of power consumption, e.g., as described below.

In some demonstrative aspects, configuration controller 102 may be configured to determine the network-configuration information 133 according to the at least one target E2E performance parameter, for example, to provide a technical solution to support improved E2E performance via the network 150, for example, in terms of any other additional or alternative E2E parameter and/or criterion.

In some demonstrative aspects, configuration controller 102 may be configured to determine the network-configuration information 133 according to the at least one target E2E performance parameter, for example, to provide a technical solution to support configuration of the network 150, for example, even in cases where different parts, portions, segments, and/or sections of the network 150 may be managed by different and/or independent entities, and/or according to different and/or independent considerations, e.g., as described below.

In some demonstrative aspects, configuration controller 102 may be configured to determine the network-configuration information 133 according to the at least one target E2E performance parameter, for example, to provide a technical solution to support configuration of the network 150, for example, even in cases where different parts, portions, segments, and/or sections of the network 150 may be managed by different and/or independent network managers 154, e.g., as described below.

In some demonstrative aspects, configuration controller 102 may be configured to determine the network-configuration information 133 according to the at least one target E2E performance parameter, for example, to provide a technical solution to support configuration of the network 150, for example, in cases where the E2E performance may be an important factor, e.g., as described below.

In some demonstrative aspects, configuration controller 102 may be configured to determine the network-configuration information 133 according to the at least one target E2E performance parameter, for example, to provide a technical solution to support configuration of the network 150, for example, in cases where the performance of one part or section of the network 150 may depend on, may have an effect on, and/or may be affected by, the performance of another part or section of the network 150, e.g., as described below.

In some demonstrative aspects, configuration controller 102 may be configured to determine the network-configuration information 133 according to the at least one target E2E performance parameter, for example, to provide a technical solution to support configuration of the network 150, for example, in cases where congestion and/or latency at one part or section of the network 150 may depend on, may have an effect on, and/or may be affected by, congestion and/or latency at another part or section of the network 150, e.g., as described below.

In some demonstrative aspects, configuration controller 102 may be configured to determine the network-configuration information 133 according to the at least one target E2E performance parameter, for example, to provide a technical solution to support configuration of the network 150, for example, in cases where a QoS provided by one part or section of the network 150 may depend on, may have an effect on, and/or may be affected by, a QoS provided by another part or section of the network 150, e.g., as described below.

In some demonstrative aspects, configuration controller 102 may include a network configuration controller 110, which may be configured to determine the network-configuration setting 131, for example, based on the flow information 135, e.g., as described below.

In some demonstrative aspects, network configuration controller 110 may include one or more processors 120, which may be configured to perform one or more operations and/or functionalities of network configuration controller 110, e.g., as described below.

In some demonstrative aspects, the one or more processors 120 may include, for example, one or more CPUs, one or more GPUs, one or more xPUs, one or more NPUs, one or more DSPs, one or more processor cores, one or more server processors, one or more microprocessors, one or more host processors, one or more controllers, a plurality of processors and/or controllers, one or more chips, one or more microchips, one or more circuits, circuitry, one or more logic units, one or more ICs, one or more ASICs, and/or or any other suitable multi-purpose or specific processors and/or controllers.

In some demonstrative aspects, the one or more processors 120 may be configured to execute instructions stored by the one or more memories 122, e.g., as described below.

In some demonstrative aspects, the one or more memories 122 may store instructions, which, when executed by the one or more processors 120, may enable the one or more processors 122 to cause network configuration controller 110 to perform one or more operations and/or functionalities, e.g., as described below.

In some demonstrative aspects, the one or more memories 122 may store information processed by the one or more processors 120, e.g., as described below.

In some demonstrative aspects, network configuration controller 110 may be configured to monitor a plurality of node-related flow information sets, for example, based on the flow information 135 corresponding to the plurality of data flows via the network 150, e.g., as described below.

In some demonstrative aspects, network configuration controller 110 may include an information observer (monitor) component 126, which may be configured to process the flow information 135, for example, to identify and/or determine the plurality of node-related flow information sets; and/or to monitor the plurality of node-related flow information sets, e.g., as described below.

In some demonstrative aspects, information monitor 126 may be configured to monitor the plurality of node-related flow information sets, for example, in real-time, e.g., as described below.

In some demonstrative aspects, the plurality of node-related flow information sets may correspond to the plurality of networking nodes 153, e.g., as described below.

In some demonstrative aspects, a node-related flow information set corresponding to a networking node 153 of the plurality of networking nodes 153 may include, for example, information corresponding to one or more data flows communicated via the networking node 153, e.g., as described below.

In some demonstrative aspects, the node-related flow information set corresponding to a networking node 153 may include, for example, source address information to identify a network input of the plurality of network inputs 151 corresponding to a data flow communicated via the networking node 153, e.g., as described below.

For example, the node-related flow information set corresponding to a networking node 153 may include first source address information to identify a first network input of the plurality of network inputs 151 corresponding to a first data flow communicated via the networking node 153; and/or second source address information to identify a second network input of the plurality of network inputs 151 corresponding to a second data flow communicated via the networking node 153, e.g., as described below.

In one example, the first source address information may be different from the second source address information.

In another example, the first source address information may be the same as the second source address information, for example, in case the first data flow and the second data flow share the same network input 151.

In some demonstrative aspects, the node-related flow information set corresponding to a networking node 153 may include, for example, destination address information to identify a network output of the plurality of network outputs 155 corresponding to the data flow communicated via the networking node 153, e.g., as described below.

For example, the node-related flow information set corresponding to a networking node 153 may include first destination address information to identify a first network output of the plurality of network outputs 155 corresponding to a first data flow communicated via the networking node 153; and/or second destination address information to identify a second network output of the plurality of network outputs 155 corresponding to a second data flow communicated via the networking node 153, e.g., as described below.

In one example, the first destination address information may be different from the second destination address information.

In another example, the first destination address information may be the same as the second destination address information, for example, in case the first data flow and the second data flow share the same network output 155.

In some demonstrative aspects, the node-related flow information set corresponding to a networking node 153 may include, for example, source port information to identify an ingress port of the networking node 153 corresponding to the data flow communicated via the networking node 153, e.g., as described below.

For example, the node-related flow information set corresponding to a networking node 153 may include first source port information to identify a first ingress port of the networking node 153 corresponding to a first data flow communicated via the networking node 153; and/or second source port information to identify a second ingress port of the networking node 153 corresponding to a second data flow communicated via the networking node 153, e.g., as described below.

In one example, the first source port information may be different from the second source port information.

In another example, the first source port information may be the same as the second source port information, for example, in case the first data flow and the second data flow share the same ingress port of the networking node 153.

In some demonstrative aspects, the node-related flow information set corresponding to a networking node 153 may include, for example, destination port information to identify an egress port of the networking node 153 corresponding to the data flow communicated via the networking node 153, e.g., as described below.

For example, the node-related flow information set corresponding to a networking node 153 may include first destination port information to identify a first egress port of the networking node 153 corresponding to a first data flow communicated via the networking node 153; and/or second destination port information to identify a second egress port of the networking node 153 corresponding to a second data flow communicated via the networking node 153, e.g., as described below.

In one example, the first destination port information may be different from the second destination port information.

In another example, the first destination port information may be the same as the second destination port information, for example, in case the first data flow and the second data flow share the same egress port of the networking node 153.

In some demonstrative aspects, the node-related flow information set corresponding to a networking node 153 may include, for example, length information to identify a data length corresponding to the data flow communicated via the networking node 153, e.g., as described below.

For example, the node-related flow information set corresponding to a networking node 153 may include first length information to identify a first data length corresponding to a first data flow communicated via the networking node 153; and/or second length information to identify a first data length corresponding to a first data flow communicated via the networking node 153, e.g., as described below.

In some demonstrative aspects, the node-related flow information set corresponding to a networking node 153 may include, for example, next-hop information to identify a next-hop networking node corresponding to the data flow communicated via the networking node 153, e.g., as described below.

For example, the next-hop networking node corresponding to the data flow may include a next networking node to which the data flow may be provided by the networking node 153 to which the node-related flow information set corresponds.

For example, the node-related flow information set corresponding to a networking node 153 may include first next-hop information to identify a first next-hop networking node corresponding to a first data flow communicated via the networking node 153; and/or second next-hop information to identify a second next-hop networking node corresponding to a second data flow communicated via the networking node 153, e.g., as described below.

In one example, the first next-hop information may be different from the second next-hop information.

In another example, the first next-hop information may be the same as the second next-hop information, for example, in case the first data flow and the second data flow are to be provided to the same next-hop networking node.

In some demonstrative aspects, the node-related flow information set corresponding to a networking node 153 may include, for example, QoS information, including, for example, information of one or more QoS parameters corresponding to the flow communicated via the networking node 153, e.g., as described below.

For example, the node-related flow information set corresponding to a networking node 153 may include first QoS information of one or more QoS parameters corresponding to a first data flow communicated via the networking node 153; and/or second QoS information of one or more QoS parameters corresponding to a second data flow communicated via the networking node 153, e.g., as described below.

In some demonstrative aspects, the node-related flow information set corresponding to a networking node 153 may include, for example, timing information, including, for example, information of one or more timing parameters corresponding to the flow communicated via the networking node 153, e.g., as described below.

For example, the timing information corresponding to a networking node 153 may include timestamp information of one or more timestamps corresponding to the flow communicated via the networking node 153. In one example, the timestamp information may include a timestamp of a first packet of the data flow, and/or a timestamp of a last packet of the data flow.

For example, the timing information corresponding to a networking node 153 may include Time to Live (TTL) information corresponding to the flow communicated via the networking node 153.

For example, the timing information corresponding to a networking node 153 may include time difference information corresponding to the flow communicated via the networking node 153.

For example, the timing information corresponding to a networking node 153 may include any other additional or alternative type of timing information corresponding to any other additional or alternative timing parameters.

For example, the node-related flow information set corresponding to a networking node 153 may include first timing information of one or more timing parameters corresponding to a first data flow communicated via the networking node 153; and/or second timing information of one or more timing parameters corresponding to a second data flow communicated via the networking node 153, e.g., as described below.

In some demonstrative aspects, network configuration controller 110 may be configured to determine network-configuration setting 131 to configure the network 150, for example, based on the plurality of node-related flow information sets, e.g., as described below.

In some demonstrative aspects, network configuration controller 110 may include a configuration setting controller component 128, which may be configured to determine the network-configuration setting 131, for example, based on the monitored plurality of node-related flow information sets, e.g., as described below.

In some demonstrative aspects, network configuration controller 110 may include a configuration setting controller component 128, which may be configured to determine the network-configuration setting 131, for example, in real-time, e.g., as described below.

In some demonstrative aspects, network configuration controller 110 may include a configuration setting controller component 128, which may be configured to determine the network-configuration setting 131, for example, based on real-time changes in the monitored plurality of node-related flow information sets, for example, based on real-time changes in the flow information 135, e.g., as described below.

In some demonstrative aspects, network configuration controller 110 may be configured to determine network-configuration setting 131 to configure the network 150, for example, based on at least one target E2E performance parameter, e.g., as described below.

In some demonstrative aspects, the at least one target E2E performance parameter may correspond to an E2E performance of the plurality of data flows via the network 150, for example, between the plurality endpoints 162 and the plurality of endpoints 164, e.g., as described below.

In some demonstrative aspects, network configuration controller 110 may be configured to determine the at least one target E2E performance parameter based, for example, on input from a user, for example, a network administrator, operator, or the like, e.g., as described below.

In some demonstrative aspects, network configuration controller 110 may be configured to provide one or more functionalities and/or operations of a User Interface (UI) 130, which may be configured to receive the input from the user, e.g., as described below.

In other aspects, one or more, e.g., some or all, target E2E performance parameters to be implemented by network configuration controller 110 may be preset, and/or preconfigured. For example, the user may be allowed to define only some target E2E performance parameters.

In some demonstrative aspects, network configuration controller 110 may be configured to determine network-configuration setting 131 to configure the network 150, for example, based on the at least one target E2E performance parameter including a Job Completion Time (JCT), e.g., as described below.

In some demonstrative aspects, network configuration controller 110 may be configured to determine network-configuration setting 131 to configure the network 150, for example, based on the at least one target E2E performance parameter including a usage efficiency corresponding to a usage efficiency of the network 150, e.g., as described below.

In some demonstrative aspects, network configuration controller 110 may be configured to determine network-configuration setting 131 to configure the network 150, for example, based on the at least one target E2E performance parameter including an E2E Quality of Experience (QoE), for example, corresponding to a QoE provided by the communication of the plurality of data flows via the network 150, e.g., as described below.

In some demonstrative aspects, network configuration controller 110 may be configured to determine network-configuration setting 131 to configure the network 150, for example, based on the at least one target E2E performance parameter including an E2E Quality of Service (QOS), for example, corresponding to a QoE provided by the communication of the plurality of data flows via the network 150, e.g., as described below.

In some demonstrative aspects, network configuration controller 110 may be configured to determine network-configuration setting 131 to configure the network 150, for example, based on the at least one target E2E performance parameter including an E2E delay, for example, corresponding to the communication of the plurality of data flows via the network 150, e.g., as described below.

In some demonstrative aspects, network configuration controller 110 may be configured to determine network-configuration setting 131 to configure the network 150, for example, based on the at least one target E2E performance parameter including an E2E bandwidth, for example, corresponding to a communication bandwidth provided by the network for the communication of the plurality of data flows, e.g., as described below.

In some demonstrative aspects, network configuration controller 110 may be configured to determine network-configuration setting 131 to configure the network 150, for example, based on the at least one target E2E performance parameter including an E2E power consumption of the network 150, e.g., as described below.

In some demonstrative aspects, network configuration controller 110 may be configured to determine network-configuration setting 131 to configure the network 150, for example, based on the at least one target E2E performance parameter including any other additional or alternative type of E2E performance parameter corresponding to the E2E performance via the network 150.

In some demonstrative aspects, configuration controller 102 may be configured to provide, for example, via the output 114, the output information 133, which may be based on the network-configuration setting 131, e.g., as described below.

In some demonstrative aspects, network configuration controller 110 may be configured to determine the network-configuration setting 131, for example, such that a predefined criterion with respect to the at least one target E2E performance parameter is to be met, e.g., as described below.

In one example, network configuration controller 110 may be configured to determine the network-configuration setting 131, for example, such that the JCT is reduced to, and/or maintained at, a minimal level, e.g., as described below.

In another example, network configuration controller 110 may be configured to determine the network-configuration setting 131, for example, such that the JCT is maintained below a suitable JCT threshold. For example, the JCT threshold may be defined, for example, by the user, e.g., via the user interface 130.

In one example, network configuration controller 110 may be configured to determine the network-configuration setting 131, for example, such that the E2E QoE is increased to, and/or maintained at, a maximal level, e.g., as described below.

In another example, network configuration controller 110 may be configured to determine the network-configuration setting 131, for example, such that the QoE is maintained above a predefined QoE threshold, or within a predefined QoE range. For example, the QoE threshold and/or the QoE range may be defined, for example, by the user, e.g., via the user interface 130.

In one example, network configuration controller 110 may be configured to determine the network-configuration setting 131, for example, such that the E2E QoS is increased to, and/or maintained at, a maximal level, e.g., as described below.

In another example, network configuration controller 110 may be configured to determine the network-configuration setting 131, for example, such that the QoS is maintained above a predefined QoS threshold, or within a predefined QoS range. For example, the QoS threshold and/or the QoS range may be defined, for example, by the user, e.g., via the user interface 130.

In other aspects, network configuration controller 110 may be configured to determine the network-configuration setting 131, for example, such that any other additional or alternative predefined criterion with respect to at least one additional or alternative target E2E performance parameter is to be met.

In some demonstrative aspects, network configuration controller 110 may be configured to monitor the flow information 135, and to update the network-configuration setting 131, for example, based on a detected real-time change in the plurality of node-related flow information sets corresponding to the networking nodes 153, e.g., as described below.

In some demonstrative aspects, network configuration controller 110 may be configured to update the network-configuration setting 131 based on the detected real-time change in the plurality of node-related flow information sets, which may include for example, a change indictive of an expected congestion state of at least one data flow, for example, via one or more networking nodes 153, e.g., as described below.

In some demonstrative aspects, network configuration controller 110 may be configured to update the network-configuration setting 131 based on the detected real-time change in the plurality of node-related flow information sets, which may include for example, a change indictive of an expected degradation in the at least one target E2E performance parameter, e.g., as described below.

In one example, configuration setting controller 128 may be configured to update the network-configuration setting 131, for example, based on a detected real-time change in the plurality of node-related flow information sets, which may be indictive of an expected degradation in the JCT, e.g., as described below.

In another example, configuration setting controller 128 may be configured to update the network-configuration setting 131, for example, based on a detected real-time change in the plurality of node-related flow information sets, which may be indictive of an expected degradation in the E2E QoE, e.g., as described below.

In another example, configuration setting controller 128 may be configured to update the network-configuration setting 131, for example, based on a detected real-time change in the plurality of node-related flow information sets, which may be indictive of an expected degradation in the E2E QoS, e.g., as described below.

In other aspects, configuration setting controller 128 may be configured to update the network-configuration setting 131 based on any other additional or alternative detected change in the plurality of node-related flow information sets, which may be indictive of an expected degradation in any other additional or alternative target E2E performance parameter.

In some demonstrative aspects, network configuration controller 110 may be configured to update the network-configuration setting 131 to a setting, which may be configured, for example, to reduce a probability of a degradation in the at least one target E2E performance parameter, e.g., as described below.

In one example, configuration setting controller 128 may be configured to update the network-configuration setting 131, for example, to a setting, which may be configured to reduce a probability of a degradation in the JCT, e.g., as described below.

In another example, configuration setting controller 128 may be configured to update the network-configuration setting 131, for example, to a setting, which may be configured to reduce a probability of a degradation in the E2E QoE, e.g., as described below.

In another example, configuration setting controller 128 may be configured to update the network-configuration setting 131, for example, to a setting, which may be configured to reduce a probability of a degradation in the E2E QoS, e.g., as described below.

In other aspects, configuration setting controller 128 may be configured to update the network-configuration setting 131 to a setting, which may be configured to reduce a probability of a degradation of any other additional or alternative E2E performance parameter.

In some demonstrative aspects, network configuration controller 110 may be configured to update the network-configuration setting 131 to a setting, which may be configured, for example, to increase a probability of an improvement in the at least one target E2E performance parameter, e.g., as described below.

In one example, configuration setting controller 128 may be configured to update the network-configuration setting 131, for example, to a setting, which may be configured to increase a probability of an improvement in the JCT, e.g., as described below.

In another example, configuration setting controller 128 may be configured to update the network-configuration setting 131, for example, to a setting, which may be configured to increase a probability of an improvement in the QoE, e.g., as described below.

In another example, configuration setting controller 128 may be configured to update the network-configuration setting 131, for example, to a setting, which may be configured to increase a probability of an improvement in the QoS, e.g., as described below.

In other aspects, configuration setting controller 128 may be configured to update the network-configuration setting 131 to a setting, which may be configured to increase a probability of an improvement of any other additional or alternative E2E performance parameter.

In some demonstrative aspects, network configuration controller 110 may be configured to dynamically update the network-configuration setting 131 based on the flow information 135, for example, according to a criterion corresponding to the at least one target E2E performance parameter, e.g., as described below.

In one example, configuration setting controller 128 may be configured to dynamically update the network-configuration setting 131 based on the flow information 135, for example, according to a criterion corresponding to the JCT, e.g., as described below.

In another example, configuration setting controller 128 may be configured to dynamically update the network-configuration setting 131 based on the flow information 135, for example, according to a criterion corresponding to the QoE, e.g., as described below.

In another example, configuration setting controller 128 may be configured to dynamically update the network-configuration setting 131 based on the flow information 135, for example, according to a criterion corresponding to the QoS, e.g., as described below.

In other aspects, configuration setting controller 128 may be configured to dynamically update the network-configuration setting 131 based on the flow information 135 according to any other additional or alternative criterion corresponding to any other additional or alternative E2E performance parameter.

In some demonstrative aspects, network configuration controller 110 may be configured to determine a first network-configuration setting 131, for example, based on a first plurality of node-related flow information sets corresponding to first flow information 135, which may be related to a first time frame, e.g., as described below.

In some demonstrative aspects, network configuration controller 110 may be configured to determine a second network-configuration setting 131, for example, based on a second plurality of node-related flow information sets corresponding to second flow information 135, which may be related to a second time frame, e.g., as described below.

In some demonstrative aspects, the second time frame may be subsequent to the first time frame, e.g., as described below.

In some demonstrative aspects, network configuration controller 110 may be configured to determine a predicted state of the plurality of data flows via the network 150, for example, based on the plurality of node-related flow information sets, e.g., as described below.

In some demonstrative aspects, network configuration controller 110 may be configured to determine the network-configuration setting 131, for example, based on the predicted state of the plurality of data flows via the network 150 and the at least one target E2E performance parameter, e.g., as described below.

In some demonstrative aspects, network configuration controller 110 may be configured to determine the network-configuration setting 131, for example, based on a predefined criterion corresponding to the predicted state of the plurality of data flows via the network 150, e.g., as described below.

In some demonstrative aspects, the predefined criterion may be based on applying the network-configuration setting 131 for the predicted state of the plurality of data flows via the network 150, e.g., as described below.

In some demonstrative aspects, network configuration controller 110 may be configured to determine the network-configuration setting 131, for example, such that a predefined criterion with respect to the at least one target E2E performance parameter is to be met, for example, based on applying the network-configuration setting 131 for the predicted state of the plurality of data flows via the network 150, e.g., as described below.

In one example, configuration setting controller 128 may be configured to determine the network-configuration setting 131, for example, such that a predefined criterion with respect to the JCT to be met, for example, based on applying the network-configuration setting 131 for the predicted state of the plurality of data flows via the network 150.

For example, configuration setting controller 128 may be configured to determine the network-configuration setting 131, for example, such that a predicted JCT, which is based on applying the network-configuration setting 131 for the predicted state of the plurality of data flows via the network 150, is maintained at a minimal level, below a predefined JCT threshold, or within a predefined JCT range.

In another example, configuration setting controller 128 may be configured to determine the network-configuration setting 131, for example, such that a predefined criterion with respect to the QoE to be met, for example, based on applying the network-configuration setting 131 for the predicted state of the plurality of data flows via the network 150.

For example, configuration setting controller 128 may be configured to determine the network-configuration setting 131, for example, such that a predicted QoE, which is based on applying the network-configuration setting 131 for the predicted state of the plurality of data flows via the network 150, is maintained at a maximal level, above a predefined QoE threshold, or within a predefined QoE range.

In another example, configuration setting controller 128 may be configured to determine the network-configuration setting 131, for example, such that a predefined criterion with respect to the QoS to be met, for example, based on applying the network-configuration setting 131 for the predicted state of the plurality of data flows via the network 150.

For example, configuration setting controller 128 may be configured to determine the network-configuration setting 131, for example, such that a predicted QoS, which is based on applying the network-configuration setting 131 for the predicted state of the plurality of data flows via the network 150, is maintained at a maximal level, above a predefined QoS threshold, or within a predefined QoS range.

In other aspects, network configuration controller 110 may be configured to determine the network-configuration setting 131 based on any other additional or alternative criterion corresponding to the predicted state of the plurality of data flows via the network 150.

In some demonstrative aspects, network configuration controller 110 may be configured to determine network topography information corresponding to a network topography of the network 150, for example, based on the plurality of node-related flow information sets, which may be monitored, for example, based on the flow information 135, e.g., as described below.

In some demonstrative aspects, network configuration controller 110 may be configured to determine the network-configuration setting 131, for example, based on the network topography information, e.g., as described below.

In some demonstrative aspects, network configuration controller 110 may be configured to determine network topology information corresponding to a network topology of the network 150, for example, based on the plurality of node-related flow information sets, which may be monitored, for example, based on the flow information 135, e.g., as described below.

In some demonstrative aspects, the network topology information may include routing information corresponding to data flow routes between the plurality of networking nodes 153, e.g., as described below.

In some demonstrative aspects, the network topology information may include routing information corresponding to active data flow routes between the plurality of networking nodes 153, e.g., as described below.

In some demonstrative aspects, the active data flow routes may include routes, which may be detected as having actual routing activity for actively routing one or more data flows.

In some demonstrative aspects, network configuration controller 110 may be configured to determine the network topology information to exclude one or more, e.g., some or all, non-active data flow routes, which do not currently have any routing activity, between the plurality of networking nodes 153, e.g., as described below.

In some demonstrative aspects, network configuration controller 110 may be configured to determine the network topology information to include only active data flow routes between the plurality of networking nodes 153, e.g., as described below.

In one example, the network topology information may include routing information corresponding to substantially all active data flow routes, which include actual traffic. For example, the network topology information may be configured to exclude information of potential and/or possible routes, which do not include any actual traffic.

In some demonstrative aspects, network configuration controller 110 may be configured to identify the active data flow routes, for example, based on processing of the data flow information 135, e.g., as described below.

In some demonstrative aspects, network configuration controller 110 may be configured to determine the network topography information, for example, based on the network topology information, e.g., as described below.

In some demonstrative aspects, network configuration controller 110 may be configured to determine the network topography information to include a topography map to map statistical data flow sizes to a plurality of ingress-egress port pairs in the network 150, e.g., as described below.

For example, an ingress-egress port pair may have multiple flows. For example, a flow of the multiple flows, e.g., each flow, may have a different QoS, e.g., traffic class. For example, the topography map may map the statistical data flow sizes, for example, per traffic class, e.g., as described below.

In some demonstrative aspects, the plurality of ingress-egress port pairs may correspond to a plurality of ingress ports of the plurality of networking nodes 153 and a plurality of egress ports of the plurality of networking nodes 153, e.g., as described below.

In some demonstrative aspects, the plurality of ingress-egress port pairs may correspond to a plurality of different ingress-egress port combinations including an ingress port of the plurality of ingress ports and an egress port of the plurality of egress ports, e.g., as described below.

In some demonstrative aspects, an ingress-egress port pair of the plurality of ingress-egress port pairs may include an egress port of a first networking node of the plurality of networking nodes 153 and an ingress port of a second networking node of the plurality of networking nodes 153, e.g., as described below. For example, such an ingress-egress port pair may include a combination of ports of two different networking nodes 153.

In some demonstrative aspects, an ingress-egress port pair of the plurality of ingress-egress port pairs may be configured to include an egress port and an ingress port of a same networking node of the plurality of networking nodes 153, e.g., as described below.

In some demonstrative aspects, network configuration controller 110 may be configured to determine the network topography map, which may be configured to map statistical QoS information to one or more, e.g., some or all, of the plurality of egress ports, e.g., as described below.

In some demonstrative aspects, network configuration controller 110 may be configured to determine the network topography information to include a plurality of statistical ingress data sizes corresponding to the plurality of ingress ports, e.g., as described below.

In some demonstrative aspects, network configuration controller 110 may be configured to determine a statistical ingress data size corresponding to an ingress port, for example, based on statistical data flow sizes mapped to ingress-egress port pairs including the ingress port, for example, based on the flow information 135, e.g., as described below.

In some demonstrative aspects, network configuration controller 110 may be configured to determine the network topography information to include a plurality of statistical egress data sizes corresponding to the plurality of egress ports, e.g., as described below.

In some demonstrative aspects, network configuration controller 110 may be configured to determine a statistical egress data size corresponding to an egress port, for example, based on statistical data flow sizes mapped to ingress-egress port pairs including the egress port, e.g., as described below.

In some demonstrative aspects, network configuration controller 110 may be configured to determine the network topography information to include any other suitable additional or alternative type of information.

In some demonstrative aspects, network configuration controller 110 may be configured to utilize a Machine Learning (ML) engine 124 in determining the network-configuration setting 131, e.g., as described below.

In some demonstrative aspects, the ML engine 124 may be implemented by the one or more processors 120.

In other aspects, the ML engine 124 may be implemented by one or more dedicated processors, which may be dedicated to the ML engine 124.

In some demonstrative aspects, ML engine 124 may be trained to generate ML output information based on an ML input, which may be based on the plurality of node-related flow information sets monitored by the network configuration controller 110, e.g., as described below.

In some demonstrative aspects, network configuration controller 110 may be configured to generate the network-configuration setting 131, for example, based on the ML output information, e.g., as described below.

In some demonstrative aspects, ML engine 124 may include a Reinforcement Learning (RL) engine, for example, a Deep Reinforcement Learning (DRL) engine, e.g., as described below.

In some demonstrative aspects, the DRL engine may be configured to generate the ML output information including action information, for example, based on the ML input including observation information and reward information, e.g., as described below.

In some demonstrative aspects, network configuration controller 110 may be configured to configure the observation information for the DRL engine, for example, based on the plurality of node-related flow information sets, which may be monitored based on the flow information 135, e.g., as described below.

In some demonstrative aspects, network configuration controller 110 may be configured to configure the reward information for the DRL engine, for example, based on the at least one target E2E performance parameter, e.g., as described below.

In some demonstrative aspects, network configuration controller 110 may be configured to determine the network-configuration setting 131, for example, based on the action information provided by the DRL engine, e.g., as described below.

In some demonstrative aspects, network configuration controller 110 may be configured to selectively activate or deactivate a learning process of the DRL engine, for example, based on one or more reward criteria applied to the reward information, e.g., as described below.

In other aspects, ML engine 124 may include any other suitable additional or alternative type of ML engine.

In some demonstrative aspects, network configuration controller 110 may be configured to configure the ML input information for the ML engine 124, for example, based on the network topography information, e.g., as described below.

In some demonstrative aspects, network configuration controller 110 may be configured to determine size-reduced network topography information, for example, by reducing a size of the network topography information, e.g., as described below.

In some demonstrative aspects, network configuration controller 110 may be configured to determine the network-configuration setting 131, for example, based on the ML output information from the ML engine 124, which may correspond to the subset of networking nodes, e.g., as described below.

In some demonstrative aspects, network configuration controller 110 may be configured to reduce the size of the network topography information, for example, based on a size of the ML input of ML engine 124, e.g., as described below.

In some demonstrative aspects, network configuration controller 110 may be configured to configure the ML input to ML engine 124, for example, based on the size-reduced network topography information, e.g., as described below.

In some demonstrative aspects, network configuration controller 110 may be configured to determine the size-reduced network topography information, for example, to provide a technical solution to support an efficient implementation of ML engine 124, e.g., as described below.

For example, the size of the network topography information may be very large, for example, in implementations where the network 150 includes a relatively large number of networking nodes 153, and/or a relatively large number of ingress ports and/or egress ports.

For example, the size-reduced network topography information may be implemented to provide a technical solution to support an implementation of ML engine 124 with a relatively small ML input size, e.g., as described below.

In some demonstrative aspects, network configuration controller 110 may be configured to determine the size-reduced network topography information to include network topography information corresponding to a subset of networking nodes 153, e.g., as described below.

In some demonstrative aspects, network configuration controller 110 may be configured to determine the size-reduced network topography information to include network topography information corresponding to a subset of the ingress-egress port pairs corresponding to the networking nodes 153, e.g., as described below.

For example, the subset of networking nodes may include up to 30% of the plurality of networking nodes 153 in network 150, and/or of the ingress-egress port pairs corresponding to the networking nodes 153.

For example, the subset of networking nodes may include no more than 20% of the plurality of networking nodes 153 in network 150, and/or of the ingress-egress port pairs corresponding to the networking nodes 153.

For example, the subset of networking nodes may include no more than 10% of the plurality of networking nodes 153 in network 150, and/or of the ingress-egress port pairs corresponding to the networking nodes 153.

For example, the subset of networking nodes may include no more than 5% of the plurality of networking nodes 153 in network 150, and/or of the ingress-egress port pairs corresponding to the networking nodes 153.

For example, the subset of networking nodes may include no more than 1% of the plurality of networking nodes 153 in network 150, and/or of the ingress-egress port pairs corresponding to the networking nodes 153.

In other aspects, the subset of networking nodes may be configured to include any other portion of the plurality of networking nodes 153 in network 150, and/or the ingress-egress port pairs corresponding to the networking nodes 153.

In some demonstrative aspects, network configuration controller 110 may be configured to select the subset of networking nodes and/or the ingress-egress port pairs corresponding to the networking nodes 153, for example, based on a selection criterion corresponding to the node-related flow information sets, e.g., as described below.

In some demonstrative aspects, network configuration controller 110 may be configured to determine the subset of networking nodes and/or the ingress-egress port pairs corresponding to the networking nodes 153, for example, based on a selection criterion, which relates to statistical data sizes, for example, the statistical flow sizes, the statistical ingress data sizes and/or the statistical egress data sizes, e.g., as described below.

In some demonstrative aspects, network configuration controller 110 may be configured to determine the subset of networking nodes and/or the ingress-egress port pairs corresponding to the networking nodes 153, for example, based on a selection criterion, which may be configured to identify networking nodes having relatively high statistical data sizes, for example, the statistical flow sizes, the statistical ingress data sizes and/or the statistical egress data sizes, e.g., as described below.

In other aspects, any other additional or alternative selection criterion may be implemented.

In some demonstrative aspects, network configuration controller 110 may be configured to maintain the network topography information corresponding to the plurality of networking nodes 153, e.g., including the full network topography information corresponding to all of the plurality of networking nodes 153. For example, network configuration controller 110 may be configured to maintain the network topography information corresponding to the plurality of networking nodes 153 in memory 122.

In some demonstrative aspects, network configuration controller 110 may be configured to update the network topography information corresponding to the plurality of networking nodes 153, for example, based on the ML output information from ML engine 124, which may correspond to the subset of networking nodes, e.g., as described below.

For example, network configuration controller 110 may be configured to maintain an indication of which networking nodes 153 are included in the subset of networking nodes, for which the size-reduced network topography information is provided to the ML engine 124, e.g., as escribed below.

In some demonstrative aspects, network configuration controller 110 may be configured to determine the network-configuration setting 131 to include one or more node-specific parameter settings corresponding to one or more networking nodes of the plurality of networking nodes 153, e.g., as described below.

In some demonstrative aspects, network configuration controller 110 may be configured to determine a node-specific parameter setting of the one or more node-specific parameter settings to include a threshold setting for the one or more networking nodes, e.g., as described below.

In some demonstrative aspects, network configuration controller 110 may be configured to determine a node-specific parameter setting of the one or more node-specific parameter settings to include a Priority Flow Control (PFC) setting for one or more ingress ports, e.g., as described below.

In some demonstrative aspects, the PFC setting may include a setting of one or more PFC parameters, which may be implemented according to a PFC mechanism, e.g., as described below.

In some demonstrative aspects, the PFC setting may include a PFC threshold setting of a PFC threshold, e.g., as described below.

Some demonstrative aspects are described below with respect to determining the network-configuration setting 131 to include a PFC threshold setting, e.g., as described below. In other aspects, the network-configuration setting 131 may be determined to include a setting of any other suitable additional or alternative PFC parameter.

In some demonstrative aspects, network configuration controller 110 may be configured to determine a node-specific parameter setting of the one or more node-specific parameter settings to include an Explicit Congestion Notification (ECN) setting for one or more egress ports, e.g., as described below.

In some demonstrative aspects, the ECN setting may include a setting of one or more ECN parameters, which may be implemented according to an ECN mechanism, e.g., as described below.

In some demonstrative aspects, the ECN setting may include an ECN threshold setting of an ECN threshold, e.g., as described below.

Some demonstrative aspects are described below with respect to determining the network-configuration setting 131 to include an ECN threshold setting, e.g., as described below. In other aspects, the network-configuration setting 131 may be determined to include a setting of any other suitable additional or alternative ECN parameter.

In some demonstrative aspects, network configuration controller 110 may be configured to determine a node-specific parameter setting of the one or more node-specific parameter settings to include a maximal buffer queue size (Qsize) setting for one or more egress ports, e.g., as described below.

In some demonstrative aspects, network configuration controller 110 may be configured to determine a node-specific parameter setting of the one or more node-specific parameter settings to include at least one QoS setting, e.g., as described below.

In some demonstrative aspects, network configuration controller 110 may be configured to determine the one or more node-specific parameter settings to include any other additional or alternative node-specific parameter settings.

In some demonstrative aspects, network configuration controller 110 may be configured to determine the network-configuration setting 131 to include at least one ingress-port setting, e.g., as described below.

In some demonstrative aspects, the at least one ingress-port setting may include an ECN setting, e.g., as described below.

In some demonstrative aspects, the at least one ingress-port setting may include a maximal buffer queue size setting, e.g., as described below.

In other aspects, the at least one ingress-port setting may include any other additional or alternative setting.

In some demonstrative aspects, network configuration controller 110 may be configured to determine the at least one ingress-port setting, which may be configured, for example, such that any PFC event based on a PFC setting is not to occur before an ingress-port event based on the at least one ingress-port setting, e.g., as described below.

In some demonstrative aspects, network configuration controller 110 may be configured to determine the at least one ingress-port setting, which may be configured, for example, such that a probability of the occurrence of any PFC event based on a PFC setting before an ingress-port event based on the at least one ingress-port setting may be below a predefined probability, e.g., as described below.

In some demonstrative aspects, network configuration controller 110 may be configured to determine the at least one ingress-port setting, which may be configured, for example, to avoid a probable or predicted PFC event, which may occur based on the PFC setting, for example, if the at least one ingress-port setting is not implemented, e.g., as described below.

In some demonstrative aspects, network configuration controller 110 may be configured to determine the network-configuration setting 131 to include a routing setting of a routing topology to route the data flows from the plurality of network inputs 151 to the plurality of network outputs 155, e.g., as described below.

In some demonstrative aspects, network configuration controller 110 may be configured to determine the network-configuration setting 131 to include any other suitable additional or alternative information to configure the network 150.

In some demonstrative aspects, network configuration controller 110 may be configured to determine the network-configuration setting 131 for the network 150 connecting between a plurality of processors of an Artificial Intelligence (AI) training cluster, e.g., as described below.

In some demonstrative aspects, network configuration controller 110 may be configured to determine the network-configuration setting 131 for the network 150 including a communication network to communicate content between one more content providers and a plurality of end users, e.g., as described below.

In some demonstrative aspects, network configuration controller 110 may be configured to monitor QoE information corresponding to the plurality of end users, e.g., at endpoints 164, and to the determine the network-configuration setting 131, for example, based on the QoE information corresponding to plurality of end users, e.g., as described below.

In some demonstrative aspects, the QoE information corresponding to an end user may include QoE information corresponding to one or more applications used by the end user.

In one example, the QoE information corresponding the end user may include information of a plurality of QoEs corresponding to a plurality of applications used by the end user.

For example, two or more of the applications may have a same QoE, and/or two or more of the applications may have two or more different QoEs.

In one example, a first application may have a first QoE requirement, e.g., a relatively-higher QoE requirement, and a second application may have a second QoE requirement, e.g., a relatively-lower QoE requirement. For example, the first application may include a high-quality video streaming application, and/or the second application may include a video-conferencing application.

In another example, an application may be used by multiple end users. For example, two or more of end user of the application may have a same QoE, and/or two or more end users of the applications may have two or more different QoEs.

For example, network configuration controller 110 may be configured to monitor QoE information corresponding to the plurality of end users, e.g., at endpoints 164, and to the determine the network-configuration setting 131, for example, based on a first QoE requirement, e.g., a relatively-higher QoE, for one or more first end users and/or for one or more applications used by the one or more first end users; and/or based on based on a second QoE requirement, e.g., a relatively lower QoE, for one or more second end users and/or for one or more applications used by the one or more second end users.

In some demonstrative aspects, network configuration controller 110 may be configured to determine the network-configuration setting 131 based on at least one target E2E performance parameter corresponding to the E2E performance of the plurality of data flows over the communication network 150 including a plurality of communication networks, e.g., as described below.

In some demonstrative aspects, network configuration controller 110 may be configured to determine the network-configuration setting 131 based on at least one target E2E performance parameter corresponding to the E2E performance of the plurality of data flows over the communication network 150 including a first communication network, e.g., managed by a first network manager 154, and a second communication network, e.g., managed by a second network manager 154.

In some demonstrative aspects, network configuration controller 110 may be configured to determine the network-configuration setting 131 to include a first network-configuration setting for the first network manager 154, and a second network-configuration setting for the second network manager 154, e.g., as described below.

In some demonstrative aspects, network configuration controller 110 may be configured to determine a plurality of network-configuration settings for the plurality of communication networks in network 150, e.g., the first network-configuration setting for the first network manager 154 and a second network-configuration setting for the second network manager 154, e.g., as described below.

In some demonstrative aspects, network configuration controller 110 may be configured to determine a plurality of network-configuration settings, for example, based on the at least one target E2E performance parameter, which may correspond to the E2E performance of the plurality of data flows between the plurality of endpoints 162 and the plurality of endpoints 164, for example, over then entire network 150 including the plurality of communication networks, e.g., as described below.

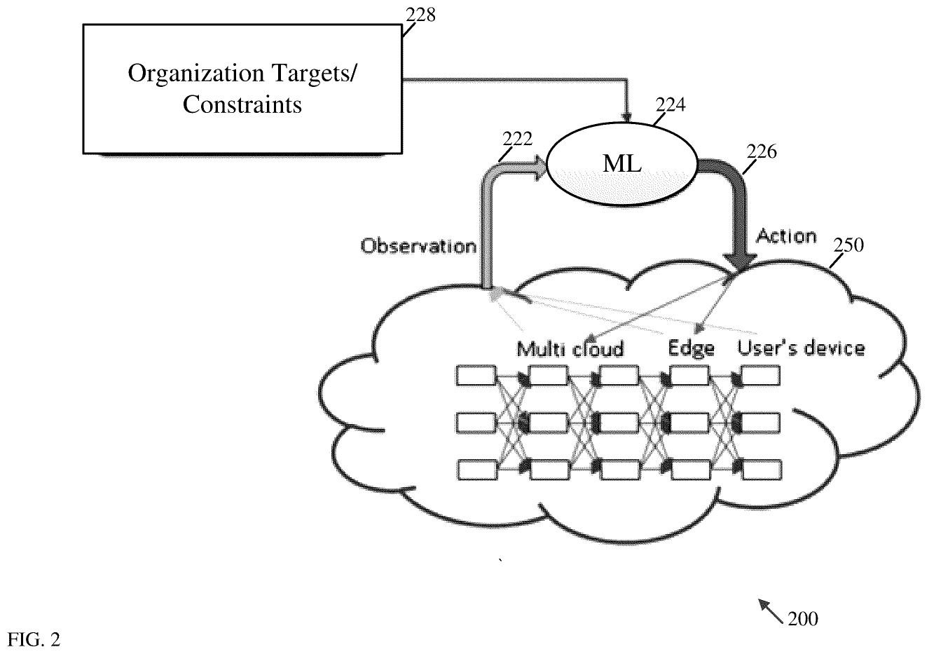

Reference is made to FIG. 2, which conceptually illustrates a ML-based network-configuration scheme 200, in accordance with some demonstrative aspects.

In some demonstrative aspects, as shown in FIG. 2, an ML engine 224 may be trained to generate one or more actions 226, for example, based on one or more observations 222 corresponding to a network 250.

For example, ML engine 224 may perform one or more operations and/or functionalities of ML engine 124 (FIG. 1).

In some demonstrative aspects, the observations 222 may be configured based on data flow information corresponding to the network. For example, network configuration controller 110 (FIG. 1), may be configured to determine the observations 222, for example, based on the monitored data flow information 135 (FIG. 1).

In some demonstrative aspects, the actions 226 may be utilized to determine a network-configuration setting to control the configuration of network 250.

For example, network configuration controller 110 (FIG. 1), may be configured to determine the network-configuration setting 131 (FIG. 1), for example, based on the actions 226 provided by the ML engine 224.

In some demonstrative aspects, as shown in FIG. 2, ML engine 224 may be configured to determine the actions 226, for example, based on one or more targets and/or constraints 228.

In some demonstrative aspects, the one or more targets and/or constraints 228 may include, or may be based on, at least one target E2E performance parameter, e.g., as described above.

For example, network configuration controller 110 (FIG. 1), may be configured to determine the one or more targets and/or constraints 228, for example, based on at least one target E2E performance parameter, which may be defined based on user input, which may be received, for example, via the user interface 130, e.g., as described above.

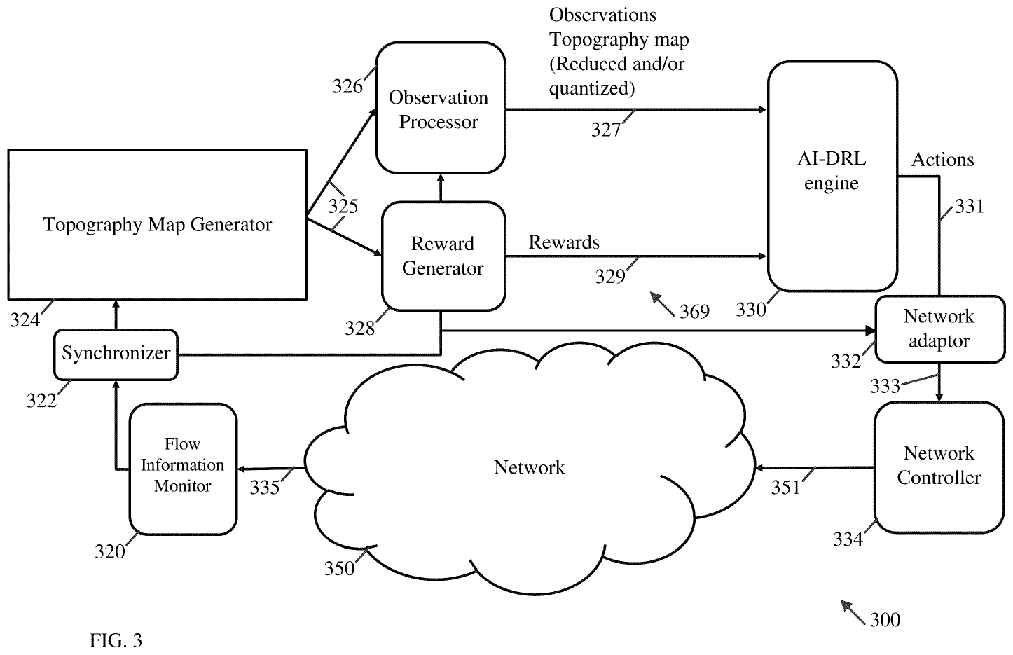

Reference is made to FIG. 3, which schematically illustrates a ML-based network-configuration system 300, in accordance with some demonstrative aspects.

For example, configuration controller 102 (FIG. 1) may include one or more components of the network-configuration system 300, and/or may perform one or more operations and/or functionalities of network-configuration system 300.

In some demonstrative aspects, as shown in FIG. 3, ML-based network-configuration system 300 may be configured to provide a technical solution to controllably set a configuration of a network 350, e.g., as described below.

For example, network 350 may include one or more components of the network 150 (FIG. 1), and/or may perform one or more operations and/or functionalities of the network 150 (FIG. 1).

In some demonstrative aspects, as shown in FIG. 3, ML-based network-configuration system 300 may include a flow information monitor 320, which may be configured to monitor flow information 335 corresponding to networking nodes of the network 350, e.g., networking nodes 153 (FIG. 1).

For example, flow information monitor 320 may include one or more components of information monitor 126 (FIG. 1), and/or may perform one or more operations and/or functionalities of information monitor 126 (FIG. 1).

In some demonstrative aspects, as shown in FIG. 3, ML-based network-configuration system 300 may include a topography map generator 324, which may be configured to generate, maintain, update, and/or adjust a topography map 325 corresponding to data flows communicated via the network 350, e.g., as described below.

For example, configuration setting controller 128 (FIG. 1) may include one or more components of topography map generator 324, and/or may perform one or more operations and/or functionalities of topography map generator 324.

In some demonstrative aspects, the topography map generator 324 may be configured to generate, maintain, update, and/or adjust the topography map 325, for example, based on the monitored flow information 335, e.g., as described below.

In some demonstrative aspects, the topography map generator 324 may be configured to generate, maintain, update, and/or adjust the topography map 325, for example, based on a plurality of node-related flow information sets, which may be monitored based on the flow information 335, e.g., as described below.

In some demonstrative aspects, as shown in FIG. 3, ML-based network-configuration system 300 may be configured to determine a network-configuration setting 333 to configure the network 350, for example, based on the topography map 325, e.g., as described below.

In some demonstrative aspects, as shown in FIG. 3, ML-based network-configuration system 300 may be configured to determine the network-configuration setting 333 based on an ML output 331 of an AI-DRL engine 330, e.g., as described below.

In other aspects, ML-based network-configuration system 300 may be configured to utilize any other suitable additional or alternative type of ML engine to provide the ML output 331, which may be utilized to determine the network-configuration setting 333.

For example, ML engine 124 (FIG. 1) may include one or more components of AI-DRL engine 330, and/or may perform one or more operations and/or functionalities of AI-DRL engine 330.

In some demonstrative aspects, as shown in FIG. 3, the AI-DRL engine 330 may be trained to generate the ML output 331 including action information, for example, based on an ML input 369 including observation information 327 and reward information 329, e.g., as described below.

In other aspects, ML-based network-configuration system 300 may be configured to utilize any other suitable additional or alternative type of ML engine, which may be trained to generate the ML output 331 including any other additional or alternative type and/or form of information, for example, based on the ML input 369 including any other suitable additional or alternative type and/or form of information, for example, according to the type and/or configuration of the ML engine.

In some demonstrative aspects, ML-based network-configuration system 300 may include a reward processor 328, which may be configured to provide the reward information 329 to the AI-DRL engine 330, e.g., as described below.

For example, configuration setting controller 128 (FIG. 1) may include one or more components of reward processor 328, and/or may perform one or more operations and/or functionalities of reward processor 328.

In some demonstrative aspects, reward processor 328 may be configured to determine the reward information 329, for example, based on at least one target E2E performance parameter corresponding to an E2E performance of the network 350, e.g., as described below.

In some demonstrative aspects, reward processor 328 may be configured to determine the reward information 329, for example, based on topography map information of the topography map 325 and according to the at least one target E2E performance parameter, e.g., as described below.

In some demonstrative aspects, processor 328 may be configured to determine the reward information 329, for example, per optimization target, e.g., per target E2E performance parameter.

In some demonstrative aspects, reward processor 328 may be configured to determine the reward information 329, for example, based on a target JCT, for example, in an implementation for a network 350 including an AI training cluster, or any other suitable type of network, which may be configured using the target JCT, e.g., as described below.

In some demonstrative aspects, reward processor 328 may be configured to determine the reward information 329, for example, based on a target QoE, and/or a target QoS, for example, in an implementation for a network 350 including a communication network, or any other suitable type of network, which may be configured using the target QoE and/or the target QoS, e.g., as described below.

In other aspects, reward processor 328 may be configured to determine the reward information 329, for example, based on a target E2E delay, a target E2E bandwidth, a target E2E power consumption, and/or any other additional or alternative target E2E parameter.

In some demonstrative aspects, reward processor 328 may be configured to selectively activate or deactivate a learning process of the AI-DRL engine 330, for example, based on one or more reward criteria applied to the reward information 329, e.g., as described below.

In some demonstrative aspects, ML-based network-configuration system 300 may include an observation processor 326, which may be configured to provide the observation information 327 to the AI-DRL engine 330, for example, based on the topography map 325, e.g., as described below.

For example, configuration setting controller 128 (FIG. 1) may include one or more components of observation processor 326, and/or may perform one or more operations and/or functionalities of observation processor 326.

In some demonstrative aspects, observation processor 326 may be configured to generate the observation information 327 to include size-reduced network topography information, which may be based on the topography map 325, e.g., as described below.

In some demonstrative aspects, observation processor 326 may be configured to generate the observation information 327, for example, by reducing (quantizing) a size of the network topography information of the topography map 325, e.g., as described below.

In some demonstrative aspects, observation processor 326 may be configured to configure a size of the size-reduced network topography information, for example, to provide a technical solution to support an efficient implementation of the AI-DRL engine 330, e.g., as described below.

For example, the size of the network topography information 325 may be very large, for example, in implementations where the network 350 includes a relatively large number of networking nodes, and/or a relatively large number of ingress ports and/or egress ports.

In some demonstrative aspects, observation processor 326 may be configured to configure the size of the size-reduced network topography information, for example, to provide a technical solution to support an implementation of the AI-DRL engine 330 with a relatively small size of the observation information 327, for example, compared to the relatively large size of the topography map 325, e.g., as described below.

In some demonstrative aspects, observation processor 326 may be configured to determine the size-reduced network topography information to include network topography information corresponding to a subset of networking nodes selected from the plurality of networking nodes being monitored by the topography map 325, e.g., as described below.

In some demonstrative aspects, observation processor 326 may be configured to determine the size-reduced network topography information to include network topography information corresponding to a subset of the ingress-egress port pairs being monitored by the topography map 325, e.g., as described below.

For example, the subset of networking nodes may include up to 30% of the plurality of networking nodes and/or the ingress-egress port pairs being monitored by the topography map 325.

For example, the subset of networking nodes may include no more than 20% of the plurality of networking nodes and/or the ingress-egress port pairs being monitored by the topography map 325.

For example, the subset of networking nodes may include no more than 10% of the plurality of networking nodes and/or the ingress-egress port pairs being monitored by the topography map 325.

For example, the subset of networking nodes may include no more than 5% of the plurality of networking nodes and/or the ingress-egress port pairs being monitored by the topography map 325.

For example, the subset of networking nodes may include no more than 1% of the plurality of networking nodes and/or the ingress-egress port pairs being monitored by the topography map 325.

In other aspects, the subset of networking nodes may be configured to include any other portion of the plurality of networking nodes and/or the ingress-egress port pairs being monitored by the topography map 325.

In some demonstrative aspects, observation processor 326 may be configured to select the subset of networking nodes and/or the ingress-egress port pairs being monitored by the topography map 325, for example, based on a selection criterion corresponding to the information monitored by the topography map 325, e.g., as described below.

In some demonstrative aspects, observation processor 326 may be configured to determine the subset of networking nodes and/or the ingress-egress port pairs being monitored by the topography map 325, for example, based on a selection criterion, which relates to statistical data sizes, for example, statistical flow sizes, statistical ingress data sizes and/or statistical egress data sizes, which may be monitored by the topography map 325, e.g., as described below.

In some demonstrative aspects, observation processor 326 may be configured to determine the subset of networking nodes and/or ingress-egress port pairs being monitored by the topography map 325, for example, based on a selection criterion, which may be configured to identify networking nodes having relatively high statistical data sizes, for example, statistical flow sizes, statistical ingress data sizes and/or statistical egress data sizes, e.g., as described below.

For example, observation processor 326 may be configured to determine the subset of networking nodes and/or the ingress-egress port pairs to include networking nodes and/or ingress-egress port pairs having the highest statistical data sizes, for example, statistical flow sizes, statistical ingress data sizes and/or statistical egress data sizes, e.g., as described below.

In other aspects, any other additional or alternative selection criterion may be implemented.

In some demonstrative aspects, as shown in FIG. 3, ML-based network-configuration system 300 may include a network adaptor 332, which may be configured to generate the network-configuration setting 333 to configure the network 350, for example, based on the ML output 331, e.g., provided by AI-DRL engine 330, e.g., as described below.

For example, configuration setting controller 128 (FIG. 1) may include one or more components of network adaptor 332, and/or may perform one or more operations and/or functionalities of network adaptor 332.

In some demonstrative aspects, as shown in FIG. 3, ML-based network-configuration system 300 may include a synchronizer 322, which may be configured to synchronize between the flow information provided to topography map generator 324 and the operation of observation processor 326, reward processor 328, and/or network adapter 332.

For example, network configuration controller 110 (FIG. 1) may include one or more components of synchronizer 322, and/or may perform one or more operations and/or functionalities of synchronizer 322.

For example, synchronizer 322 may be configured to provide a technical solution to synchronize the operations of topography map generator 324, observation processor 326, reward processor 328 and/or network adapter 332, with respect to the same flow information provided by the flow information

In some demonstrative aspects, network adaptor 332 may be configured to maintain and/or manage the network topography information of the topography map 325, e.g., including the full network topography information corresponding to all of the plurality of networking nodes being monitored.

In some demonstrative aspects, network adaptor 332 may be configured to identify the subset of networking nodes and/or the ingress-egress port pairs to which the ML output 331 corresponds, e.g., as described below.

In some demonstrative aspects, network adaptor 332 may be configured to identify the subset of networking nodes and/or the ingress-egress port pairs to which the ML output 331 corresponds, for example, based on suitable identification information, which may be provided by observation processor 326.

In some demonstrative aspects, network adaptor 332 may be configured to maintain an indication of which networking nodes are included in the subset of networking nodes and/or which ingress-egress port pairs are included in the subset of ingress-egress port pairs, for which the size-reduced network topography information 327 is provided to the AI-DRL engine 330, e.g., as escribed below.

In some demonstrative aspects, network adaptor 332 may be configured to determine the network-configuration setting 333 with respect to the subset of networking nodes and/or ingress-egress port pairs to which the ML output 331 corresponds, for example, based on the action information in ML output 331, e.g., as described below.

For example, the topography map 325 may include topography map information corresponding to a first count, denoted M, of ingress-egress port pairs, and the AI-DRL engine 330 may be configured to support a size of the observation information 327 corresponding to a second count, denoted N, of a size-reduced subset of ingress-egress port pairs, e.g., wherein M>N.

In one example, the value of M may be at least 5 times the value of N.

In one example, the value of M may be at least 10 times the value of N.

In one example, the value of M may be at least 20 times the value of N.

In one example, the value of M may be at least 30 times the value of N.

In one example, the value of M may be at least 50 times the value of N.

In one example, the value of M may be at least 100 times the value of N.

In one example, the value of M may be at least 1000 times the value of N.

In one example, the value of M may be at least 5000 times the value of N.

In one example, the value of M may be at least 10000 times the value of N.

In other aspects, the value of M be greater than the value of N according to any other suitable factor.

For example, observation processor 326 may be configured to provide the observation information 327 corresponding to the size-reduced subset of ingress-egress port pairs.

For example, observation processor 326 may be configured to provide to network adaptor 332 selection information to indicate the size-reduced subset of ingress-egress port pairs, and/or to indicate the networking nodes including the size-reduced subset of ingress-egress port pairs.

For example, network adaptor 332 may be configured to maintain and/or manage the network-configuration setting 333 corresponding to the M ingress-egress port pairs.

For example, network adaptor 332 may be configured to identify the N ingress-egress port pairs to which the ML output 331 corresponds, for example, based on the selection information provided by observation processor 326.

For example, network adaptor 332 may be configured to update the network-configuration setting 333 corresponding to the N ingress-egress port pairs, for example, based on the action information in the ML output 331.

In some demonstrative aspects, the network-configuration setting 333 may include a PFC setting, e.g., a PFC threshold setting, for one or more ingress ports, an ECN setting, e.g., an ECN threshold setting, for one or more egress ports, and/or a maximal buffer queue size (Qsize) setting for the one or more egress ports, e.g., as described below.

In some demonstrative aspects, the network-configuration setting 333 may be configured on a per traffic class basis. For example, the network-configuration setting 333 may include a PFC setting, e.g., a PFC threshold setting, for one or more ingress ports, e.g., per traffic class per ingress port; an ECN setting, e.g., an ECN threshold setting, for one or more egress ports, e.g., per traffic class per egress port; and/or a maximal buffer queue size (Qsize) setting for the one or more egress ports, e.g., per traffic class per egress port, e.g., as described below.

In some demonstrative aspects, network adaptor 332 may be configured to configure the network-configuration setting 333 to include at least one ingress-port setting, for example, an ECN setting and/or a maximal buffer queue size setting, for example, on a per traffic class per port basis, e.g., as described below.

In some demonstrative aspects, network adaptor 332 may configure the at least one ingress-port setting, for example, such that any PFC event based on a PFC setting is not to occur before an ingress-port event based on the at least one ingress-port setting, e.g., as described below.

In some demonstrative aspects, network adaptor 332 may configure the at least one ingress-port setting, for example, such that a probability of the occurrence of any PFC event based on a PFC setting before an ingress-port event based on the at least one ingress-port setting may be below a predefined probability, e.g., as described below.

In some demonstrative aspects, network adaptor 332 may configure the at least one ingress-port setting, for example, to avoid a probable or predicted PFC event, which may occur based on the PFC setting, for example, if the at least one ingress-port setting is not implemented, e.g., as described below.

In some demonstrative aspects, the AI-DRL engine 330 may be trained to generate the action information 331 including a plurality of sets of values, e.g., in the form of vectors or any other form, corresponding to a plurality of parameter types for the network-configuration setting 333, e.g., as described below.

In some demonstrative aspects, the AI-DRL engine 330 may be trained to generate the action information 331 including recommended PFC setting information, e.g., including PFC threshold information, recommended ECN information, e.g., including ECN threshold information, and/or recommended maximal buffer queue size (Qsize) information, e.g., as described below.

For example, the AI-DRL engine 330 may be trained to generate the action information 331 including a set of values, e.g., in the form of a vector (ECN vector) or any other form, which may include, represent, and/or indicate, recommended ECN threshold values corresponding to a plurality of egress ports, e.g., on a per traffic class per egress port basis.

In one example, the recommended ECN threshold values may correspond to a plurality of egress ports, e.g., per traffic class per egress port, included in the selected subset of networking nodes and/or ingress-egress port pairs to which the observation information 327 corresponds.

For example, the AI-DRL engine 330 may be trained to generate the action information 331 including a set of values, e.g., in the form of a vector (PFC vector) or any other form, which may include, represent, and/or indicate, recommended PFC threshold values corresponding to a plurality of ingress ports, e.g., on a per traffic class per ingress port basis.

In one example, the recommended PFC threshold values may correspond to a plurality of ingress ports, e.g., per traffic class per ingress port, included in the selected subset of networking nodes and/or ingress-egress port pairs to which the observation information 327 corresponds.

For example, the AI-DRL engine 330 may be trained to generate the action information 331 including a set of values, e.g., in the form of a vector (queue size (Qsize) vector) or any other form, which may include recommended maximal buffer queue size values corresponding to the plurality of egress ports, e.g., on a per egress port basis.

In one example, the recommended maximal buffer queue size values may correspond to the plurality of egress ports included in the selected subset of networking nodes and/or ingress-egress port pairs to which the observation information 327 corresponds.

In other aspects, the AI-DRL engine 330 may be trained to generate the action information 331 including any other additional or alternative parameter types for the network-configuration setting 333.

In some demonstrative aspects, network adaptor 332 may be configured to provide output (network-configuration) information, which may be based on the network-configuration setting 333, for example, to at least one network controller 334.

For example, the at least one network controller 334 may control a configuration 351 of the network 350, for example, based on the output (network-configuration) information provided by the network adaptor 332.

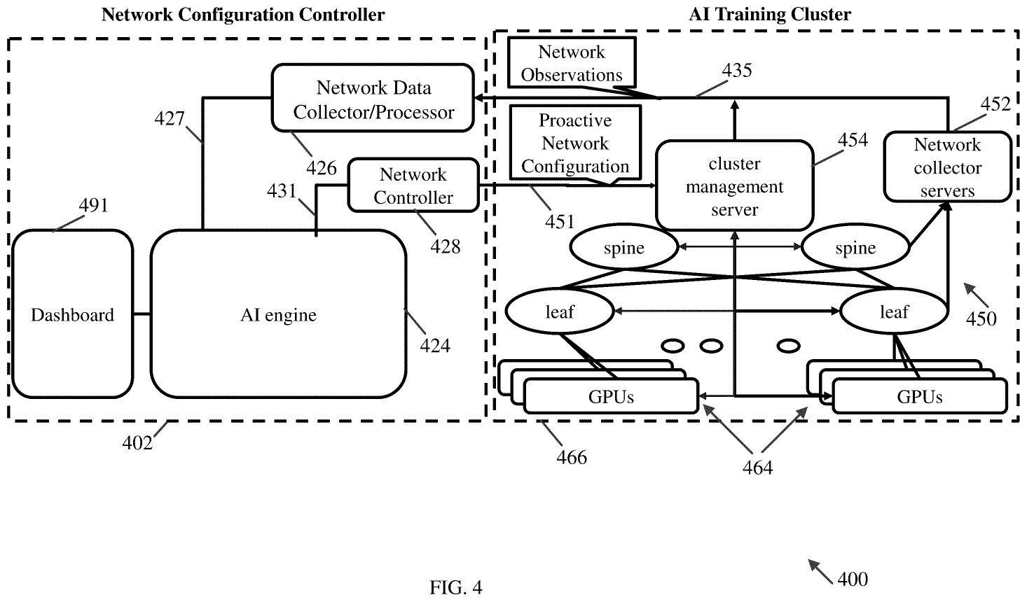

Reference is made to FIG. 4, which schematically illustrates a system 400 including a network configuration controller 402 to controllably set a configuration of a network 450, in accordance with some demonstrative aspects.

For example, configuration controller 102 (FIG. 1) may include one or more components of the network configuration controller 402, and/or may perform one or more operations and/or functionalities of network configuration controller 402.

For example, network 150 (FIG. 1) may include one or more components of the network 450, and/or may perform one or more operations and/or functionalities of the network 450.

In some demonstrative aspects, as shown in FIG. 4, network 450 may include a Clos network, which may be configured according to a Clos architecture, e.g., as described below.

In one example, network 450 may be implemented according to a leaf-spine layout.

In other aspects, network 450 may be implemented according to any other suitable network architecture and/or layout.

In some demonstrative aspects, network 450 may be implemented as part of a computing cluster 466, for example, to interconnect between a plurality of computing resources 464, e.g., as described below.

In some demonstrative aspects, as shown in FIG. 4, computing cluster 466 may include an AI training cluster.

In other aspects, computing cluster 466 may include any other suitable type of computing cluster.

In some demonstrative aspects, as shown in FIG. 4, the plurality of computing resources 464 may include a plurality of GPUs, xPUs, CPUs, NPUs, servers, accelerators, or the like.

For example, the computing cluster 466 may include the plurality of computing resources 464, which may be connected by network 450, for example, to create a larger “compute element”, e.g., by using parallelism methods.

In some demonstrative aspects, network configuration controller 402 may be configured to provide a technical solution to support configuration, e.g., optimization, of a network segment, e.g., network 450, which is implemented to interconnect between the plurality of computing resources 464 of computing cluster 466, e.g., as described below.

In some demonstrative aspects, as shown in FIG. 4, network configuration controller 402 may include a Network Data Collector (NDC) 426, which may be configured to collect and process flow information 435 corresponding to networking nodes of the network 450, e.g., networking nodes 153 (FIG. 1).

For example, NDC 426 may include one or more components of information monitor 126 (FIG. 1), and/or may perform one or more operations and/or functionalities of information monitor 126 (FIG. 1).

For example, NDC 426 may include one or more components of flow information monitor 320 (FIG. 3), synchronizer 322 (FIG. 3), topography map generator 324 (FIG. 3), and/or observation processor 326 (FIG. 3), and/or may perform one or more operations and/or functionalities of flow information monitor 320 (FIG. 3), synchronizer 322 (FIG. 3), topography map generator 324 (FIG. 3), and/or observation processor 326 (FIG. 3).

In some demonstrative aspects, NDC 426 may be configured to receive and/or collect the flow information 435 from one or more information sources, for example, from one or more suitable network collector servers 452, and/or any other additional or alternative type of information sources.

For example, the flow information 435 may include observed flow information, which may be based on, and/or may represent network observations over the network 450, e.g., as described below.

In some demonstrative aspects, the flow information 435 may include information according to an IPFIX protocol, a NETFLOW protocol, an SFLOW protocol, and/or any other suitable additional or alternative protocol and/or format.

In some demonstrative aspects, NDC 426 may be configured to monitor the flow information 435, and to generate processed flow information 427, for example, based on the flow information 435, e.g., as described below.

In some demonstrative aspects, as shown in FIG. 4, network configuration controller 402 may include a network controller 428, which may be configured to provide network configuration information 451 to configure the network 450 according to a network-configuration setting, which may be determined, for example, based on the topography map 325 (FIG. 3), e.g., as described below.

For example, configuration setting controller 128 (FIG. 1) may include one or more components of network controller 428, and/or may perform one or more operations and/or functionalities of network controller 428.

For example, network controller 428 may include one or more components of network adaptor 332 (FIG. 3), and/or may perform one or more operations and/or functionalities of network adaptor 332 (FIG. 3).

In some demonstrative aspects, as shown in FIG. 4, network configuration controller 402 may include an ML engine (AI engine) 424, which may be trained to provide an ML output 431, for example, based on an ML input, which may be based on the processed flow information 427, e.g., as described below.

For example, ML engine 124 (FIG. 1) may include one or more components of ML engine 424, and/or may perform one or more operations and/or functionalities of ML engine 424.

In some demonstrative aspects, network controller 428 may be configured to determine output (network configuration) information 451, for example, based on the ML output 431, e.g., as described below.

In some demonstrative aspects, network controller 428 may be configured to provide the network configuration information 451, for example, to a network manager of network 450, e.g., to a suitable cluster management server 454.

For example, network controller 428 may be configured to provide the output information 451 in the form of proactive network configuration information, for example, to proactively trigger an update to a configuration of the network 450, e.g., as described below.

For example, network controller 428 may be configured to provide the output information 451 in the form of a network configuration recommendation, which may include a recommendation to apply the network-configuration setting to configure the network 450, e.g., as described below.

For example, network controller 428 may be configured to provide the network configuration information 451 in the form of a network configuration instruction, which may include an instruction to apply the network-configuration setting to configure the network 450, e.g., as described below.

In other aspects, the network-configuration information 451 may be provided in any other suitable additional or alternative form and/or configuration.

For example, the cluster management server 454 may control a configuration of the network 450, for example, based on the network configuration information 451.

In some demonstrative aspects, network configuration controller 402 may be configured to provide a user Interface (UI) 491 to a user, for example, to receive input data from the user and/or to provide output data to the user, e.g., as described below.

In some demonstrative aspects, UI 491 may include a Graphical UI (GUI), a dashboard, and/or any other suitable type and/or form of UI.

In some demonstrative aspects, UI 491 may be configured to input from the user at least one optimization target, for example, at least one target E2E parameter, which may be utilized by the network configuration controller 402 in determining the network-configuration information 451, e.g., as described below.

In some demonstrative aspects, network configuration controller 402 may be configured to determine the network configuration information 451, for example, by determining a network-configuration setting to configure the network 450, for example, based on at least one target E2E performance parameter corresponding to an E2E performance over network 450, e.g., as described below.

In some demonstrative aspects, network configuration controller 402 may be configured to determine the network configuration information 451, for example, by determining the network-configuration setting to configure the network 450, for example, based on a JCT over the network 451, e.g., as described below.

In some demonstrative aspects, network configuration controller 402 may be configured to determine the network configuration information 451, for example, by determining the network-configuration setting to optimize the JCT over the network 450, e.g., as described below.

In some demonstrative aspects, network configuration controller 402 may be configured to determine the network configuration information 451, for example, by using the JCT as an optimization target for determining the network-configuration setting to configure the network 450, e.g., as described below.

For example, the Job Completion Time (JCT) of a compute cluster implementing a network, e.g., network 450, may include, for example, the time that may be required for a collection of compute elements connected by the network, e.g., computing resources 464, to process a job, for example, at an application level.

For example, the JCT of the AI training cluster 466, may include a time, which may be required by the computing resources 464 to complete an AI training procedure, while utilizing the network 450.

In other aspects, network configuration controller 402 may be configured to determine the network configuration information 451, for example, by using any other additional or alternative target E2E parameter as an optimization target.

In some demonstrative aspects, the JCT over the network 450 may be considered as an “application-level” QoS parameter for the network 450.

In some demonstrative aspects, the JCT over the network 450 may be managed based on a cluster-level perspective, which may be aware of cluster-level conditions and application-layer requirements, e.g., at an E2E perspective of the cluster implementing network 450.

In some demonstrative aspects, network configuration controller 402 may be configured to process the flow information 435, for example, to identify, e.g., “learn”, traffic patterns of the traffic communicated by network 450, e.g., in real time, e.g., as described below.

In some demonstrative aspects, network configuration controller 402 may be configured to process the flow information 435, for example, to monitor the network status of network 450, e.g., in real time, e.g., as described below.

In some demonstrative aspects, network configuration controller 402 may be configured to predict a configuration, for example, an improved configuration, e.g., an optimized configuration or a best configuration, of the network 450, which may be utilized, for example, to achieve the optimization target, e.g., the JCT, and/or any other additional or alternative optimization target.

In some demonstrative aspects, network configuration controller 402 may be configured to process the flow information 435, for example, to determine a configuration of the network 450, for example, to improve, e.g., to optimize, the JCT, for example, across the AI training cluster 466, e.g., as described below.

In some demonstrative aspects, ML engine 424 may be configured to provide a technical solution, which may exploit statistical characteristics of AI training applications running across AI training cluster 466 at a first time, e.g., at time t=0, for example, to set a network configuration of network 450, which may be configured, e.g., may be optimized, for a predicted traffic pattern of the AI training applications running across AI training cluster 466 at a second time, e.g., at a time t=1+1, as described below.

In some demonstrative aspects, network configuration controller 402 may be configured to identify at least one target E2E parameter to be implemented as an optimization target for configuration of the network 450. For example, network configuration controller 402 may identify that the optimization target is to be the JCT, e.g., based on input received from a user, e.g., via the UI 491.

In some demonstrative aspects, network configuration controller 402 may be configured to identify QoS profiles configured for the AI training cluster 466.

In one example, a cluster operator of the cluster 466 may set the QoS profiles as configured in the cluster 466.

In another example, a Yang path may be utilized to read information of the QoS profiles from the cluster 466.

In some demonstrative aspects, network configuration controller 402 may be configured to identify ports and/or flows that are subject to be configured, e.g., optimized, by the network configuration controller 402.

For example, the cluster operator of cluster 466 may use the UI 491 to set cluster ports, e.g., RDMA ports and/or any other ports, and flows that are to be subject to be optimized by the JCT optimization target.

In some demonstrative aspects, network configuration controller 402 may be configured to identify one or more parameters and/or settings of the network 450, for example, based on input provided via the UI 491.

For example, the cluster operator may use the UI 491 to select whether the cluster 466 uses a scheduled fabric, or a non-scheduled (clos) fabric.

In some demonstrative aspects, network configuration controller 402 may be configured to retrieve the flow information 435 from the one or more information sources 452.

For example, the cluster operator may set an address, e.g., a server address, of network configuration controller 402 as a target for one or more information sources 452, e.g., an IPFIX collector server, a NetFlow collector server, or the like.

For example, the network configuration controller 402 may receive from the cluster operator, e.g., via UI 491, one or more addresses and/or credentials, which may be used by the NDC 426 to access one or more information sources 452, e.g., an IPFIX collector server, a NetFlow collector server, or the like.

In some demonstrative aspects, NDC 426 may be configured to collect flow information 435 corresponding to one or more network elements in network 450, e.g., from all relevant network elements in the cluster 466 that are to subject to the required JCT optimization.

In some demonstrative aspects, NDC 426 may be configured to process the flow information 435 according to a flow information processing mechanism, which may be configured to provide a technical solution to support observing the traffic running via the network 450, for example, even without being part of the network data-path, e.g., as described below.

In some demonstrative aspects, NDC 426 may be configured to collect the flow information 435 in a standard format, e.g., as defined by an IPFIX and/or an NetFlow standard, and/or in any other suitable format.

In one example, the flow information 435 may include one or more, e.g., some or all, of the information elements according to the following format:
User Datagram Protocol, Src Port: 2055, Dst Port: 9919
   Source Port: 2055
   Destination Port: 9919
   Length: 1672
   Checksum: 0x903f [unverified]
   [Checksum Status: Unverified]
   [Stream index: 0]
   [Timestamps]
      [Time since first frame: 140.010239000 seconds]
      [Time since previous frame: 0.000073000 seconds]
   UDP payload (1664 bytes)
SrcAddr 10.10.10.2
DstAddr 10.10.11.18
NextHop: 10.10.11.18
. . .
User Datagram Protocol, Src Port: 2055, Dst Port: 9919
   Source Port: 2055
   Destination Port: 9919
   Length: 70
   Checksum: 0xf4da [unverified]
   [Checksum Status: Unverified]
   [Stream index: 0]
   [Timestamps]
      [Time since first frame: 140.010241000 seconds]
      [Time since previous frame: 0.000002000 seconds]
   UDP payload (62 bytes)
SrcAddr 10.10.10.2
DstAddr 10.10.11.18
NextHop: 10.10.11.18

According to this example, the flow information 435 may include information for a data flow communicated via a networking node of the network 450, e.g., a networking node 153 (FIG. 1).

For example, the flow information 435 may include source address information (SrcAddr) to identify a network input, e.g., a network input 151 (FIG. 1), corresponding to the data flow.

For example, the flow information 435 may include destination address information (DstAddr) to identify a network output, e.g., a network output 155 (FIG. 1), corresponding to the data flow.

For example, the flow information 435 may include destination port information (Source Port) to identify an ingress port of the networking node, e.g., an ingress port of the networking node 153 (FIG. 1), corresponding to the data flow.

For example, the flow information 435 may include source port information (Destination Port) to identify an egress port of the networking node, e.g., an egress port of the networking node 153 (FIG. 1), corresponding to the data flow.

For example, the flow information 435 may include source length information (Length) to identify data length corresponding to the data flow.

For example, the flow information 435 may include next-hop information (NextHop) to identify a next-hop networking node, e.g., a next-hop networking node 153 (FIG. 1), corresponding to the data flow.

For example, the flow information 435 may include timing information (Timestamps) including information of one or more timing parameters corresponding to the data flow.

In some demonstrative aspects, NDC 426 may be configured to process the flow information 435, e.g., in real time, e.g., as described below.

In some demonstrative aspects, NDC 426 may be configured to extract ingress traffic patterns corresponding to data flows via ingress ports of networking nodes of the network 450, for example, based on the flow information 435, e.g., as described below.

In some demonstrative aspects, NDC 426 may be configured to determine a topography map, for example, based on the ingress traffic patterns, e.g., as described below.

In some demonstrative aspects, NDC 426 may be configured to utilize the topography map, for example, to map the data flows per ingress ports and traffic class, for example, versus the egress ports of the networking nodes, e.g., as described below.

In some demonstrative aspects, NDC 426 may be configured to extract and/or monitor a node-related flow information set for a networking node, e.g., for each networking node, for example, including one or more, e.g., some or all, of the following information elements based on the flow information 435:
Global frame information
Timing information
Flow Sequence
Number of Flows
Per Flow information:
   FlowID
   Input Interface
   Interface Name
   Ingress VRFID
   flowlength
   Src port
   Dst port
   Nexthop_ip
   destinationIPv4Address
   sourceIPv4Address

In some demonstrative aspects, NDC 426 may be configured to extract and/or monitor one or more additional or alternative information elements based on the flow information 435.

In some demonstrative aspects, NDC 426 may be configured to determine and monitor an active network topology of the network 450, e.g., in real time, e.g., as described below.

In some demonstrative aspects, the active network topology of the network 450 may include active data flow routs, between networking nodes of the network 450.

For example, an active data flow route may include a route which may include an active data flow, e.g., including traffic, between networking nodes.

In some demonstrative aspects, the active network topology of the network 450 may be implemented to monitor the data flows via the active data flow routes, which may change in real time, for example, in opposed to a pre-configured (static) network topology, which may be preconfigured, and may include non-active routes between networking nodes.

For example, a physical (static) network topology may be set by network engineers, for example, by physically connecting networking nodes, e.g., by cables, in a topology that is intended to support one or more predefined network goals.

In one example, such a physical network topology may be used to connect Ns servers/accelerators to each other. For example, the Ns servers/accelerators may be connected to Y leaf switches with aggregated number of ports equal to Ns, and the Y leaf switches may be connected to X spine switches, e.g., by a clos topology. For example, a fixed predefined network configuration may be used to support an average traffic pattern.

For example, in real-time operation, some paths of the network might be congested, while other paths might be underutilized, for example, in case the cluster topology is not aware of the actual application's traffic patterns.

In some demonstrative aspects, NDC 426 may be configured to determine and monitor an active network topology of the network 450, e.g., in real time, for example, to provide a technical solution to address at least some of these inefficiencies of the static network topology.

For example, NDC 426 may be configured to determine and monitor an active network topology of the network 450, e.g., based on the monitored node-related flow information sets corresponding to the networking nodes of network 450, for example, to provide a technical solution to monitor a dynamic topology model of network 450, for example, according to the actual flows entering the network cluster, e.g., at any given moment.

In some demonstrative aspects, NDC 426 may be configured to process the flow information 435 according to a software-based network traffic processing mechanism, which may be configured to provide a technical solution to process traffic pattern information in real-time, for example, by software, e.g., even in cases where a traffic rate may of the cluster 466 may be very high, e.g., higher than a data rate supported by software-based processing.

For example, a cluster having 10000 ports, e.g., each port having a rate of 400 Gbps, may run at an aggregated cluster traffic rate of (400×10\hat{ }9)×(10×10\hat{ }3)=4×10\hat{ }15 bps, which may be much higher than a data rate supported by software-based processing techniques, e.g., up to 1×10\hat{ }7 bps.

In some demonstrative aspects, the software-based network traffic processing mechanism may be configured to utilize a switch capability, which may support sampling ingress traffic at a specified rate, e.g., 1:1000.

In some demonstrative aspects, NDC 426 may be configured to split a time dimension into timeframes. For example, NDC 426 may process the received flow information 435 to build a novel internal virtual topography map, for example, for a timeframe, e.g., for each timeframe, e.g., as described below.

In some demonstrative aspects, the virtual topography map may be defined according to a two-dimensional map format, for example, where a vertical axis of the map may include information for the ingress interfaces, e.g., per Traffic Class (T.C), and the horizontal axis of the map may include information of the egress interfaces, e.g., as described below.

In some demonstrative aspects, NDC 426 may be configured to use the monitored flow information 435, for example, to fill in cells, e.g., in each specific cell, of the topography map aggregated packet sizes per flow that entered the cluster and matched the specific cell per time frame, e.g., as described below.

In some demonstrative aspects, NDC 426 may be configured to update the topography map to include a representation of the exact amount of traffic that may need to traverse the cluster, e.g., from all its input ports to all its output ports, for example, including the required quality of service, e.g., as may be represented by the T.C., e.g., as described below.

In some demonstrative aspects, NDC 426 may be configured to utilize the topography map to provide a technical solution to estimate the ingress and egress internal buffer sizes across the cluster network 450, e.g., as described below.

In one example, there may be 8 ingress virtual buffers and 8 egress virtual buffers per port. For example, there may be about 10\hat{ }4-10\hat{ }6 ports in a cluster. Accordingly, it may not be efficient or practical to read all information from the cluster to meet a real-time rate of 10\hat{ }6 updates per second (8×8×10\hat{ }6×10\hat{ }6).

In some demonstrative aspects, NDC 426 may be configured to utilize an assumed average egress traffic, which may be equal to a port rate, e.g., 400 Gbps, or may be set to any other rate, e.g., which may be set by the user via the UI 491. For example, this assumption may provide a technical solution to isolate accelerator/server inefficiencies, e.g., versus network inefficiencies.

In some demonstrative aspects, this assumption may be implemented to provide a technical solution to support use of the ingress traffic pattern as the main contributor to network inefficiencies, e.g., as described below.

In some demonstrative aspects, NDC 426 may be configured to process flow updates at rate of X pps, e.g., X=200 Kpps or any other rate. For example, a flow-monitoring packet, e.g., each flow-monitoring packet, may include information about traffic changes that happened in the cluster since a last packet. For example, NDC 426 may be configured to monitor the flow information 435 to observe changes in the traffic pattern in a resolution of, e.g., about 5 usec.

In some demonstrative aspects, NDC 426 may be configured to build a data structure (also referred to as “topology map”), which may describe a connectivity, e.g., a required connectivity, between ingress and egress interfaces in the cluster 466, e.g., as described below.

In some demonstrative aspects, NDC 426 may be configured to determine the topology map to include all ingress and egress ports in the cluster 466, for example, including internal connectivity between network elements (for example spine <->leaf).

For example, NDC 426 may be configured to determine the topology map as a two-dimensional array corresponding to a plurality of different pairs of ingress and egress ports, for example, wherein a predefined value, e.g., the value “1”, may be set to indicate a required connection between a corresponding pair of ingress and egress interfaces.

In one example, the topology map may be configured according to the following two-dimensional array:

TABLE 1

| Cluster | Cluster Dst Int | | | | |
|---|---|---|---|---|---|
| Src Int | 1 | 2 | 3 | 50 | M |
| 1 | | 1 | | | 1 |
| 2 | 1 | | 1 | | |
| 3 | | | | | 1 |
| 40 | 1 | 1 | | 1 | |
| N | | | 1 | 1 | 1 |

For example, according to the topology map of Table 1, there may be “active” connections between the following pairs of {ingress,egress} ports: {1,2}, {1,M}, {2,1}, {2,3}, {3,M}, {40,1}, {40,2}, {40,50}, {N,3}, {N,50}, and {N,M}.

For example, NDC 426 may be configured to update the topology map, e.g., periodically, for example, based on the monitored flow information 435.

For example, at a first time frame, e.g., t=1, the topology map may reflect all the required connections between ingress and egress interfaces in the cluster for the time frame=1.

For example, a size of the topology map may reflect the number of active ports in the cluster at a given time frame.

In one example, according to Table 1, the ingress ports [4:39], [41:N−1] may not be presented as part of the topology map, for example, in case these ingress ports did not send any traffic into the cluster at the time frame corresponding to Table 1.

In one example, according to Table 1, the egress ports [4:49], [51:M−1] may not be presented as part of the topology map, for example, in case these egress ports did not output any traffic at the time frame corresponding to Table 1.

For example, the two-dimensional topology map, e.g., according to the format of Table 1, may be implemented to provide a technical solution for monitoring the topology of the active routing connections between the networking nodes of network 450, for example, while reducing, e.g., dramatically reducing, a scaling factor, e.g., without reducing the topology accuracy.

In some demonstrative aspects, NDC 426 may be configured to determine a topography map, for example, based on the flow information 435 and the topology map, e.g., as described below.

In some demonstrative aspects, the topography map may be configured to indicate the amount of traffic that the cluster should traverse at a particular time frame, e.g., at any time frame.

In some demonstrative aspects, the topography map may be based on the size of the flows, which may be represented, for example, based on a statistical sampling of actual flow sizes, and the topology map, e.g., as described below.

For example, the topography map may be determined by adding the aggregate packet sizes per flow, e.g., at the time frame t=1.

For example, the topography map may be implemented to provide a technical solution to monitor the statistical data size heights and/or occupancy, e.g., per flow.

In one example, the following topography map may be determined, for example, based on the topography map of Table 1. In one example, the topography map may be configured according to the following two-dimensional array:

TABLE 2

| Cluster | Cluster Dst Int | | | | |
|---|---|---|---|---|---|
| Src Int | 1 | 2 | 3 | 50 | M |
| 1 | | 1000 | | | 3000 |
| 2 | 4000 | | 2000 | | |
| 3 | | | | | 6000 |
| 40 | 1000 | 3000 | | 2000 | |
| N | | | 5000 | 6000 | 2000 |

For example, according to the topography map of Table 2, the statistical amount of traffic that should traverse the cluster from ingress interface 1 to egress interface 2 is 1000 units, e.g., bytes; the statistical amount of traffic that should traverse the cluster from ingress interface 1 to egress interface M is 3000 units, e.g., bytes; the statistical amount of traffic that should traverse the cluster from ingress interface 2 to egress interface 1 is 4000 units, e.g., bytes; the statistical amount of traffic that should traverse the cluster from ingress interface 2 to egress interface 3 is 2000 units, e.g., bytes; the statistical amount of traffic that should traverse the cluster from ingress interface 3 to egress interface M is 6000 units, e.g., bytes; the statistical amount of traffic that should traverse the cluster from ingress interface 40 to egress interface 1 is 1000 units, e.g., bytes; the statistical amount of traffic that should traverse the cluster from ingress interface 40 to egress interface 2 is 3000 units, e.g., bytes; the statistical amount of traffic that should traverse the cluster from ingress interface 40 to egress interface 50 is 2000 units, e.g., bytes; the statistical amount of traffic that should traverse the cluster from ingress interface N to egress interface 3 is 5000 units, e.g., bytes; the statistical amount of traffic that should traverse the cluster from ingress interface N to egress interface 50 is 6000 units, e.g., bytes; and the statistical amount of traffic that should traverse the cluster from ingress interface N to egress interface M is 2000 units, e.g., bytes.

In some demonstrative aspects, the topography map may be implemented by NDC 426 to provide a technical solution to monitor, e.g., in an efficient manner, flow information corresponding to a cluster having a relatively large size, e.g., even with an unlimited number of interfaces.

In some demonstrative aspects, the topography map may be implemented by NDC 426 to provide a technical solution to monitor the flow information of the cluster as flow information of a “big networking node”, e.g., one big switch, which may be allowed to have an unlimited number of interfaces, e.g., ingress ports and egress ports.

In some demonstrative aspects, the topography map may be implemented by NDC 426 to provide a technical solution to support optimization of the network 450 at a data path level, for example, to handle traffic according the target optimization parameter, e.g., the JCT parameter, as described below.

In some demonstrative aspects, the topography map may be implemented by NDC 426 to provide a technical solution to support optimization of the network 450 at a routing level, for example, by improving, e.g., optimizing, route selection from ingress to egress ports inside the cluster, e.g., as described below.

In some demonstrative aspects, the topography map may be implemented by NDC 426 to provide a technical solution to support optimization of the network 450 at a data path level, for example, by managing a configuration of the network 450, for example, to optimize performance in terms of congestion, e.g., as described below.

For example, a network bottleneck (congestion) may occur when a specific point in the network receives more data than the specific point can send at a given time frame.

In some demonstrative aspects, NDC 426 may be configured to manage a topography map, for example, where a cell, e.g., each cell, in the topography map, e.g., the topography map of Table 2, may indicate statistical data size information corresponding to a flow, e.g., for an ingress-egress port pair, to which the cell corresponds, e.g., as described below.

In some demonstrative aspects, the statistical data size information in the cell may include, represent, indicate, and/or may be based on, a ratio of bytes that should be traverse via the cluster from a cluster source port (cluster-src-port) to a cluster destination port (cluster-dst-port), versus traffic traversed in between other ingress and egress ports, e.g., at the same timeframe.

For example, when a packet arrives at a cluster ingress port, the cluster may resolve its cluster-dst-port.

For example, in an implementation of an AI training cluster, a target computing resource, e.g., a target GPU, may be connected to a single cluster output port with a single traffic class. According to this example, a packet, e.g., each packet, may have only one way out from the network cluster, e.g., network 450. For example, a similar rule may be applied for other implementations, e.g., bundles and/or Link Aggregations (LAGs).

In one example, a network of a cluster, network 450, may be implemented based on a scheduled fabric. According to this example, congestion may occur in the egress ports of the network.

In another example, a network of a cluster, network 450, may be implemented as a multilayer cluster, for example, a clos with a non-scheduled fabric. In such multilayer cluster, there may be multiple routes inside the cluster. For example, selection between the available routes may be determined according to an Equal-Cost Multi-Path (ECMP) routing definition, and/or any other suitable routing strategy. According to this example, congestion may be handled by solving an ECMP efficiency problem.

In some demonstrative aspects, NDC 426 may be configured to implement the topography map to provide a technical solution to emulate a data-path behavior of the cluster network 450, e.g., as described below.

In some demonstrative aspects, the data-path behavior may depend on internal buffer occupancy, flow-control logic around it, and/or other additional or alternative parameters.

In one example, a network of a cluster including 10 thousand (K) endpoints, e.g., xPU servers, or the like, may utilize a very large number of buffers, e.g., 160K buffers. It may be very hard, inefficient, or even impractical, to read and monitor the buffer height of each buffer, e.g., in real time.

In some demonstrative aspects, NDC 426 may be configured to implement the topography map to provide a technical solution to support estimating a cluster internal buffer occupancy at a given time frame, e.g., at any given time-frame, for example, even without reading the actual height of each buffer in the cluster, e.g., as described below.

In some demonstrative aspects, NDC 426 may be configured to estimate, e.g., to statistically estimate, the occupancy of the internal buffers of the cluster network 450, for example, based on the monitored information in the topography map, e.g., as described below.

For example, an egress interface, e.g., each egress interface, for example, in a cluster network implementing a scheduled fabric, may obtain its data from a dedicated buffer (also referred to as a Virtual Output Queue (VOQ)”.

For example, the egress buffer, e.g., each egress buffer, may aggregate traffic from a plurality of interfaces, e.g., all interfaces, destined to the egress interface.

For example, in case the buffer of the egress interface is overloaded, traffic from multiple ingress interfaces, e.g., xPUs/Servers, might be dropped.

For example, some networking nodes, e.g., state-of-the-art switches, may implement ingress buffers, e.g., virtual ingress buffers, which may be configured to indicate the amount of traffic pilled in the networking node, e.g., per ingress port and traffic class (TC).

For example, a Priority Flow Control (PFC) mechanism, an Explicit Congestion Notification (ECN) mechanism, and/or any other additional or alternative mechanisms may be implemented in networking nodes, e.g., switches, to protect from packet drop, e.g., due the ingress overload and/or egress overload.

For example, the PFC mechanism and/or the ECN mechanism may be configured to trigger flow control events and/or signals, for example, based on a suitable buffer occupancy threshold, for example, to halt or reduce the amount of traffic entering the networking node.

In some demonstrative aspects, NDC 426 may be configured to estimate buffer relative occupancy information, which may be utilized as an estimation of the relative occupancy of internal buffers of the cluster network 450, e.g., as described below.

In some demonstrative aspects, NDC 426 may be configured to implement the buffer relative occupancy information, for example, instead of reading absolute occupancy information from all buffers in the cluster network.

In some demonstrative aspects, NDC 426 may be configured to implement the buffer relative occupancy information to provide a technical solution to support monitoring, e.g., in real time, a state of congestion of the network 450, for example, even without obtaining direct information of the internal buffer occupancy/height of all buffers in the cluster network, which may be inefficient, or even impractical, to monitor in real time.

In some demonstrative aspects, NDC 426 may be configured to utilize the relative occupancy information, which may be good enough, for example, to efficiently manage, e.g., minimize, the JCT across the cluster 466 utilizing network 450.

For example, NDC 426 may be configured to utilize the relative occupancy information to manage a configuration of the network 450, for example, with a target to “flatten” buffers with minimum occupancy, while maintaining a high, e.g., maximum, egress port utilization.

For example, the optimization target, e.g., the JCT, may set by suitable formulation at a reward function processor of the ML engine 424.

In some demonstrative aspects, NDC 426 may be configured to assume a “correct” cluster configuration, for example, such that, on average, a flow, e.g., each flow, may have enough bandwidth allocation to traverse the cluster without drops.

In some demonstrative aspects, NDC 426 may be configured to estimate the relative occupancy information, for example, to estimate the buffer occupancy of network 450, for example, by reducing the number of input bytes, e.g., which may be determined based on the topography map, from an estimated bandwidth allocation per flow per time frame.

In one example, the estimated bandwidth allocation per flow per time frame may be 10K bytes, e.g., as described below. In other aspects, any other suitable estimated bandwidth allocation per flow per time frame may be used.

In some demonstrative aspects, NDC 426 may be configured to process the information of the topography map, for example, to estimate the relative occupancy information, for example, by estimating statistical ingress buffer data size information, e.g., statistical free buffer size, for the ingress buffers of the network 450.

For example, NDC 426 may be configured to estimate the statistical ingress buffer data size information for an ingress buffer of an ingress port, for example, based on a difference between an estimated ingress buffer allocated bandwidth and total of bytes traversing the ingress port.

In some demonstrative aspects, NDC 426 may be configured to process the information of the topography map, for example, to estimate the relative occupancy information, for example, by estimating statistical egress buffer data size information, e.g., statistical free buffer size, for the egress buffers of the network 450.

For example, NDC 426 may be configured to estimate the statistical egress buffer data size information for an egress buffer of an egress port, for example, based on a difference between an estimated egress buffer allocated bandwidth and total of bytes traversing the egress port.

In one example, the following topography map information may be determined, for example, based on the topography map of Table 2. In one example, the topography map may be configured according to the following two-dimensional array:

TABLE 3

| | Cluster Dst Int | | | | | |
|---|---|---|---|---|---|---|
| | | | | | | Ingress |
| Cluster | | | | | | Buffer Data |
| Src Int | 1 | 2 | 3 | 50 | M | Size Info. |
| 1 | | 1000 | | | 3000 | 6000 |
| 2 | 4000 | | 2000 | | | 4000 |
| 3 | | | | | 6000 | 4000 |
| 40 | 1000 | 3000 | | 2000 | | 6000 |
| N | | | 5000 | 6000 | 2000 | −3000 |
| Egress Buffer Data | 5000 | 6000 | 3000 | 2000 | −1000 | |
| Size Info. | | | | | | |

For example, the topography map information of Table 3 may include a plurality of statistical ingress buffer data sizes corresponding to the plurality of ingress ports, e.g., as represented by the values in the last column of Table 3.

For example, a statistical ingress buffer data size corresponding to an ingress port may be based on statistical data flow sizes mapped to ingress-egress port pairs including the ingress port.

For example, as shown in Table 3, a statistical ingress buffer data size, e.g., 6000, corresponding to the ingress port 1 may be determined based on a difference between the estimated ingress buffer allocated bandwidth for the ingress port 1, e.g., 10000, and the total of the statistical data flow sizes mapped to ingress-egress port pairs including the ingress port 1, e.g., 6000=10000−(1000+3000).

For example, as shown in Table 3, a statistical ingress buffer data size, e.g., 4000, corresponding to the ingress port 2 may be determined based on a difference between the estimated ingress buffer allocated bandwidth for the ingress port 2, e.g., 10000, and the total of the statistical data flow sizes mapped to ingress-egress port pairs including the ingress port 2, e.g., 4000=10000−(4000+2000).

For example, as shown in Table 3, a statistical ingress buffer data size, e.g., 4000, corresponding to the ingress port 3 may be determined based on a difference between the estimated ingress buffer allocated bandwidth for the ingress port 3, e.g., 10000, and the total of the statistical data flow sizes mapped to ingress-egress port pairs including the ingress port 3, e.g., 4000=10000−(6000).

For example, as shown in Table 3, a statistical ingress buffer data size, e.g., 6000, corresponding to the ingress port 40 may be determined based on a difference between the estimated ingress buffer allocated bandwidth for the ingress port 40, e.g., 10000, and the total of the statistical data flow sizes mapped to ingress-egress port pairs including the ingress port 40, e.g., 6000=10000−(1000+3000+2000).

For example, as shown in Table 3, a statistical ingress buffer data size, e.g., (−3000), corresponding to the ingress port N may be determined based on a difference between the estimated ingress buffer allocated bandwidth for the ingress port N, e.g., 10000, and the total of the statistical data flow sizes mapped to ingress-egress port pairs including the ingress port N, e.g., (−3000)=10000−(5000+6000+2000).

For example, the topography map information of Table 3 may include a plurality of statistical egress buffer data sizes corresponding to the plurality of egress ports, e.g., as represented by the values in the last row of Table 3.

For example, a statistical egress buffer data size corresponding to an egress port may be based on statistical data flow sizes mapped to ingress-egress port pairs including the egress port.

For example, as shown in Table 3, a statistical egress buffer data size, e.g., 5000, corresponding to the egress port 1 may be determined based on a difference between the estimated egress buffer allocated bandwidth for the egress port 1, e.g., 10000, and the total of the statistical data flow sizes mapped to ingress-egress port pairs including the egress port 1, e.g., 5000=10000−(4000+1000).

For example, as shown in Table 3, a statistical egress buffer data size, e.g., 6000, corresponding to the egress port 2 may be determined based on a difference between the estimated egress buffer allocated bandwidth for the egress port 2, e.g., 10000, and the total of the statistical data flow sizes mapped to ingress-egress port pairs including the egress port 2, e.g., 6000=10000−(1000+3000).

For example, as shown in Table 3, a statistical egress buffer data size, e.g., 3000, corresponding to the egress port 3 may be determined based on a difference between the estimated egress buffer allocated bandwidth for the egress port 3, e.g., 10000, and the total of the statistical data flow sizes mapped to ingress-egress port pairs including the egress port 3, e.g., 3000=10000−(2000+5000).

For example, as shown in Table 3, a statistical egress buffer data size, e.g., 2000, corresponding to the egress port 50 may be determined based on a difference between the estimated egress buffer allocated bandwidth for the egress port 50, e.g., 10000, and the total of the statistical data flow sizes mapped to ingress-egress port pairs including the egress port 1, e.g., 2000=10000−(2000+6000).

For example, as shown in Table 3, a statistical egress buffer data size, e.g., (−1000), corresponding to the egress port M may be determined based on a difference between the estimated egress buffer allocated bandwidth for the egress port M, e.g., 10000, and the total of the statistical data flow sizes mapped to ingress-egress port pairs including the egress port M, e.g., (−1000)=10000−(3000+6000+2000).

For example, the ingress buffer data size information of Table 3 may be determined based on an estimated ingress buffer allocated bandwidth of 10K bytes per timeframe; and the egress buffer data size information of Table 3 may be determined based on an estimated egress buffer allocated bandwidth of 10K bytes per timeframe.

In some demonstrative aspects, NDC 426 may be configured to support any other suitable setting of the ingress buffer allocated bandwidth and/or the egress buffer allocated bandwidth.

In some demonstrative aspects, NDC 426 may be configured to determine the setting of the ingress buffer allocated bandwidth and/or the egress buffer allocated bandwidth, for example, based on input information received via the UI 491.

In one example, NDC 426 may be configured to support a first allocation bandwidth as the ingress buffer allocated bandwidth, and a second allocation bandwidth egress buffer allocated bandwidth, e.g., different from the first allocation bandwidth.

In one example, NDC 426 may be configured to support a setting of the ingress buffer allocated bandwidth on a per ingress port basis, and/or the egress buffer allocated bandwidth on a per egress port basis.

For example, NDC 426 may be configured to support a setting of a first ingress buffer allocated bandwidth for a first ingress port, and a second ingress buffer allocated bandwidth for a second ingress port, e.g., different from the first ingress buffer allocated bandwidth.

For example, NDC 426 may be configured to support a setting of a first egress buffer allocated bandwidth for a first egress port, and a second egress buffer allocated bandwidth for a second egress port, e.g., different from the first egress buffer allocated bandwidth.

In some demonstrative aspects, the topography map information, e.g., of Table 3, may be utilized to identify a potential congestion state at an ingress port and/or an egress port.

For example, a positive statistical ingress buffer data size for an ingress port may correspond to a situation where the total ingress traffic for the ingress port is less than the allocated bandwidth for the ingress port.

For example, the ingress port having the positive statistical ingress buffer data size may be identified as a non-congested port.

For example, a negative statistical ingress buffer data size for an ingress port may correspond to a situation where the total ingress traffic for the ingress port is greater than the allocated bandwidth for the ingress port.

For example, the ingress port having the negative statistical ingress buffer data size may be identified as a congested port.

For example, a positive statistical egress buffer data size for an egress port may correspond to a situation where the total ingress traffic for the egress port is less than the allocated bandwidth for the egress port.

For example, the egress port having the positive statistical egress buffer data size may be identified as a non-congested port.

For example, a negative statistical egress buffer data size for an egress port may correspond to a situation where the total ingress traffic for the egress port is greater than the allocated bandwidth for the egress port.

For example, the egress port having the negative statistical egress buffer data size may be identified as a congested port.

In some demonstrative aspects, ML engine 424 may be configured to utilize the statistical ingress buffer data size information and/or the statistical egress buffer data size information, for example, to provide a technical solution to configured the network 450, for example, to better utilize unused BW between timeframes, e.g., as described below.

In some demonstrative aspects, NDC 426 may be configured to configure the ML input information 427 for the ML engine 424, for example, based on the network topography information corresponding to network 450, e.g., as described below.

In some demonstrative aspects, NDC 426 may be configured to determine size-reduced network topography information, for example, by reducing a size of the network topography information, e.g., as described below.

In some demonstrative aspects, NDC 426 may be configured to reduce the size of the network topography information, for example, based on a size of the ML input 427 of ML engine 424, e.g., as described below.

In some demonstrative aspects, NDC 426 may be configured to configure the ML input 427 to ML engine 424, for example, based on the size-reduced network topography information, e.g., as described below.

In some demonstrative aspects, NDC 426 may be configured to determine the size-reduced network topography information, for example, to provide a technical solution to support an efficient implementation of ML engine 424, e.g., as described below.

For example, the size of the network topography information, e.g., according to Table 3, may be very large, for example, in implementations where the network 450 includes a relatively large number of networking nodes, and/or a relatively large number (N) of ingress ports, and/or a relatively large number (M) of egress ports.

For example, the size-reduced network topography information may be implemented to provide a technical solution to support an implementation of ML engine 424 with a relatively small ML input size, for example, compared to the size of the network topography information, e.g., as described below.

In some demonstrative aspects, NDC 426 may be configured to determine the size-reduced network topography information to include network topography information corresponding to a subset of networking nodes of the network 450, e.g., as described below.

In some demonstrative aspects, NDC 426 may include an observation processor, e.g., observation processor 326 (FIG. 3), which may be configured to provide the ML input 427 to ML engine 424, for example, based on the size-reduced network topography information.

In some demonstrative aspects, the observation processor of NDC 426, e.g., observation processor 326 (FIG. 3), may be configured to determine the size-reduced network topography information, for example, to adjust the size of the topography map, for example, to match a size of the input to a neural network component of the ML engine 424, e.g., as described below.

In some demonstrative aspects, the observation processor of NDC 426, e.g., observation processor 326 (FIG. 3), may be configured to determine the size-reduced network topography information, for example, based on identified active flows in a timeframe, e.g., as described below.

In some demonstrative aspects, the observation processor of NDC 426, e.g., observation processor 326 (FIG. 3), may be configured to identify active flows in a current timeframe, for example, by identifying flows that currently hold data in at least one networking node.

For example, a total number of concurrent active flows may be limited, for example, by computing resources. For example, the total number of concurrent active flows may be limited, for example, to be less than 50K, e.g., less than 10K, for example, even in implementations of clusters having a large number of computing resources, e.g., 10K GPUs, which may theoretically map a very large number of flows, e.g., 100,000,000 flows.

In some demonstrative aspects, the observation processor of NDC 426, e.g., observation processor 326 (FIG. 3), may be configured to search for a plurality of in-cast active flows meeting a selection criterion, e.g., relating to the statistical buffer data size information.

In one example, the selection criterion may be configured to select the plurality of in-cast active flows corresponding to ingress ports and egress ports having negative statistical buffer data size values and/or low statistical buffer data size values.

In some demonstrative aspects, the observation processor of NDC 426, e.g., observation processor 326 (FIG. 3), may be configured to use the minimal statistical buffer data size value from the selected in-casted flows as a minimal threshold value that should not be removed by a size-reduction procedure.

In some demonstrative aspects, the size-reduction procedure may be performed, for example, on the cells of the topography map, for example, according to the threshold value.

In some demonstrative aspects, the size-reduction procedure may be configured to reduce the number of cells in the topography map (TPM), for example, to match the size of the NN input layer of ML engine 424.

In some demonstrative aspects, the size-reduction procedure may be implemented by a quantization procedure, e.g., as described below. In other aspects, any other suitable size-reduction procedure may be implemented.

In one example, the quantization procedure may include the following operations:
1. increase a quantization factor, denoted q, by a predefined quantization step;
2. round down the results;
3. Remove lines and columns of the TPM with no active cells (cells=0);
4. Repeat the procedure, e.g., until the number of cells will match the number of inputs in the NN;
5. Pad missing cells by ‘0’;
6. In case the above procedure does not converge down to match the NN dimension, the lowest non-incast cells may be reset and removed. The probability of such a scenario is extremely low, e.g., as the size of the NN input layer may be increased, e.g., as much as necessary, for example, with compensation by stronger processing power at the ML engine.

In one example, the size-reduced network topography information may include the following Reduced Topography Map (RTM), e.g., based on the size of the ML input:

TABLE 4

| | | | | |
|---|---|---|---|---|
| 0 | 2 | 1 | . . . | 1 |
| 2 | 2 | 0 | . . . | 1 |
| 0 | 2 | 2 | . . . | 0 |
| . . . | . . . | . . . | . . . | 0 |
| 0 | 0 | 1 | 1 | 2 |

It is noted that the Table 4 is provided as a conceptual example, while in practice the size-reduced network topography information may be provided in a much larger map, e.g., with a size of 100K cells or more.

In some demonstrative aspects, the observation processor of NDC 426, e.g., observation processor 326 (FIG. 3), may be configured generate observation information for the AI engine 424, e.g., observation information 327 (FIG. 3), for example, based on the RTM.

In some demonstrative aspects, AI engine 424 may include a reward processor, e.g., reward processor 328 (FIG. 3), which may utilize a reward function, e.g., a JCT reward function, to provide reward information, e.g., reward information 329 (FIG. 3), for example, based on the network topography information, e.g., the RTM, provided in ML input 427.

In some demonstrative aspects, the reward function, e.g., the JCT reward function, may be configured to provide the reward information including a reward level, which may be based, for example, on a variance (flat) and/or size values in the network topography information, e.g., the RTM, provided in ML input 427.

In some demonstrative aspects, the reward function, e.g., the JCT reward function, may be configured to provide the reward information including an increased reward level, for example, based on a lower variance (flat) and smaller buffer height in the network topography information, e.g., the RTM, provided in ML input 427.

In other aspects, the reward function, e.g., the JCT reward function, may be configured according to any other suitable parameters and/or criteria.

In some demonstrative aspects, AI engine 424 may be configured to utilize a DRL policy, which may be configured to find an optimal set of RTMs that will maximize the reward function.

For example, the AI engine 424 may be configured to provide the ML output 431 including information, e.g., action information 331 (FIG. 3), corresponding to an observation input, e.g., observation input 327 (FIG. 3), including an RTM(t) at a timeframe t.

For example, the AI engine 424 may be configured to provide the ML output 431 including action information 331 (FIG. 3), which may include actions to “control” a future RTM state at a future timeframe, e.g., an RTM (t+1).

In some demonstrative aspects, AI engine 424 may be configured to provide the ML output 427 including the action information, for example, in the form of a matrix of a plurality vectors corresponding to a plurality actions, e.g., as described below.

In some demonstrative aspects, AI engine 424 may be configured to provide the ML output 427 including the action information, for example, in the form of a matrix of a plurality sets of values, e.g., vectors, for example, including 3 sets of values, e.g., vectors or any other format, e.g., as described below.

For example, AI engine 424 may be trained to generate the ML output 427 including a set of values, e.g., which may include, indicate, represent and/or be used as a set of ECN values, e.g., an ECN vector, which may include recommended ECN threshold values corresponding to a plurality of egress ports and traffic classes, e.g., on a per traffic class per egress port basis.

In one example, the recommended ECN threshold values may correspond to a plurality of egress ports and flows included in the selected subset of networking nodes/flows to which the observation information 327 (FIG. 3) corresponds.

For example, AI engine 424 may be trained to generate the ML output 427 including a set of values, e.g., which may include, indicate, represent and/or be used as a set of PFC values, e.g., a PFC vector, which may include recommended PFC threshold values corresponding to a plurality of ingress ports and traffic classes, e.g., on a per traffic class per ingress port basis.

In one example, the recommended PFC threshold values may correspond to a plurality of ingress ports and flows included in the selected subset of networking nodes/flows to which the observation information 327 (FIG. 3) corresponds.

For example, AI engine 424 may be trained to generate the ML output 427 including a set of values, e.g., which may include, indicate, represent and/or be used as a set of queue size values, e.g., a queue size vector, which may include recommended maximal buffer queue size values corresponding to the plurality of egress ports and traffic classes, e.g., on a per traffic class per egress port basis.

In one example, the recommended maximal buffer queue size values may correspond to the plurality of egress ports and flows included in the selected subset of networking nodes/flows to which the observation information 327 (FIG. 3) corresponds.

In other aspects, AI engine 424 may be configured to provide the ML output 427 including the action information in the form of a matrix including any other suitable count of sets of values, e.g., vectors or any other form of set of values, corresponding to any other suitable count of actions, and/or in any other suitable form.

In some demonstrative aspects, network controller 428 may be configured to generate the network configuration information 451, for example, based on the DRL actions in the ML output 431.

In some demonstrative aspects, network controller 428 may be configured to translate the DRL actions from AI engine 424 into suitable, e.g., supported, values of the PFC threshold, ECN threshold, and/or Qsize, for example, per profile.

For example, network controller 428 may perform on or more operations and/or functionalities of network adapter 332 (FIG. 3).

In some demonstrative aspects, network controller 428 may be configured to generate network configuration information 451, for example, based on the values of the PFC threshold, ECN threshold, and/or Qsize.

For example, network controller 428 may use a pre-defined Yang path to create network configuration information 451 including a suitable, e.g., legal, command towards the cluster server manager 454.

For example, the network configuration information 451 may include the command configured according to a Network Configuration (Netconf) protocol, a gRPC Network Management Interface (gNMi) protocol, a Simple Network Management Protocol (SNMP), and/or any other suitable network management and/or configuration protocol.

For example, the cluster 466 may change its behavior, for example, based on the new configuration, e.g., according to the network configuration information 451.

For example, the NDC 426 may monitor the flow information 435, which may change based on the new configuration of the network 450, and may use the updated flow information 435 further configure the network 450, e.g., in an iterative manner.

In some demonstrative aspects, the DRL mechanism implemented by AI engine 424 may converge within a relatively short time, e.g., compared to a duration of AI training of the AI engine 424, for example, based on real time adaptation of the network configuration information 451.

In some demonstrative aspects, a learning process of the DRL mechanism may be stopped, for example, based on convergence of the DRL mechanism, e.g., when reaching a predefined rewards value.

In some demonstrative aspects, the rewards processor of AI engine 424 may be configured to decrease the rewards, for example, based on a change in traffic statistics corresponding to the network 450.

In some demonstrative aspects, the DRL learning process may be re-activated by AI engine 424, for example, based on a decrease of the rewards, e.g., below a pre-defined threshold, for example, with hysteresis to avoid toggling.

For example, AI engine 424 may be configured selectively activate or deactivate the DRL learning process may be, for example, based on one or more reward criteria, e.g., reward thresholds.

For example, the selective activation or deactivation of the DRL learning process may be utilized to provide a technical solution to automatically learn new traffic patterns, and/or to improve, e.g., optimize, performance with respect to different and/or new network scenarios in which the network 450 may be operated.

For example, the selective activation or deactivation of the DRL learning process may be utilized to provide a technical solution to avoid a need to train the DRL offline with respect to multiple traffic scenarios.

For example, the selective activation or deactivation of the DRL learning process may be utilized to provide a technical solution to support multiple traffic scenarios, for example, without compromising on the DRL accuracy.

In some demonstrative aspects, network configuration controller 402 may be configured to provide the network configuration information 451 to include at least one ingress-port setting, for example, an ECN setting and/or a maximal buffer queue size setting, for example, on a per traffic class per port basis, e.g., as described below.

In some demonstrative aspects, network configuration controller 402 may configure the at least one ingress-port setting, for example, such that any PFC event based on a PFC setting is not to occur before an ingress-port event based on the at least one ingress-port setting, e.g., as described below.

In some demonstrative aspects, network configuration controller 402 may configure the at least one ingress-port setting, for example, such that a probability of the occurrence of any PFC event based on a PFC setting before an ingress-port event based on the at least one ingress-port setting may be below a predefined probability, e.g., as described below.

In some demonstrative aspects, network configuration controller 402 may configure the at least one ingress-port setting, for example, to avoid a probable or predicted PFC event, which may occur based on the PFC setting, for example, if the at least one ingress-port setting is not implemented, e.g., as described below.

For example, NDC 426 may determine a state of a reduced topography map including 9 cells, e.g., corresponding to 9 ingress-egress port pairs, at a first timeframe, e.g., as follows:

TABLE 5

| | Egress | | | |
|---|---|---|---|---|
| | | | | (PFC) ingress |
| Ingress | 1 | 2 | 3 | Queues |
| 1 | 0 | 2 | 1 | 3 |
| 2 | 2 | 2 | 0 | 4 |
| 3 | 0 | 2 | 2 | 4 |
| (ECN) egress | 2 | 6 | 3 | |
| Queues | | | | |

In one example, configuring fixed parameter settings, e.g., fixed ECN parameters, PFC parameters, and/or max Qsize value, for all the networking nodes of the network 450 may result in congestion, which may result in increased JCT.

For example, configuring all the networking nodes of the network 450 to have a fixed ECN threshold of 7, and a fixed PFC threshold of 10 may result in one or more ECN events, PFC events, and/or an increased JCT.

For example, the reduced topography map including the 9 cells may have a second state at a second timeframe, subsequent to the first time frame, e.g., as follows:

TABLE 6

| | Egress | | | |
|---|---|---|---|---|
| | | | | (PFC) ingress |
| Ingress | 1 | 2 | 3 | Queues |
| 1 | 0 | 2 | 1 | 3 |
| 2 | 2 | 3 | 0 | 5 |
| 3 | 0 | 4 | 2 | 6 |
| (ECN) egress | 2 | 9 | 3 | |
| Queues | | | | |

For example, the reduced topography map including the 9 cells may have a third state at a third timeframe, for example, in case the fixed ECN threshold of 7, and the fixed PFC threshold of 10 are maintained for the networking nodes, e.g., as follows:

TABLE 7

| | Egress | | | |
|---|---|---|---|---|
| | | | | (PFC) ingress |
| Ingress | 1 | 2 | 3 | Queues |
| 1 | 0 | 4 | 1 | 5 |
| 2 | 3 | 4 | 1 | 8 |
| 3 | 1 | 7 | 2 | 10 |
| (ECN) egress | 4 | 15 | 4 | |
| Queues | | | | |

For example, as may be seen from Table 7, maintaining the same fixed ECN threshold of 7, and the same fixed PFC threshold of 10, e.g., for the networking nodes, may result in a congestion situation, where the PFC of the ingress port 3 may reach the value of 10, which may exceed the fixed PFC threshold of 10, which, in turn, may result in a PFC event.

For example, the in-cast congestion situation may result in an increased JCT, e.g., JCT=15, which may be determined, for example, based on the highest egress queue corresponding to egress port 2.

In some demonstrative aspects, network configuration controller 402 may be configured to provide a technical solution to avoid this in-cast congestion situation, for example, by monitoring the flow information 435 and generating the network configuration information 451, e.g., based on the real-time monitoring of the flow information 435, for example, to dynamically adjust the network-configuration setting of network 450 based on the target E2E parameter, e.g., to converge towards an improved JCT.

In some demonstrative aspects, network configuration controller 402 may be configured to provide the network configuration information 451, for example, to configure one or more node-specific parameter settings for the networking nodes of the network 450, for example, on a per-node basis, e.g., in real time.

For example, network configuration controller 402 may be configured to utilize AI engine 424 to selectively configure the ECN threshold and/or the PFC threshold, e.g., for one or more networking nodes of network 450, for example, based on the monitored topography map corresponding to network 450.

For example, the AI engine 424 may be configured to selectively configure the ECN threshold and/or the PFC threshold, e.g., for one or more networking nodes of network 450, for example, to avoid the in-cast congestion situation of Table 7.

For example, the AI engine 424 may be configured to avoid the in-cast congestion situation of Table 7, for example, by selectively configuring the ECN threshold and/or the PFC threshold, for example, based on the topography map of Table 6 corresponding to the second timeframe.

For example, the AI engine 424 may be configured to determine that the ECN threshold for a flow corresponding to the ingress-egress port pair {3,2} is to be reduced, e.g., from 7 to 4, for example, based on the topography map of Table 6 corresponding to the second timeframe.

For example, the AI engine 424 may be configured to determine that the PFC threshold for the ingress port {3} is to be increased, e.g., from 10 to 12, for example, based on the topography map of Table 6 corresponding to the second timeframe.

For example, the selective setting of the ECN threshold and the PFC threshold at the second timeframe may result in an improved third state of the topography map at the third timeframe, e.g., as follows:

TABLE 8

| Egress | | | | (PFC) ingress |
|---|---|---|---|---|
| Ingress | 1 | 2 | 3 | Queues |
| 1 | 0 | 4 | 1 | 5 |
| 2 | 3 | 4 | 1 | 8 |
| 3 | 4 | 2 | 4 | 10 |
| (ECN) egress | 7 | 10 | 6 | |
| Queues | | | | |

For example, as may be seen from Table 8, the selective setting of the ECN threshold and the PFC threshold may provide a technical solution to avoid the in-cast congestion situation of Table 7.

For example, as may be seen from Table 8, the selective setting of the ECN threshold and the PFC threshold may provide a technical solution to maintain the PFC of the ingress port 3 at a value of 10, which may be below the adjusted PFC threshold of 12, e.g., to avoid a PFC event.

For example, as may be seen from Table 8, the selective setting of the ECN threshold and the PFC threshold may provide a technical solution to achieve a reduced JCT, e.g., JCT=10, which may be determined, for example, based on the highest ECN queue corresponding to egress port 2.

For example, the selective setting of the ECN threshold and the PFC threshold may provide a technical solution to achieve a reduction of about 50% in the JCT, e.g., compared to the JCT of the in-cast congestion situation of Table 7.

For example, the selective setting of the ECN threshold and the PFC threshold may provide a technical solution to achieve an improved utilization, e.g., a 100% utilization, on the ingress port 3 and the egress port 2.

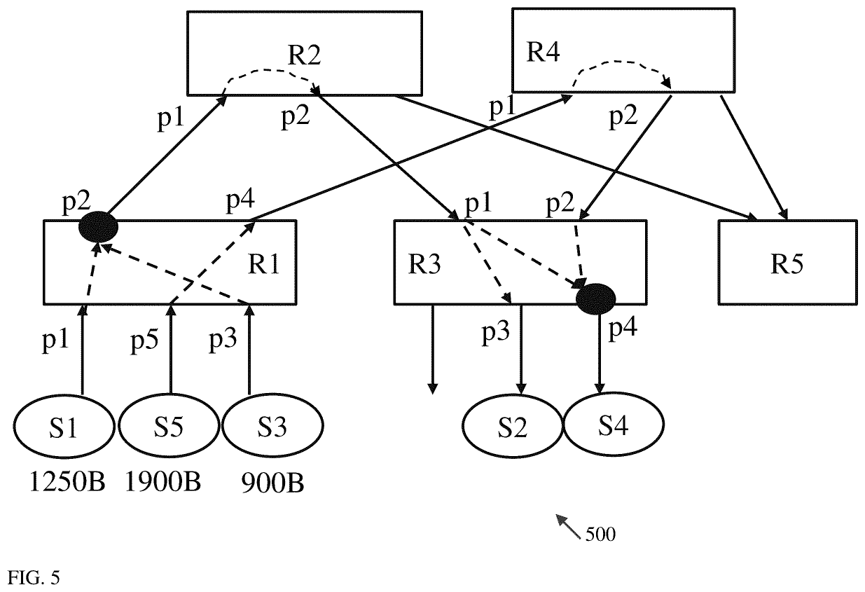

Reference is also made to FIG. 5, which schematically illustrates a computing cluster 500, in accordance with some demonstrative aspects.

For example, computing cluster 466 (FIG. 4) may include one or more components of computing cluster 500, and/or may perform one or more operations and/or functionalities of computing cluster 500.

In some demonstrative aspects, as shown in FIG. 5, computing cluster 500 may include a plurality of computing resources, e.g., including a first computing resource, denoted S1, a second computing resource, denoted S2, a third computing resource, denoted S3, a fourth computing resource, denoted S4, and/or a fifth computing resource, denoted S5.

In some demonstrative aspects, as shown in FIG. 5, computing cluster 500 may include a network including a plurality of networking nodes to interconnect between the plurality of computing resources.

For example, as shown in FIG. 5, the network may include a first networking node, denoted R1, a second networking node, denoted R2, a third networking node, denoted R3, a fourth networking node, denoted R4, and/or a fifth networking node, denoted R5.

In some demonstrative aspects, as shown in FIG. 5, a networking node may include a plurality of ports, e.g., including one or more ingress ports and one or more egress ports.

For example, as shown in FIG. 5, the networking node R1 may include at least an ingress port, denoted R1: p1, an ingress port, denoted R1: p3, an ingress port, denoted R1: p5, an egress port, denoted R1: p2, and/or an egress port, denoted R1: p4.

For example, as shown in FIG. 5, the networking node R2 may include at least an ingress port, denoted R2: p1, and an egress port, denoted R2: p2.

For example, as shown in FIG. 5, the networking node R3 may include at least an ingress port, denoted R3: p1, an ingress port, denoted R3: p2, an egress port, denoted R3: p3, and/or an egress port, denoted R3: p4.

For example, as shown in FIG. 5, the networking node R4 may include at least an ingress port, denoted R4: p1, and an egress port, denoted R4: p2.

For example, as shown in FIG. 5, a dashed arrow may be used to indicate an internal route within a networking node.

For example, as shown in FIG. 5, a full-line arrow may be used to indicate a route between networking nodes.

For example, as shown in FIG. 5, a full black circle may be used to indicate a potential congestion point, e.g., due to incast flows.

For example, as shown in FIG. 5, the notation <number> may be used to indicate a statistical length of a flow.

For example, as shown in FIG. 5, the computing resource S1 may provide to the ingress port R1: p1 a flow with a statistical length of 1250 bytes (B), the computing resource S3 may provide to the ingress port R1: p3 a flow with a statistical length of 1900B, and/or the computing resource S5 may provide to the ingress port R1: p5 a flow with a statistical length of 1900B.

In some demonstrative aspects, an NDC, e.g., NDC 426, may be configured to collect flow information, e.g., flow information 435, corresponding to the computing cluster 500.

In one example, the NDC, e.g., NDC 426, may collect the following node-related flow information sets corresponding to the networking nodes R1, R2, R3, and R4, e.g., for a particular timeframe:
R1:
Src port: p1
Dst port: p2
IP src: S1
IP dst: S2
Nexthop: R2
flowlength: 1250
Src port: p3
Dst port: p2
IP src: S3
IP dst: S4
Nexthop: R2
flowlength: 900
Src port: p5
Dst port: p4
IP src: S5
IP dst: S4
Nexthop: R4
flowlength: 1900
R2:
Src port: p1
Dst port: p2
IP src: S1
IP dst: S2
Nexthop: R3
flowlength: 1250
Src port: p1
Dat port: p2
IP &c: S3
IP dst: S4
Nexthop: R3
flowlength: 900
R3:
Src port: p1
Det port: p3
IP arc: S1
IP dst: S2
Nexthop: S2
flowlength: 1163
Src port: p1
Dst port: p4
IP &c: S3
IP dst: S4
Nexthop: S4
flowlength: 837
Src port: p2
Det port: p4
IP &c: S5
IP dst: S4
Nexthop: S4
flowlength: 1900
R4:
Src port: p1
Det port: p2
IP &c: S5
IP dst: S4
Nexthop: S2
flowlength: 1900
   wherein:
Rx denotes a networking node X, e.g., router, switch or the like,
Src port: n denotes an ingress (ing) port n on a networking node X,
Dst port: m denotes an egress (egr) port m on a networking node X,
IP src: Si denotes an Internet Protocol (IP) source address of all the packets of this flow,
IP dst:Sj denotes an IP destination address of all the packets of this flow,
NexthopIP denotes an IP address of the next networking node (hop) for packets in this flow,
Flowlength denotes the aggregated size of all sampled packets of this flow (e.g., in octets).

In some demonstrative aspects, an NDC, e.g., NDC 426, may be configured to monitor the node-related flow information sets from multiple networking nodes, for example, to determine the active topology of the cluster 500, e.g., at any given timeframe, for example, based on the Nexthop information.

For example, the NDC, e.g., NDC 426, may determine the following active topology of cluster 500, e.g., based on the node-related flow information sets corresponding to the networking nodes R1, R2, R3, and R4:
S1->R1->R2->R3->S2—Active
S3->R1->R2->R3->S4—Active
S5->R1->R4->R3->S4—Active

In some demonstrative aspects, the NDC, e.g., NDC 426, may be configured to monitor the monitored flow information from multiple networking nodes, for example, to determine one or more in-cast scenarios, for example, based on the source port (Src port) information and the destination port (Dst port) information.

For example, the NDC, e.g., NDC 426, may be configured to determine an in-cast early detection, for example, based on detection of multiple flows having a same Dst port with a different Src port.

In some demonstrative aspects, the NDC, e.g., NDC 426, may be configured to monitor the monitored flow information from multiple networking nodes, for example, to identify end-to-end flows across the cluster 500, e.g., based on the IP src information and the IP dst information. For example, end-to-end flows across the cluster 500 may represent the application level connections between computing resources across the cluster 500.

In some demonstrative aspects, the NDC, e.g., NDC 426, may be configured to determine a topography map corresponding to the cluster 500, for example, based on the monitored flow information.

For example, the topography map may be configured to hold information on the cluster 500, e.g., per timeframe, e.g., as described above.

For example, a cell, e.g., each cell, of the topography map may hold a statistical number, e.g., in units of octets or any other suitable units, that should travers the cluster 500, e.g., between a pair of input and output ports per router, e.g., as described above.

In one example, the NDC, e.g., NDC 426, may determine the following topography map based on the monitored flow information of the cluster 500:

TABLE 9

| | DST PORT | | | | | | |
|---|---|---|---|---|---|---|---|
| | | | | | | | Ingress |
| SRC PORT | R1:p2 | R1:p4 | R2:p2 | R3:p3 | R3:p4 | R4:p2 | buffers |
| R1:p1 | 1250 | | | | | | 1250 |
| R1:p5 | | 1900 | | | | | 1900 |
| R1:p3 | 900 | | | | | | 900 |
| R2:p1 | | | 2000 | | | | 2000 |
| R3:p1 | | | | 1163 | 837 | | 2000 |
| R3:p2 | | | | | 1900 | | 1900 |
| R4:p1 | | | | | | 1900 | 1900 |
| Egress buffers | 2150 | 1900 | 2000 | 1250 | 2737 | | |

For example, according to the topography map of Table 9, the port 1 in networking node R1 may send 1250 bytes to port 2 of the networking node R1 (upper left cell); and port 3 in the same networking node R1 may try to send 900 bytes to the port 2 of the networking node R1. However, the aggregate size intended for the port 2 of the networking node R1 may be greater than a physical port rate supported by the port 2 of the networking node R1, e.g., 1250+900>2000. In this situation, packets might be dropped, e.g., depending on the buffer size and burst duration.

For example, the topography map may be implemented to parse the flow information, for example, to create a function that connects between ingress and egress queues, e.g., although these queues may not actually be coupled in the networking node.

For example, the topography map may be implemented to provide a technical solution to estimate settings, e.g., optimal settings, for a networking node, for example, a PFC threshold, an ECN threshold, and/or a Qsize, e.g., as described below.

For example, as shown in FIG. 5, the topography map may be implemented to provide a technical solution to mitigate congestion, which may occur at an “outer” layer of the network, e.g., from an input of the network and/or towards an output of the network. In other aspects, the topography map may be implemented to provide a technical solution to mitigate congestion, which may additionally or alternatively occur in an “inner” layer of the network, e.g., at the networking nodes R2 and/or R4.

For example, the topography map may be implemented to provide a technical solution to evaluate how the settings of the networking nodes may impact the traffic pattern, e.g., per physical buffer, per switch and/or per cluster, e.g., as described below.

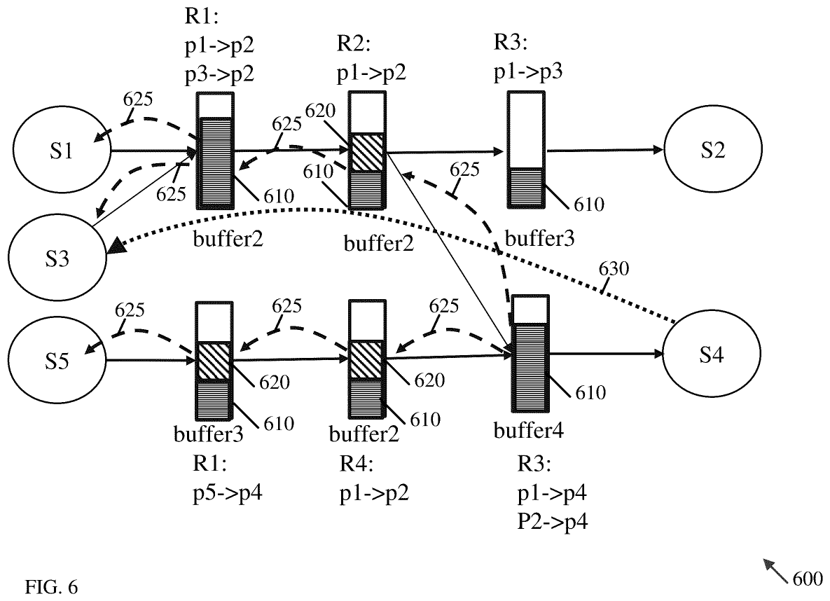

Reference is made to FIG. 6, which schematically illustrates a buffer occupancy scheme 600 to illustrate the occupancy of physical buffers of networking nodes, e.g., the networking nodes of the cluster 500 (FIG. 5), and corresponding flow control signals, in accordance with some demonstrative aspects.

For example, a networking node, e.g., a switch, a router, or the like, may maintain a buffer, for example, per each {egress port, Traffic class}, and/or per any other suitable setting. For example, the buffers may use a shared memory space.

For example, as shown in FIG. 6, inputs, e.g., all inputs, that send data to a specific egress port with the same T.C may fill the same egress buffer.

For example, one or more flow control mechanisms may be implemented to control the flow via the networking nodes.

For example, a PFC mechanism may utilize a PFC threshold and/or one or more other suitable PFC parameters, which may be applied with respect to a measured virtual ingress buffer. For example, the PFC mechanism may be configured to identify a situation where the PFC threshold is crossed, and based on this identified situation, to trigger one or more pause frames to be sent to a port and a traffic class, form which traffic is sent to the ingress buffer.

For example, an ECN mechanism may utilize an ECN threshold and/or one or more other suitable ECN parameters, which may be applied with respect to a measured virtual egress buffer. For example, the ECN threshold may be implemented in the form of a threshold, e.g., an egress queue threshold, and/or in the form of a probability, for example, to set a congestion indication bit when the threshold is crossed.

For example, a Qsize mechanism may utilize a buffer max queue size value to set a limit on a buffer height. For example, packets may be dropped, e.g., when the buffer height crosses the buffer max queue size value.

In some demonstrative aspects, it would be preferred to trigger an ECN event, for example, before a PFC event, and/or to trigger a PFC even, e.g., long enough before buffer occupancy crosses the max queue size. However, knowing what are the best thresholds that will guarantee these conditions may be a challenging task, e.g., since the PFC and ECN mechanisms are not defined to measure the same buffer.

In some demonstrative aspects, the topography map, e.g., as described above, may be implemented to provide a technical solution to parse both the virtual buffer system of the PFC mechanism and the virtual buffer system of the ECN mechanism, for example, as a single or combined resource set, which may support optimizing both the PFC and ECN threshold values.

For example, as shown in FIG. 6, there may be a 1:2 incast scenario starting on buffer 4, which may cause a PFC storm across the whole cluster.

For example, as shown in FIG. 6, a first congestion contribution 610 may be caused by original in-cast traffic.

For example, as shown in FIG. 6, a first congestion contribution 620 may be caused by a PFC pause, which may arrive from a next networking node.

For example, as shown in FIG. 6, the dashed lines 625 may represent PFC frames traversing the cluster, e.g., from a single point of congestion that may cause the PFC storm across the cluster.

For example, the PFC storm may reduce link utilization, and/or may increase JCT, e.g., dramatically.

In some demonstrative aspects, the topography map may be utilized to “predict” this type, and other types, of scenarios, e.g., as described above.

In some demonstrative aspects, a network-configuration setting may be determined to configure the network, for example, based on the topography map, e.g., as described above.

In some demonstrative aspects, the network-configuration setting may be configured, for example, to provide a technical solution to avoid PFC storms, e.g., by properly reconfiguring the network, e.g., before the PFC storm occurs.

In some demonstrative aspects, the network-configuration setting may be configured, for example, to set thresholds, e.g., optimal thresholds, for the ECN, PFC and/or max Qsize mechanisms, for example, to avoid and/or prevent the PFC storm events.

For example, as shown in FIG. 6, the topography map may be utilized to determine that an ECN event 630 may be triggered, e.g., from source S4 to source S3, for example, instead of triggering the PFC from buffer 4 and from buffer 2 (of networking node R1).

For example, as shown in FIG. 6, the topology map may be utilized to provide a technical solution to support a broader view, for example, a cluster-level view of the networking nodes in the cluster, which may take into consideration the states of the various buffers, e.g., all buffers.

For example, as shown in FIG. 6, the topology map may be utilized to provide a technical solution to support a “cluster level” optimization for the networking nodes.

For example, as shown in FIG. 6, the topology map may be utilized to provide a technical solution to support configuring a setting corresponding to one or more particular buffers and/or flows, for example, while taking into consideration the traffic flows and/or states of other buffers, e.g., as described above.

For example, as shown in FIG. 6, the topology map may be utilized to provide a technical solution to support configuring the ECN setting to trigger the ECN event 630 from source S4 to source S3, for example, before any PFC situation would actually occur at the buffer 2 of the node R1, e.g., in order to avoid the PFC events 625.

For example, the DRL-AI engine may utilize the topology map to provide a technical solution to support a pro-active setting of ECN and PFC parameters early enough, for example, to create a congestion notification on the flow from the source S3 to the source S4, for example, before the buffers R3:buffer 4, R1:buffer2, and R2:buffer 2 become congested, for example, even without causing any packet drops.

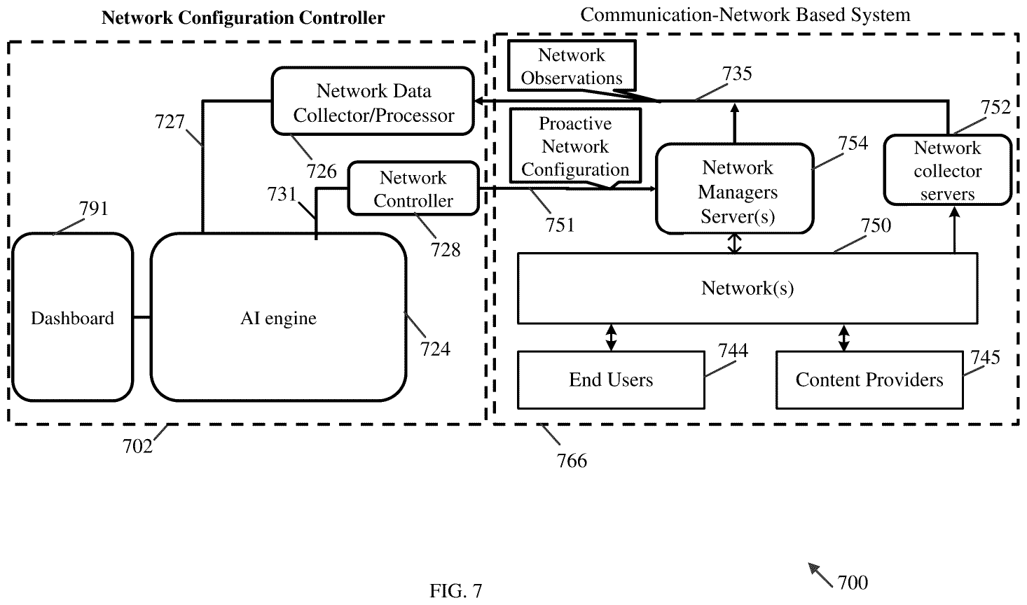

Reference is made to FIG. 7, which schematically illustrates a system 700 including a network configuration controller 702 to controllably set a configuration of at least one communication network 750, in accordance with some demonstrative aspects.

For example, configuration controller 102 (FIG. 1) may include one or more components of the network configuration controller 702, and/or may perform one or more operations and/or functionalities of network configuration controller 702.

For example, network 150 (FIG. 1) may include one or more components of the network 750, and/or may perform one or more operations and/or functionalities of the network 750.

In some demonstrative aspects, the at least one communication network 450 may include at least one communication network configured according to a lossy communication protocol.

In some demonstrative aspects, the at least one communication network 450 may include at least one communication network configured according to a lossless communication protocol.

In some demonstrative aspects, network 750 may be implemented according to any other suitable network architecture and/or layout.

For example, the at least one network 750 may include one or more cloud-based networks, one or more regional Telephone companies (Telcos) networks, and/or one or more Internet Service Providers (ISPs) networks, or the like.

In some demonstrative aspects, network 750 may be implemented as part of a communication-network based system 766, for example, to interconnect between a plurality of endpoint users 744 and one or more content providers 745, e.g., as described below.

For example, the content providers 745 may include one or more Content Application Providers (CAPs).

For example, the endpoint users 744 may include one or more user devices, for example, a UE, an MD, a STA, a PC, a desktop computer, a mobile computer, a laptop computer, a notebook computer, a tablet computer, a handheld computer, a handheld device, a wearable device, a sensor device, an IoT device, a mobile or portable device, a consumer device, a non-mobile or non-portable device, a wireless communication station, a wireless communication device, a video device, an audio device, an A/V device, or the like.

In some demonstrative aspects, in many deployments, implementations, use cases, and/or scenarios, there may be a need to provide a technical solution to support a sufficient level of one or more quality-based parameters, e.g., QoE and/or QoS, with respect to content provided to the end users, e.g., via the network 750.

For example, the QoE from online applications may be dramatically affected by the network service, for example, the network 750 that connects the content providers 745, e.g., a CAP origin server, with the end users 744.

For example, the Telcos infrastructure may typically carry all the traffic to and from end users 744.

For example, it is known that many CAPs may locate their origin servers on global cloud providers, which may not be on the Telcos premises.

For example, each Telco and cloud provider may prefer to handle only its own network, e.g., according to its own Service-Level Agreement (SLA).

For example, as a result, end-to-end traffic, e.g., from the CAP origin server to the end users 744 and/or from the end users 744 to the CAP origin server, may cross multiple networks and/or infrastructures, e.g., multi-cloud and/or multi-Telcos infrastructures.

For example, each Telco and/or cloud provider may manage their own network, for example, to guarantee only their internal SLA. As a result, the content providers 745, e.g., the CAPs, may not have sufficient control to ensure their client's QoE.

For example, there may be one or more technical limitations, which may limit the ability to control the QoE for the end users 744.

For example, network infrastructures may use profiles and definitions that may enable limited flexibility.

For example, network setup and/or planning may typically be done manually, and changes to the network definitions may require a long time.

For example, each network owner, e.g., a cloud provider X and/or a Telco provider Y, my typically controls only its internal profiles and definitions. In such cases, there may be no entity that is aware of an actual End-to-End service.

For example, many networks, e.g., especially Telcos networks, may not be aware of the applications running over their infrastructure.

For example, many standard routing engines and/or QoS management mechanisms may not be aware of traffic content and/or patterns.

For example, many networks may be configured as reactive networks, which may be configured to react to problems when they occur. This reactive configuration may be in opposed to a proactive configuration, which may be able to “react” to predicted problems, e.g., before they occur.

For example, there may be business limitations and/or other limitations, which may limit the ability to control the QoE for the end users 744.

For example, many Telcos may not be able to directly collect information relating to the experience of the end users 744, e.g., due to privacy issues.

For example, many Telcos may use a “residential SLA”, where home users may pay a monthly fee and get an agreed service level, e.g., Best Effort service.

For example, many cloud providers may not usually pay Telcos for delivering traffic between the cloud and the end consumers.

For example, Telcos premium services may be open for the enterprise market to connect between branches, e.g., not to the individual home users.

For example, in many use cases the technical limitations and the business limitations may be tied to each other.

For example, it may be very expensive for Telcos to make changes to the network, for example, due to lack of a technology to support dynamic and optimized network definitions on a large scale for end users, and/or since any SLA change may require manual work. As a result, the Telcos may typically sell only long-term packages, e.g., mainly to enterprises.

For example, Telcos are currently not able to provide any services that guarantee network performance down to end user's device.

For example, the lack of flexibility in network infrastructure, and the lack of possibility to predict traffic volumes in each part of the network, may result in very low average link utilization, e.g., about 40%, and, in some cases, even less than 10%.

For example, many network providers may attempt to compensate for this inefficiency, for example, by using fix oversubscription ratios, e.g., mainly on Edge\ Metro and Access networks. However, this situation may dramatically reduce the end users' QoE.

In some demonstrative aspects, network configuration controller 702 may be configured to provide a technical solution to support configuration, e.g., optimization, of at least one network segment, e.g., at least one network 750, e.g., as described below.

In some demonstrative aspects, network configuration controller 702 may be configured to provide a technical solution to support an End-To-End predictive and dynamic network optimization via the at least one network 750, for example, starting from the content provider 745, e.g., the CAP origin servers, to the end user 744, e.g., the CAP's end consumer device, and vice versa, e.g., as described below.

In some demonstrative aspects, network configuration controller 702 may be configured to provide a technical solution to support the End-To-End predictive and dynamic network optimization, for example, even via multiple networks 750, which may be managed by multiple different entities, for example, multiple-cloud providers and/or multiple Telcos networks, e.g., as described below.

In other aspects, network configuration controller 702 may be configured to provide a technical solution to support the End-To-End predictive and/or dynamic network optimization for any other suitable network, network segment, network hierarchy, and/or network architecture of the at least one network 750.

For example, network configuration controller 702 may be configured to provide a technical solution to support the End-To-End predictive and/or dynamic network optimization for a network 750 implemented as part of a datacenter, e.g., a Telco data center, a cloud provider datacenter, or the like.

For example, network configuration controller 702 may be configured to provide a technical solution to support the End-To-End predictive and/or dynamic network optimization for a network 750 implemented as part of a group of Autonomous Systems (AS).

For example, network configuration controller 702 may be configured to provide a technical solution to support the End-To-End predictive and/or dynamic network optimization for a network 750 implemented as part of any other suitable network architecture.

In some demonstrative aspects, network configuration controller 702 may be configured to determine a network-configuration setting to configure the network 750, for example, according to at least one target E2E performance parameter corresponding to an E2E performance of data flows between the content providers 745 and the end users 744, e.g., as described below.

In some demonstrative aspects, the at least one target E2E performance parameter may include one or more optimization targets, which may be defined, for example, by the CAP and/or any other entity, e.g., as described below.

In some demonstrative aspects, the definition of the one or more optimization targets may vary per application, use case, and/or scenario, e.g., as described below.

In some demonstrative aspects, the one or more optimization targets may include, for example, a delay parameter, a jitter parameter, a power consumption parameter, a high availability parameter, a parameter corresponding to lossless traffic, a parameter corresponding to high bandwidth, a parameter corresponding to JCT, a parameter corresponding to cost, any other suitable additional or alternative parameter, and/or any combination of two or more parameters.

In some demonstrative aspects, network configuration controller 702 may be configured to utilize one or ML algorithms, which may be continued to continuously learn a network behavior of the network 750, for example, from and to the content providers 745, e.g., the CAP origin servers, to each of its end consumers devices 744, e.g., as described herein.

In some demonstrative aspects, network configuration controller 702 may be configured to utilize one or ML algorithms, which may be continued to continuously learn a network behavior of the network 750, for example, between sources and destinations, e.g., any source and any destination, in one or more portions of the network 750, e.g., in any portion of the network, e.g., as described herein.

In some demonstrative aspects, network configuration controller 702 may be configured to utilize one or ML algorithms, which may be continued to continuously learn application usage patterns, e.g., per application per user, e.g., as described herein.

In some demonstrative aspects, network configuration controller 702 may be configured to utilize one or ML algorithms, which may be continued to continuously learn a QoE of the end users 744, e.g., the CAP's end users, as described herein.

In some demonstrative aspects, network configuration controller 702 may be configured to utilize one or ML algorithms, which may be continued to continuously learn the network status of network 750, e.g., as described herein.

In some demonstrative aspects, network configuration controller 702 may be configured to an AI engine, e.g., a single AI engine, to monitor and learn about some or all of these behaviors, e.g., a combination of these learning types, e.g., as described herein.

In some demonstrative aspects, network configuration controller 702 may be configured to provide a technical solution to control the network configuration of network 750, for example, in near real-time speed, e.g., as described below.

In some demonstrative aspects, this ability of network configuration controller 702 to enables the control the network configuration of network 750 in real time may be implemented to provide a technical solution to support an ML optimization (prediction) engine to predict the required network resources, e.g., a step ahead, as described below. As a result, the network infrastructure of network 750 may be configured to be ready in advance to an upcoming traffic demand.

In some demonstrative aspects, network configuration controller 702 may be configured to translate the ML prediction engine results into a set of network operations, which may be utilized to configure the network 750, e.g., by configuring an origin server location, routes, Traffic Management (T.M), and/or QoS configurations, or the like, e.g., as described herein.

In some demonstrative aspects, network configuration controller 702 may be configured to implement one or more mechanisms to support network awareness of traffic patterns, e.g., as described herein.

In some demonstrative aspects, network configuration controller 702 may be configured to implement one or more mechanisms to support End-to-End network awareness and controllability, e.g., as described herein.

In some demonstrative aspects, network configuration controller 702 may be configured to implement one or more mechanisms to support predictive optimization of network routing and/or QoS, e.g., as described herein.

In some demonstrative aspects, as shown in FIG. 7, network configuration controller 702 may include a Network Data Collector (NDC) 726, which may be configured to collect and process flow information 735 corresponding to networking nodes, e.g., networking nodes 153 (FIG. 1), of the network 750.

For example, NDC 726 may include one or more components of information monitor 126 (FIG. 1), and/or may perform one or more operations and/or functionalities of information monitor 126 (FIG. 1).

For example, NDC 726 may include one or more components of flow information monitor 320 (FIG. 3), synchronizer 322 (FIG. 3), topography map generator 324 (FIG. 3), and/or observation processor 326 (FIG. 3), and/or may perform one or more operations and/or functionalities of flow information monitor 320 (FIG. 3), synchronizer 322 (FIG. 3), topography map generator 324 (FIG. 3), and/or observation processor 326 (FIG. 3).

In some demonstrative aspects, NDC 726 may be configured to receive and/or collect the flow information 735 from one or more information sources, for example, including one or more suitable network collector servers 752, and/or any other additional or alternative type of information sources.

For example, the flow information 735 may include observed flow information, which may be based on, and/or may represent network observations over the network 750, e.g., as described below.

In some demonstrative aspects, the flow information 735 may include information according to an IPFIX protocol, a NETFLOW protocol, an SFLOW protocol, a Simple Network Management Protocol (SNMP), a gNMI protocol, an Intelligent Platform Management Interface (IPMI) protocol, and/or any other suitable additional or alternative protocol and/or format.

In some demonstrative aspects, NDC 726 may be configured to monitor the flow information 735, and to generate processed flow information 727, for example, based on the flow information 735, e.g., as described below.

In some demonstrative aspects, as shown in FIG. 7, network configuration controller 702 may include a network controller 728, which may be configured to provide network configuration information 751 to configure the network 750 according to a network-configuration setting, which may be determined, for example, based on the topography map 325 (FIG. 3), e.g., as described herein.

For example, configuration setting controller 128 (FIG. 1) may include one or more components of network controller 728, and/or may perform one or more operations and/or functionalities of network controller 728.

For example, network controller 728 may include one or more components of network adaptor 332 (FIG. 3), and/or may perform one or more operations and/or functionalities of network adaptor 332 (FIG. 3).

In some demonstrative aspects, as shown in FIG. 7, network configuration controller 702 may include an ML engine (AI engine) 724, which may be trained to provide an ML output 731, for example, based on an ML input, which may be based on the processed flow information 727, e.g., as described herein.

For example, ML engine 124 (FIG. 1) may include one or more components of ML engine 724, and/or may perform one or more operations and/or functionalities of ML engine 724.

In some demonstrative aspects, network controller 728 may be configured to determine output (network configuration) information 751, for example, based on the ML output 731, e.g., as described herein.

In some demonstrative aspects, network controller 728 may be configured to provide the output information 751, for example, to at least one network manager of network 750, e.g., to one or more network management servers 754.

For example, network controller 728 may be configured to provide the output (network configuration) information 751 in the form of proactive network configuration information, for example, to proactively trigger an update to a configuration of the network 750, e.g., as described herein.

For example, network controller 728 may be configured to provide the network configuration information 751 in the form of a network configuration recommendation, which may include a recommendation to apply the network-configuration setting to configure the network 750, e.g., as described herein.

For example, network controller 728 may be configured to provide the network configuration information 751 in the form of a plurality of network configuration settings to a plurality of network managers, for example, in case the network 750 includes a plurality of networks managed by a plurality of network managers 754, e.g., as described below.

For example, network controller 728 may be configured to provide the network configuration information 751 in the form of a first network-configuration setting for a first network manager 754 of a first network of networks 750, and a second network-configuration setting for a second network manager 754 of a second network of networks 750, e.g., as described below.

In other aspects, the network-configuration information 751 may be provided in any other suitable additional or alternative form and/or configuration.

For example, the network management server 754 may control a configuration of the network 750, for example, based on the network configuration information 751.

In some demonstrative aspects, network configuration controller 702 may be configured to provide a user Interface (UI) 791 to a user, for example, to receive input data from the user and/or to provide output data to the user, e.g., as described below.

In some demonstrative aspects, UI 791 may include a Graphical UI (GUI), a dashboard, and/or any other suitable type and/or form of UI.

In some demonstrative aspects, UI 791 may be configured to input from the user at least one optimization target, for example, at least one target E2E parameter, which may be utilized by the network configuration controller 702 in determining the network-configuration information 751, e.g., as described below.

In some demonstrative aspects, network configuration controller 702 may be configured to determine the network configuration information 751, for example, by determining a network-configuration setting to configure the network 750, for example, based on at least one target E2E performance parameter corresponding to an E2E performance over network 750, e.g., as described below.

In some demonstrative aspects, network configuration controller 702 may be configured to determine the network configuration information 751, for example, by determining the network-configuration setting to configure the network 750, for example, based on an E2E QoE, e.g., between content providers 745 and end users 744, over the network 751, e.g., as described below.

In some demonstrative aspects, network configuration controller 702 may be configured to determine the network configuration information 751, for example, by determining the network-configuration setting to optimize the E2E QoE, e.g., between content providers 745 and end users 744, over the network 750, e.g., as described below.

In some demonstrative aspects, network configuration controller 702 may be configured to determine the network configuration information 751, for example, by using the E2E QoE, e.g., between content providers 745 and end users 744, as an optimization target for determining the network-configuration setting to configure the network 750, e.g., as described below.

In other aspects, network configuration controller 702 may be configured to determine the network configuration information 751, for example, by using any other additional or alternative target E2E parameter as an optimization target.

In some demonstrative aspects, the E2E QoE, e.g., between content providers 745 and end users 744, over the network 750 may be managed based on a network-level perspective, which may be aware of network-level conditions and application-layer requirements, e.g., at an E2E perspective.

In some demonstrative aspects, network configuration controller 702 may be configured to process the flow information 735, for example, to identify, e.g., “learn”, traffic patterns of the traffic communicated by network 750, e.g., in real time, e.g., as described herein.

In some demonstrative aspects, network configuration controller 702 may be configured to process the flow information 735, for example, to monitor the network status of network 750, e.g., in real time, e.g., as described herein.

In some demonstrative aspects, network configuration controller 702 may be configured to predict a configuration, for example, an improved configuration, e.g., an optimized configuration or a best configuration, of the network 750, which may be utilized, for example, to achieve the optimization target, e.g., the E2E QoE, e.g., between content providers 745 and end users 744, and/or any other additional or alternative optimization target.

In some demonstrative aspects, network configuration controller 702 may be configured to process the flow information 735, for example, determine a configuration of the network 750, for example, to improve, e.g., to optimize, the E2E QoE, for example, across the system 766, e.g., as described herein.

In some demonstrative aspects, UI 791 may be configured to receive from a user an indication of one or more required optimization targets, e.g., low delay, high BW, cost, JCT, or the like, for example, via a unified interface such as, for example, a web browser, an Application Programming Interface (API), a dedicated application, or the like.

In some demonstrative aspects, NDC 726 may be configured to perform one or more operations and/or functionalities of a translation layer, which may be configured to translate the optimization targets into a set of constraints for the ML engine 724, e.g., as described below.

In some demonstrative aspects, NDC 726 may be configured to collect information relating to the QoE and/or any other performance criterion corresponding to the end user data of end users 744 and/or to one or more network portions, e.g., as described below.

In one example, this information may be collected directly from the network 750 and/or from network boundaries. In another example, this information may be collected the CAP user's devices 744, for example, via a dedicated probe, or from a CAP internal collector, e.g., if available.

In some demonstrative aspects, a probe may be used to detect the relevant network devices per end user per CAP.

In some demonstrative aspects, a network status collector may be connected to the relevant telco's network, e.g., via a NetFlow server, an sFlow server, and/or any other available network status collector server. For example, in case a collector server is not available, a Software Defined Network (SDN) protocol and/or tool may be used to probe the relevant networking nodes of the network 750.

In some demonstrative aspects, information from cloud providers about the location of the relevant CAP origin server may be collected, for example, via a CAP's cloud API, e.g., if required.

In some demonstrative aspects, NDC 726 may utilize the translation layer to translate the collected flow data 735, e.g., some or all of the collected data, for example, into meaningful information for an optimization engine, which may be based on ML technologies implemented by the AI engine 724.

In some demonstrative aspects, the ML engine 724 may be configured to learn the network behavior of network 750, for example, per application and/or per network termination point (user) 744.

In some demonstrative aspects, the ML engine 724 may utilize an ML algorithm, which may initially be trained, e.g., offline or online, by suitable training data.

In some demonstrative aspects, upon deployment of the ML engine 724, the ML engine 724 may continue to learn the actual topology and network behavior of network 750,e.g., in different scenarios, e.g., as described below.

In some demonstrative aspects, the ML engine 724 may implement multiple ML algorithms, which may be configured to support the ML engine 724 in learning and predicting a next optimal network configuration and topology for network 750, for example, based on the current state of network 750, e.g., as described below.

In some demonstrative aspects, the current state of the network 750 may be characterized, for example, by profiles of users' usage per application, by network topology and/or by network status, e.g., including queue load, link utilization, or the like.

In some demonstrative aspects, the ML engine 724 may be trained to find the optimized next state, for example, from any current state, for example, according to the one or more optimization targets, e.g., low delay, high BW, low jitter, High Availability, low JCT, or the like, for example, under one or more constraints, e.g., cost and/or other constraints.

In some demonstrative aspects, the ML engine 724 may be trained to predict the optimized network topology and configuration for network 750, for example, to deliver overall optimized performance.

In some demonstrative aspects, the ML engine 724 may be trained to provide the ML output 731 to include, for example, a suggested route for routing the traffic via the network 750, e.g., as described below.

In some demonstrative aspects, the ML engine 724 may be trained to provide the ML output 731 to include, for example, a suggested QoS configuration for the network 750, e.g., as described below.

In some demonstrative aspects, the ML engine 724 may be potentially implemented by agents, e.g., according to a distributed scheme.

In some demonstrative aspects, the ML suggestions provided by ML engine 724 may be constrained, for example, according to CAP\user definitions, available network resources and/or capabilities, and/or any other suitable additional or alternative constraints.

In some demonstrative aspects, the ML suggestions provided by ML engine 724 may be reflected, e.g., by network controller 728, to the relevant network operator, and/or forwarded, e.g., by network controller 728, to a network updater module, e.g., as described below.

In some demonstrative aspects, the Network Updater (NU) may translate the ML suggestions into network configurations and/or network instructions to be applied to network 750.

In some demonstrative aspects, network configuration controller 702 may be configured to select for network 750 routes, which may not be limited to well-known “best path selection” algorithms, e.g., Dijkstra.

In some demonstrative aspects, network configuration controller 702 may be configured to provide the network configuration information 751, for example, in a format suitable for Software-Defined Networking (SDN) protocols, or the like.

For example, the network configuration information 751 and/or network instructions based on the network configuration information 751, may be sent and distributed to relevant network equipment, for example, by standard control protocols such as, for example, a Border Gateway Protocol (BGP), a Resource Reservation Protocol (RSVP), an Open Shortest Path First (OSPF) protocol, an Intermediate System to Intermediate System (ISIS) protocol, or the like.

In some demonstrative aspects, network configuration controller 702 may be configured to provide the network configuration information 751 including a suggested, e.g., optimized, location for the CAP origin servers, for example, a suggestion to change the origin server region, to use an Edge server instead of a Core server, or the like.

In some demonstrative aspects, the ML engine 724 may be implemented using a DRL mechanism, a Graph Neural Network (GNN) mechanism, a Convolutional Neural Network (CNN) mechanism, and/or any other additional or alternative ML mechanisms.

For example, QoE and/or network infrastructure status of network 750 may change their state, for example, upon updating of the network routes and QoS, e.g., per the ML output 731 (Action).

For example, updated, e.g., new, ML inputs 727 (observations) may be provided to the ML engine 724, for example, based on the update state of the network 750.

For example, the ML engine 724 may learn the changes in the observations, and may move to a new state, for example, while creating new actions, which may be directed, for example, towards an optimized solution.

For example, the ML engine 724 may be configured to utilize a suitable learning state-based algorithm, for example, to provide a technical solution to support a predictive and proactive control over the configuration of the network 750.

For example, the ML engine 724 may know, e.g., at any given moment, what should be the network configuration of network 750, for example, to achieve the optimized solution, e.g., according the predefined constraints.

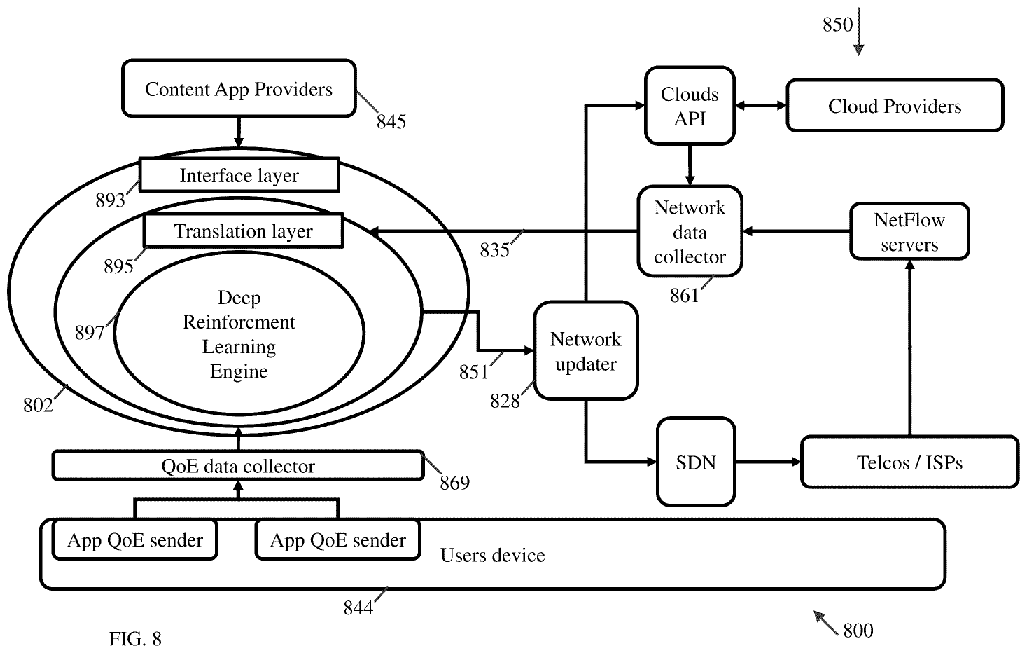

Reference is made to FIG. 8, which schematically illustrates components of a network configuration controller 802 to controllably set a configuration of at least one communication network 850, in accordance with some demonstrative aspects.

In some demonstrative aspects, network configuration controller 802 may be configured to provide network configuration information 851 to control a network-configuration setting of a communication network 850 between a plurality of endpoint user devices 844 and a plurality of CAPs 845, e.g., as described below.

For example, network configuration controller 702 (FIG. 7) may include one or more components of network configuration controller 802, and/or may perform one or more operations and/or functionalities of network configuration controller 802.

In some demonstrative aspects, as shown in FIG. 8, network configuration controller 802 may include a CAP Interface layer 893, which may be configured to support a CAP 845 to set one or more optimization criterion goals and/or constraints, for example, low delay, high bandwidth, high availability, traffic direction, network elements power consumption, cost, a combination of two or more optimization criterion goals and/or constraints, or the like.

For example, UI 791 (FIG. 7) may include one or more components of CAP Interface layer 893, and/or may perform one or more operations and/or functionalities of CAP Interface layer 893.

In some demonstrative aspects, as shown in FIG. 8, network configuration controller 802 may include translation layer 895, which may be configured to translate between the interface layer 893 and one or more external resources, which are external to an ML engine 897 of network configuration controller 802, e.g., as described below.

For example, translation layer 895 may be configured to receive user parameters from a user interface, e.g., UI 791 (FIG. 7), and to translate the user parameters into constraints, rewards and/or other inputs, which may be provided to the ML engine 897, e.g., as described above.

For example, translation layer 895 may be configured to receive status information, for example, from one or more QoE data collectors, and to translate the status information into suitable observation information to be provided to the ML engine 897, e.g., as described above.

For example, translation layer 895 may be configured to receive flow information, for example, from network data collectors, which may indicate the network status of the network 850, for example, per flow, e.g., as described above.

For example, translation layer 895 may be configured to translate the network information into observations to be provided to the ML engine 897, e.g., as described above.

For example, translation layer 895 may be configured to receive ML engine actions, e.g., provided at an ML output of ML engine 897, and to translate the ML engine actions into network configuration information 851 in a suitable format, e.g., a “network commands” module's syntax, or the like.

In some demonstrative aspects, ML Engine 897 may be configured to implement one or more DRL mechanisms, GNN mechanisms, supervised NN mechanisms, or the like.

In some demonstrative aspects, ML Engine 897 may be configured to process the constraints, targets and observations provided by the translation layer 895, e.g., as described above.

In some demonstrative aspects, ML Engine 897 may be configured to learn, e.g., to continually learn, the network 850, the users 844, and the application behavior and their patterns, e.g., as described above.

In some demonstrative aspects, ML Engine 897 may be configured to predict one or more next, e.g., optimal, required actions, for example, to achieve one or more of the defined targets for network 850, e.g., as described above.

In some demonstrative aspects, ML Engine 897 may be configured to send action information based on the determined actions, e.g., in the form of action commands, to translation layer 895.

In some demonstrative aspects, the translation layer 895 may be configured to translate the action information into the network configuration information 851, which may be provided to the network updater 828, e.g., as described above.

In some demonstrative aspects, the network updater 828 may receive the network configuration information 851, and may update one or more network modules, for example, based on the network configuration information 851.

In some demonstrative aspects, the network updater 828 may update a network controller module of the network 850.

In one example, configuration of QOS, Traffic Management (TM) and/or Buffer Management (BM) may be performed by the SDN, e.g., to configure specific networking nodes of network 850, e.g., routers\switches.

In another example, the building of premium routes and/or SLA may be performed, for example, by RSVP-TE, MPLS, SR-TE, or the like.

In another example, distribution of new routes may be performed, for example, by updating administrative distance values via a suitable protocol, for example, via ISIS, BGP, OSPF, or the like.

In some demonstrative aspects, the network updater 828 may update a network controller module.

In one example, the origin server location may be changed, for example, to create an improved, e.g., optimized route. For example, a suitable API to the CAP's global cloud provider may be implemented to perform this change.

In some demonstrative aspects, as shown in FIG. 8, the network configuration controller 802 may be configured to generate the network configuration information 851, for example, based on flow information 835, which may be provided by a network data collector 861, e.g., as described above.

For example, network data collector 861 may collect network status information from a plurality of Telcos.

For example, the Telcos may use servers to collect information about flows, buffer utilization, congestion and link utilization from their network devices, for example, according to standard protocols, e.g., including NetFlow, sFlow or the like.

For example, the network data collector module 861 may access these Telco servers, for example, via a Simple Network Management Protocol (SNMP), and/or any other suitable protocol, for example, to collect information about the network status of network 850.

For example, the network data collector module 861 may collect information about CAP containers and/or microservices geographical locations (zones), for example, using a cloud services API.

In some demonstrative aspects, as shown in FIG. 8, an Application (App) QoE data collector 869 may be configured, for example, as a probe, for example, to collect QoE data from end devices 844, for example, indicative of the user experience while using the relevant application (CAP).

In some demonstrative aspects, the QoE data collector module 869 may be, for example, integrated as part of a CAP's installation package, or as part of a CAP's web-based application.

In some demonstrative aspects, the QoE data collector module 869 may configured to connect to a CAP's QoE probing system, for example, to collect the required information about the user experience.

In some demonstrative aspects, the QoE data collector module 869 may be configured to collect the QoE data, for example, in compliance with General Data Protection Regulation (GDPR) requirements, or the like.

In some demonstrative aspects, the QoE data collector 869 may be configured to aggregate information of a plurality of App QoE data collectors, to process the aggregated information, and to send the processed aggregated QoE information to the translation layer 895.

In some demonstrative aspects, network configuration controller 802 may be configured to provide a technical solution to monitor, learn, and/or manage a network status of network 850 as a whole, for example, while considering the E2E aspects of routing selection, buffer management, and/or traffic management (T.M), e.g., as described above.

For example, network configuration controller 802 may be configured to provide a technical solution to provide the network configuration information 851, which may be configured to control a network-configuration setting in terms of relevant configurations for routing, traffic management, and/or buffer management, e.g., as described above.

In some demonstrative aspects, network configuration controller 802 may be configured to provide a technical solution to support an End-to-End guarantee for quality of service, for example, between a CAP's origin server and its end user devices, e.g., as described above.

For example, network configuration controller 802 may be configured to provide a technical solution to learn End-to-End statuses, patterns, and/or behavior, which may support network configuration controller 802 in optimizing the network quality of service according CAP targets, e.g., as described above.

In some demonstrative aspects, network configuration controller 802 may be configured to provide a technical solution in the form of a unified platform, which may support the CAP in guaranteeing quality of service, for example, across multiple Telcos and/or multiple cloud providers, e.g., as described above.

For example, network configuration controller 802 may be configured to provide a technical solution to deliver a unified platform for CAPs to define their optimization targets, e.g., across multiple Telcos and/or cloud providers, for example, to implement these CAP's optimization targets, e.g., as described above.

For example, network configuration controller 802 may be configured to provide a technical solution to support cooperation with multiple Telcos and/or cloud providers, for example, to achieve the CAP's optimization targets, e.g., as described above.

For example, in opposed to a Telco's network, which may typically be “blind” to the customer QoE of the CAP, network configuration controller 802 may be configured to provide a technical solution to collect and learn QoE information and learn the end user QoE, e.g., continuously per CAP.

For example, Telcos may typically use static oversubscription to increase infrastructure utilization. This static oversubscription may statistically reduce network quality of service and end user's QoE.

For example, network configuration controller 802 may be configured to provide a technical solution to support dynamic and/or predictable oversubscription, which may, for example, statistically guarantee the end user's QoE, for example, according to the CAP's optimization targets, e.g., as described above.

For example, Telcos may typically not support dynamic SLA per CAP per end user (residential), for example, because the Telcos are typically “blind” to the end user QoE.

For example, network configuration controller 802 may be configured to probe the CAP's end user QoE, and to use the probed QoE as an input to the ML optimization engine 897, for example, to control the Telcos network resources dynamically, e.g., as described above. Accordingly, network configuration controller 802 may be configured to provide a technical solution to support dynamic SLA, e.g., per CAP, and/or per end user.

For example, network configuration controller 802 may be configured to provide a technical solution to control the Telcos network resources, e.g., dynamically and/or automatically, for example, to support a dynamic SLA, e.g., per CAP and/or per end user.

For example, in many networks, routes may typically be determined according one or more “best path selection” techniques, e.g., Dijkstra. However, this “best path” may not be optimized per application and/or per CAP. For example, a best path for a CAP A may not necessarily be the best path for a CAP B.

For example, network configuration controller 802 may be configured to provide a technical solution to determine the optimized path, e.g., per each CAP, for example, at any given time, e.g., as described above.

For example, many types of path algorithms, e.g., Dijkstra, may need to recursively calculate a graph per any change in network wights. Accordingly, changes may be very expensive in terms of computation resources.

For example, network configuration controller 802 may be configured to utilize the ML optimization engine 897, which may not be required to recalculate the entire network segment each time. For example, the ML optimization engine 897 may learn observations continuously, for example, such that a state, e.g., each state, may point to a next optimized state, e.g., with much lower computational resources.

For example, in opposed to best path algorithms, which may typically be centralized per network segment, the ML engine 897 may be implemented, for example, as a centralized model as well as a distributed model, e.g., using multi agent deep re-enforcement learning algorithms.

For example, networking nodes, e.g., routers and/or switches, may typically use internal buffers to handle congestions. For example, buffer management and/or T.M. techniques may be implemented to resolve a TC, for example, according to a packet's header, and to add packets to a relevant queue, for example, according to TC and destination. For example, a queue, e.g., each queue, may typically use one of pre-configured TC parameters, e.g., Weighted Random Early Detection (WRED) or the like, a priority of the queue over other queues, and/or internal resources, e.g., Max queue size. For example, the TC parameters and/or the TM may typically be configured manually, e.g., when a cluster is designed.

For example, network configuration controller 802 may be configured to dynamically configure the TC and/or TM parameters, and/or the flow priority, for example, according to the prediction determined by ML engine 897, e.g., based on network status and/or the optimization targets and/or constraints, e.g., as described above.

For example, network operators may typically use fixed, or even identical, configurations for all routers in a cluster and may rarely change this configuration. For example, clusters my typically include tens of thousands of routers, and network planers are usually not able to predict the future traffic patterns and usages.

For example, network configuration controller 802 may be configured to learn the network patterns and usage, e.g., on-the-fly, and to update the configuration, e.g., the optimal configuration, for example, dynamically and in near real-time time frames, e.g., as described above.

For example, in opposed to TC and/or queue configurations, which may typically be unaware of statuses of other network devices, network configuration controller 802 may be configured to provide a technical solution, which may be aware, e.g., fully aware, of other network device statuses and/or configurations, and, accordingly, may configure each relevant network device with a different configuration, for example, to produce optimized End-To-End performance, e.g., as described above.

For example, some routing protocols may be able to take into consideration link delays, for example, by using measurements done by a Two-Way Active Measurement Protocol (TWAMP), and by setting an administrative distance accordingly.

For example, network configuration controller 802 may be configured to provide a technical solution to support flow level, e.g., in opposed to only link level, delay awareness routing along the End-to-End path, e.g., as described above.

For example, a delay measurement's aware routing may be a reactive mechanism, as it may try to solve delays after the delays already happened.

For example, network configuration controller 802 may be configured to build an “internal understanding” of the network behavior, and/or the usage patterns, and may predict the optimal configuration for a next state, for example, to proactively configure the network according to a configuration that avoids the delays before they happen, e.g., as described above.

For example, the Internet is a hierarchical network, and flows are typically aggregated, for example, as going from a consumer device towards the internet core. Accordingly, there may typically be more flows per link. For example, core routers may serve millions of flows, while the flow QoS may be differentiated by a few different TCs per link.

For example, network configuration controller 802 may be configured to provide a technical solution to dynamically change the relevant flow priority, e.g., to a higher or lower priority TC, e.g., depending on CAP constraint and/or budget, and/or to update TC parameters, e.g., WRED parameters.

For example, a flow that originates from an origin server towards an end consumer, e.g., home\mobile, and vice versa, may cross multiple Autonomous Systems (AS) and/or vendors. However, there may typically be no single entity that can guarantee the network quality across the whole path of the flow.

For example, network configuration controller 802 may be configured to learn the behavior of the relevant network segments, e.g., vendors, autonomous systems, or the like, and/or to learn the per application usage of the network, e.g., as described above. Accordingly, network configuration controller 802 may be implemented to provide a technical solution to route specific flows through different vendors and AS, for example, according to its predictions, e.g., as described above.

For example, network configuration controller 802 may be configured to change, e.g., via SDN, the relevant QoS configurations of network devices that are part of the flow selected path, e.g., as described above.

For example, applications that support microservices and/or containers that can run from different geographical locations or locations having different network connectivity, may be able to select a required active container, e.g., manually.

For example, network configuration controller 802 may be configured to provide a technical solution to select the container and/or microservice site dynamically, for example, according to the ML optimization engine targets, which may include, for example, minimum delay, price, or the like, e.g., as described above. For example, this selection may be implemented by a suitable API to the CAP's management environment.

For example, many Telcos may typically not handle application isolation to and from home users. Therefore, if a network is congested, e.g., due to many users of a specific video application, other users, which do not use this application, will still suffer from a degraded QoE.

For example, network configuration controller 802 may be configured to provide a technical solution to guarantee a QoE, e.g., an optimized QoE, per application, e.g., as described above. Accordingly, a CAP A may implement the network configuration controller 802 to guarantee that the QoE of the customers of the CAP A may not be degraded due to an overload caused by another CAP B.

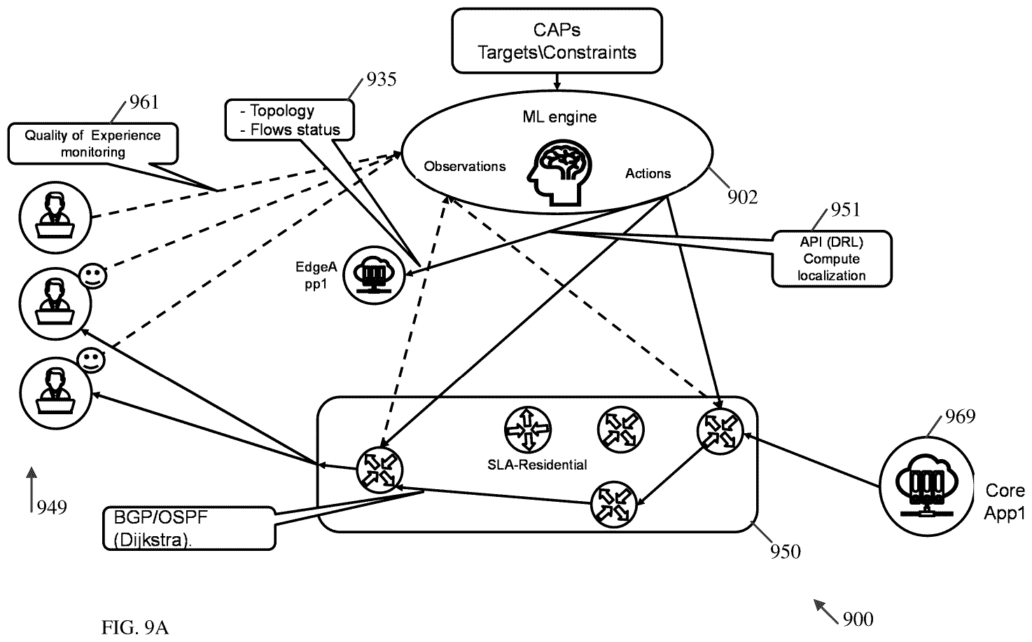

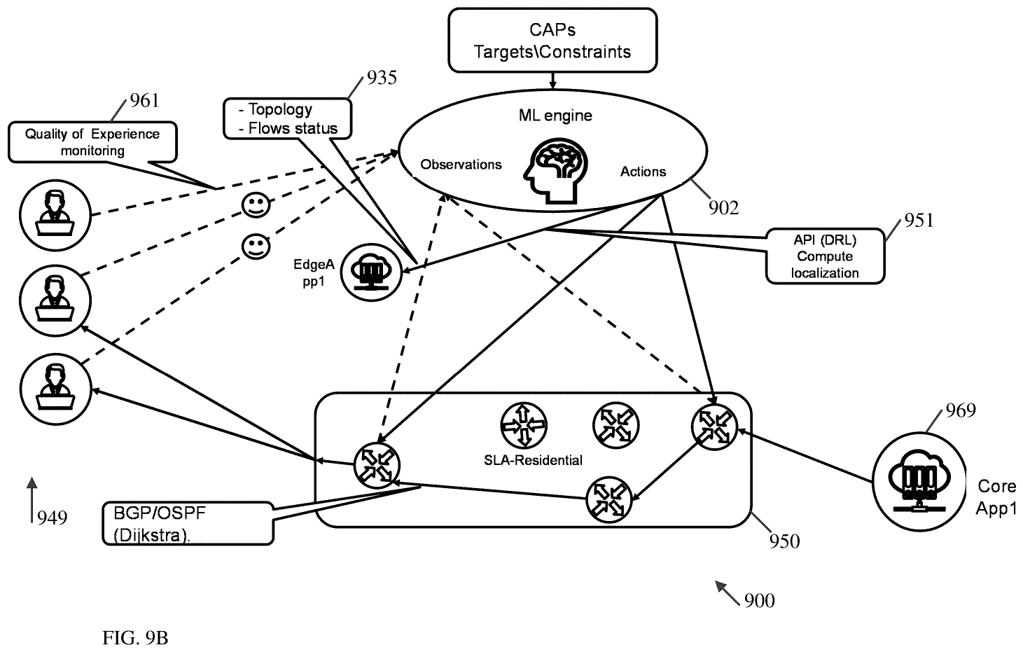

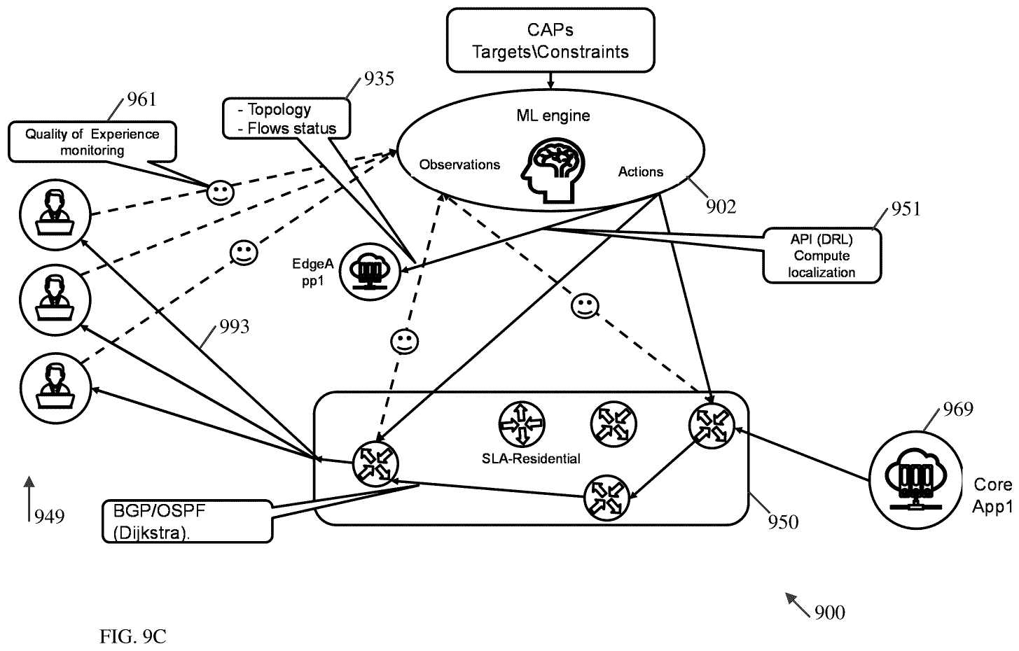

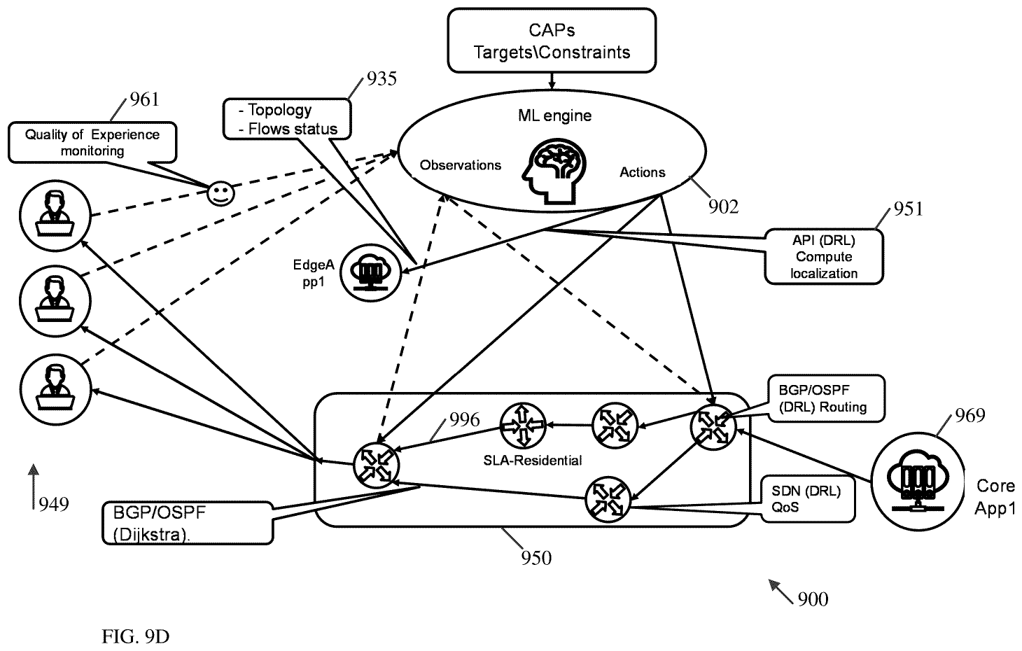

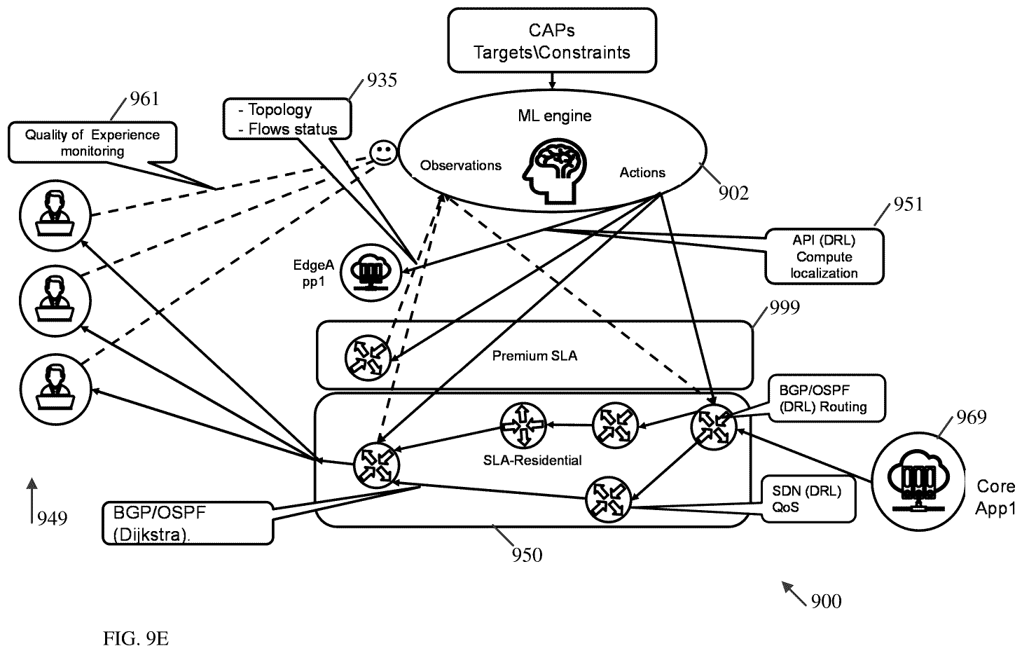

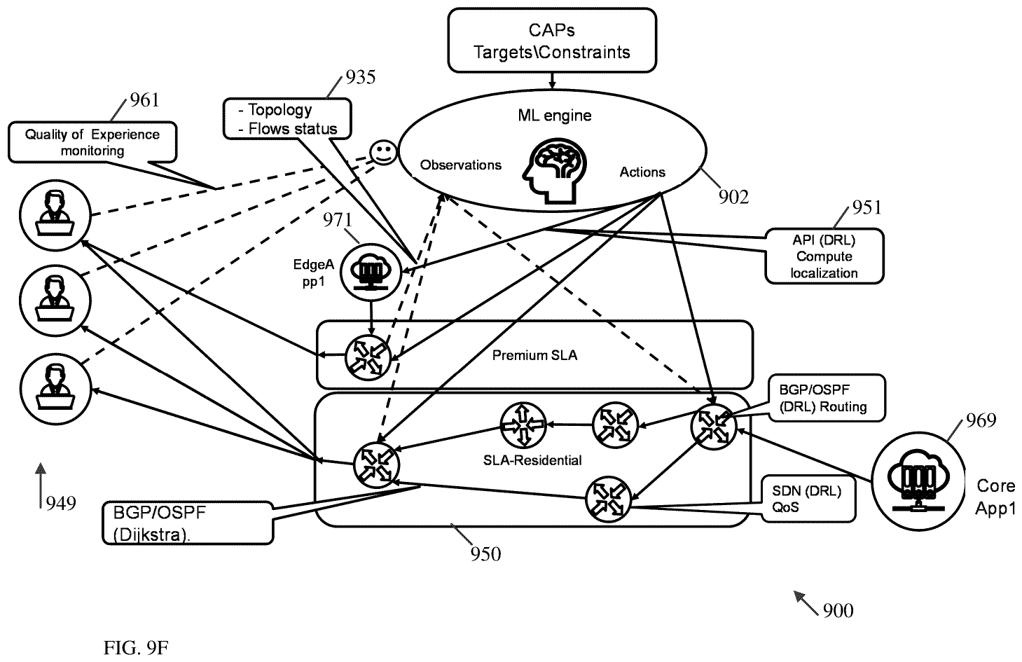

Reference is made to FIGS. 9A, 9B, 9C, 9D, 9E and 9F, which conceptually illustrate states of a system 900 implementing a network configuration controller 902, in accordance with some demonstrative aspects.

For example, network configuration controller 902 may include one or more components of network configuration controller 802 (FIG. 8), and/or may perform one or more operations and/or functionalities of network configuration controller 802 (FIG. 8).

For example, as shown in FIGS. 9A, 9B, 9C, 9D, 9E and 9F, network configuration controller 902 may be configured to control a network-configuration setting to configure a network 950, which may include a plurality of networking nodes, for example, routers and/or switches, e.g., as described above.

For example, as shown in FIGS. 9A, 9B, 9C, 9D, 9E and 9F, the networking nodes of network 950 may communicate a plurality of data flows via a plurality of data paths between a plurality of end users 949 and one or more CAPs 969.

For example, as shown in FIGS. 9A, 9B, 9C, 9D, 9E and 9F, network configuration controller 902 may receive QoE information 961 corresponding to a QoE of the endpoint users 949, e.g., as described above.

For example, as shown in FIGS. 9A, 9B, 9C, 9D, 9E and 9F, network configuration controller 902 may provide output (network-configuration) information 951 to configure the network 950, for example, according to a determined network-configuration setting, e.g., as described above.

For example, network configuration controller 902 may be configured to determine the network-configuration setting, for example, according to a CAP optimization target, which may include stable traffic, e.g., no packet loss, with normal delay at a constraint budget.

For example, as shown in FIG. 9A, at a first state routing of the CAP flows may be performed according to a shortest path, e.g., as may be selected by a standard Dijkstra mechanism.

For example, as shown in FIG. 9B, at the first state network configuration controller 902 may receive QoE notifications 961 indicating a good QoE for all of the endpoint users.

For example, as shown in FIG. 9C, in case the network configuration controller 902 is not implemented, the load of network 950 may increase at a second state, for example, such that a path 993 may become congested. For example, the network configuration controller 902 may receive flow status information 935 indicating an increase in buffer utilization, and QoE information 961 indicating decreased QoE, e.g., of a user 949 served by the data path 993.

For example, in such a situation, buffer size may increase, and networking nodes may drop packets. For example, as long as the overload exists, the QoE may not be solved automatically.

For example, as shown in FIG. 9D, network configuration controller 902 may predict an optimized route for the congested flow of data path 993 (FIG. 9C), for example, even before the overload is spread in the network 950.

For example, as shown in FIG. 9D, network configuration controller 902 may move the relevant flows to new and free routes 996. For example, as a result, the end user QoE 961 may improve, and distribution of overload across the network may be avoided.

For example, network configuration controller 902 may be configured to detect the potential overloaded path 993 (FIG. 9C), e.g., in advance, for example, based on monitoring of the network information 935 and the QoE information 961, e.g., as described above.

For example, network configuration controller 902 may be configured to provide network-configuration information 951, for example, to change a routing for one or more of the CAP flows, for example, from the shortest but overloaded path, e.g., as may have been selected by a standard Dijkstra mechanism, into the longer but non-loaded path 996.

For example, network configuration controller 902 may be configured to identify that the QoE from some of the CAP end users 949 may still not be good enough.

For example, as shown in FIG. 9E, network configuration controller 902 may be configured to us an available CAP's budget, for example, to upgrade the SLA and purchase premium routes\TC.

For example, as shown in FIG. 9E, network configuration controller 902 may be configured to dynamically send to the Telco an upgraded SLA, for example, according to the CAP's optimization target and/or cost constraint, e.g., as described above.

For example, as shown in FIG. 9E, according the upgraded SLA, traffic from this CAP should be prioritized and be routed on dedicated routes, e.g., via a “Premium SLA” 999.

For example, as shown in FIG. 9F, network configuration controller 902 may be configured to detect that it may be preferable to connect the premium service 999 to an edge server 971.

For example, as shown in FIG. 9F, network configuration controller 902 may be configured to identify that it may be best to use an edge sever 971, e.g., instead of the core server, for example, to better optimize the user QoE 961.

For example, as shown in FIG. 9F, the load over all routes may be reduced, and all users may be provided with a QoE 961, for example, according the costs (budget) set by the CAP 969.

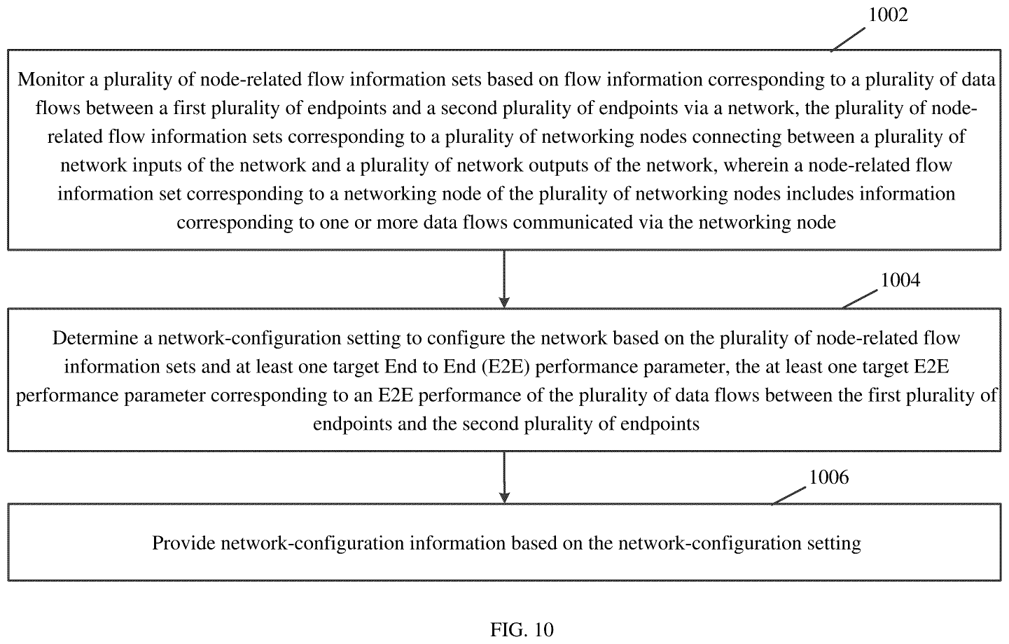

Reference is made to FIG. 10, which schematically illustrates a method of configuring a network, in accordance with some demonstrative aspects. For example, one or more of the operations of the method of FIG. 10 may be performed by one or more elements of a system, e.g., system 100 (FIG. 1), for example, one or more elements of a configuration controller, e.g., configuration controller 102 (FIG. 1), for example, one or more elements of a network configuration controller, e.g., network configuration controller 110 (FIG. 1), network configuration controller 402 (FIG. 4), network configuration controller 702 (FIG. 7), network configuration controller 802 (FIG. 8), and/or network configuration controller 902 (FIGS. 9A-9F).

As indicated at block 1002, the method may include monitoring at a network configuration controller a plurality of node-related flow information sets, for example, based on flow information corresponding to a plurality of data flows via a network, e.g., between a first plurality of endpoints and a second plurality of endpoints. For example, the plurality of node-related flow information sets may correspond to a plurality of networking nodes connecting between a plurality of network inputs of the network and a plurality of network outputs of the network. For example, a node-related flow information set corresponding to a networking node of the plurality of networking nodes may include information corresponding to one or more data flows communicated via the networking node. For example, network configuration controller 110 (FIG. 1) may be configured to monitor the plurality of node-related flow information sets, for example, based on flow information corresponding to the plurality of data flows between the endpoints 163 (FIG. 1) and the endpoints 164 (FIG. 1) via the network 150 (FIG. 1), e.g., as described above.

As indicated at block 1004, the method may include determining a network-configuration setting to configure the network based on the plurality of node-related flow information sets and at least one target E2E performance parameter. For example, the at least one target E2E performance parameter may correspond to an E2E performance of the plurality of data flows between the first plurality of endpoints and the second plurality of endpoints, e.g., via the network. For example, network configuration controller 110 (FIG. 1) may be configured to determine the network-configuration setting to configure the network 150 (FIG. 1), for example, based on the plurality of node-related flow information sets and the at least one target E2E performance parameter, e.g., as described above.

As indicated at block 1006, the method may include providing output (network-configuration) information based on the network-configuration setting. For example, network configuration controller 110 (FIG. 1) may be configured to provide the output information 133 (FIG. 1), for example, based on the network-configuration setting 131 (FIG. 1), e.g., as described above.

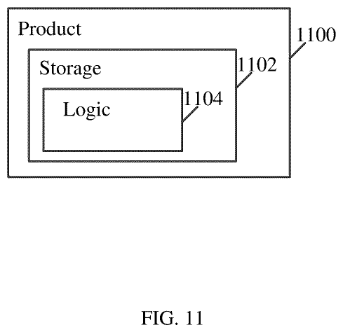

Reference is made to FIG. 11, which schematically illustrates a product of manufacture 1100, in accordance with some demonstrative aspects. Product 1100 may include one or more tangible computer-readable (“machine-readable”) non-transitory storage media 1102, which may include computer-executable instructions, e.g., implemented by logic 1104, operable to, when executed by at least one computer processor, enable the at least one computer processor to implement one or more operations at a system, e.g., system 100 (FIG. 1), at one or more elements of a configuration controller, e.g., configuration controller 102 (FIG. 1), and/or at one or more elements of a network configuration controller, e.g., network configuration controller 110 (FIG. 1), network configuration controller 402 (FIG. 4), network configuration controller 702 (FIG. 7), network configuration controller 802 (FIG. 8), and/or network configuration controller 902 (FIGS. 9A-9F); to cause a system, e.g., system 100 (FIG. 1), one or more elements of a configuration controller, e.g., configuration controller 102 (FIG. 1), and/or one or more elements of a network configuration controller, e.g., network configuration controller 110 (FIG. 1), network configuration controller 402 (FIG. 4), network configuration controller 702 (FIG. 7), network configuration controller 802 (FIG. 8), and/or network configuration controller 902 (FIGS. 9A-9F), to perform, trigger and/or implement one or more operations and/or functionalities; and/or to perform, trigger and/or implement one or more operations and/or functionalities described with reference to the FIGS. 1-10, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1100 and/or machine readable storage media 1102 may include one or more types of computer-readable storage media capable of storing data, including volatile memory, non-volatile memory, removable or non-removable memory, erasable or non-erasable memory, writeable or re-writeable memory, and the like. For example, machine readable storage media 1102 may include, RAM, DRAM, Double-Data-Rate DRAM (DDR-DRAM), SDRAM, static RAM (SRAM), ROM, programmable ROM (PROM), crasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a network configuration controller comprising one or more processors configured to monitor a plurality of node-related flow information sets based on flow information corresponding to a plurality of data flows between a first plurality of endpoints and a second plurality of endpoints via a network, the plurality of node-related flow information sets corresponding to a plurality of networking nodes connecting between a plurality of network inputs of the network and a plurality of network outputs of the network, wherein a node-related flow information set corresponding to a networking node of the plurality of networking nodes comprises information corresponding to one or more data flows communicated via the networking node; and determine a network-configuration setting to configure the network based on the plurality of node-related flow information sets and at least one target End to End (E2E) performance parameter, the at least one target E2E performance parameter corresponding to an E2E performance of the plurality of data flows between the first plurality of endpoints and the second plurality of endpoints; and an output to provide output information based on the network-configuration setting.

Example 2 includes the subject matter of Example 1, and optionally, wherein the node-related flow information set comprises source address information to identify a network input of the plurality of network inputs corresponding to a data flow, destination address information to identify a network output of the plurality of network outputs corresponding to the data flow, source port information to identify an ingress port of the networking node corresponding to the data flow, destination port information to identify an egress port of the networking node corresponding to the data flow, length information to identify a data length corresponding to the data flow, and next-hop information to identify a next-hop networking node corresponding to the data flow.

Example 3 includes the subject matter of Example 2, and optionally, wherein the node-related flow information set comprises Quality of Service (QOS) information comprising information of one or more QoS parameters corresponding to the flow.

Example 4 includes the subject matter of Example 2 or 3, and optionally, wherein the node-related flow information set comprises timing information comprising information of one or more timing parameters corresponding to the data flow.

Example 5 includes the subject matter of any one of Examples 1-4, and optionally, wherein the network configuration controller is configured to determine the network-configuration setting such that a predefined criterion with respect to the at least one target E2E performance parameter is to be met.

Example 6 includes the subject matter of any one of Examples 1-5, and optionally, wherein the network configuration controller is configured to monitor the flow information, and to update the network-configuration setting based on a detected real-time change in the plurality of node-related flow information sets.

Example 7 includes the subject matter of Example 6, and optionally, wherein the detected real-time change in the plurality of node-related flow information sets comprises a change indictive of an expected congestion state of at least one networking node.

Example 8 includes the subject matter of Example 6 or 7, and optionally, wherein the detected real-time change in the plurality of node-related flow information sets comprises a change indictive of an expected degradation in the at least one target E2E performance parameter.

Example 9 includes the subject matter of any one of Examples 6-8, and optionally, wherein the network configuration controller is configured to update the network-configuration setting to a setting, which is configured to reduce a probability of a degradation in the at least one target E2E performance parameter.

Example 10 includes the subject matter of any one of Examples 6-9, and optionally, wherein the network configuration controller is configured to update the network-configuration setting to a setting, which is configured to increase a probability of an improvement in the at least one target E2E performance parameter.

Example 11 includes the subject matter of any one of Examples 1-10, and optionally, wherein the network configuration controller is configured to dynamically update the network-configuration setting based on the flow information according to a criterion corresponding to the at least one target E2E performance parameter.

Example 12 includes the subject matter of any one of Examples 1-11, and optionally, wherein the network configuration controller is configured to determine a first network-configuration setting based on a first plurality of node-related flow information sets corresponding to first flow information related to a first time frame, and to determine a second network-configuration setting, different from the first network-configuration setting, based on a second plurality of node-related flow information sets, different from the first plurality of node-related flow information sets, corresponding to second flow information related to a second time frame subsequent to the first time frame.

Example 13 includes the subject matter of any one of Examples 1-12, and optionally, wherein the network configuration controller is configured to determine a predicted state of the plurality of data flows via the network based on the plurality of node-related flow information sets, and to determine the network-configuration setting based on the predicted state of the plurality of data flows via the network and the at least one target E2E performance parameter.

Example 14 includes the subject matter of Example 13, and optionally, wherein the network configuration controller is configured to determine the network-configuration setting such that a predefined criterion with respect to the at least one target E2E performance parameter is to be met based on applying the network-configuration setting for the predicted state of the plurality of data flows via the network.

Example 15 includes the subject matter of any one of Examples 1-14, and optionally, wherein the network configuration controller comprises a Machine Learning (ML) engine trained to generate ML output information based on an ML input, which is based on the plurality of node-related flow information sets, wherein the network-configuration setting is based on the ML output information.

Example 16 includes the subject matter of Example 15, and optionally, wherein the network configuration controller is configured to determine network topography information corresponding to a network topography of the network based on the plurality of node-related flow information sets, wherein the ML input information is based on the network topography information.

Example 17 includes the subject matter of Example 16, and optionally, wherein the network configuration controller is configured to determine size-reduced network topography information by reducing a size of the network topography information based on a size of the ML input, wherein the ML input is based on the size-reduced network topography information.

Example 18 includes the subject matter of Example 17, and optionally, wherein the size-reduced network topography information comprises network topography information corresponding to a subset of networking nodes, the ML output information corresponding to the subset of networking nodes.

Example 19 includes the subject matter of Example 18, and optionally, wherein the network configuration controller is configured to maintain the network topography information corresponding to the plurality of networking nodes, and to update the network topography information based on the ML output information corresponding to the subset of networking nodes.

Example 20 includes the subject matter of any one of Examples 15-19, and optionally, wherein the ML engine comprises a Deep Reinforcement Learning (DRL) engine configured to generate the ML output information comprising action information based on the ML input comprising observation information and reward information, wherein the observation information is based on the plurality of node-related flow information sets, the reward information is based on the at least one target E2E performance parameter, the network-configuration setting is based on the action information.

Example 21 includes the subject matter of Example 20, and optionally, wherein the ML engine is configured to selectively activate or deactivate a learning process of the DRL engine based on one or more reward criteria applied to the reward information.

Example 22 includes the subject matter of any one of Examples 1-21, and optionally, wherein the network configuration controller is configured to determine network topography information corresponding to a network topography of the network based on the plurality of node-related flow information sets, and to determine the network-configuration setting based on the network topography information.

Example 23 includes the subject matter of Example 22, and optionally, wherein the network topography information comprises a topography map to map statistical data flow sizes to a plurality of ingress-egress port pairs, the plurality of ingress-egress port pairs corresponding to a plurality of ingress ports of the plurality of networking nodes and a plurality of egress ports of the plurality of networking nodes.

Example 24 includes the subject matter of Example 23, and optionally, wherein an ingress-egress port pair of the plurality of ingress-egress port pairs comprises an egress port of a first networking node of the plurality of networking nodes and an ingress port of a second networking node of the plurality of networking nodes.

Example 25 includes the subject matter of Example 23 or 24, and optionally, wherein the topography map is to map statistical QoS information to the plurality of egress ports.

Example 26 includes the subject matter of any one of Examples 23-25, and optionally, wherein the network topography information comprises a plurality of statistical ingress data sizes corresponding to the plurality of ingress ports, and a plurality of statistical egress data sizes corresponding to the plurality of egress ports, wherein a statistical ingress data size corresponding to an ingress port is based on statistical data flow sizes mapped to ingress-egress port pairs comprising the ingress port, wherein a statistical egress data size corresponding to an egress port is based on statistical data flow sizes mapped to ingress-egress port pairs comprising the egress port.

Example 27 includes the subject matter of any one of Examples 22-26, and optionally, wherein the network configuration controller is configured to determine network topology information corresponding to a network topology of the network based on the plurality of node-related flow information sets, and to determine the network topography information based on the network topology information, wherein the network topology information comprises routing information corresponding to active data flow routes between the plurality of networking nodes.

Example 28 includes the subject matter of any one of Examples 1-27, and optionally, wherein the network configuration controller is configured to determine the network-configuration setting comprising at least one ingress-port setting, the at least one ingress-port setting comprising at least one of an Explicit Congestion Notification (ECN) setting or a maximal buffer queue size setting, wherein the at least one ingress-port setting is configured such that any Priority Flow Control (PFC) event based on a PFC setting is not to occur before an ingress-port event based on the at least one ingress-port setting.

Example 29 includes the subject matter of any one of Examples 1-28, and optionally, wherein the network-configuration setting comprises one or more node-specific parameter settings corresponding to one or more networking nodes of the plurality of networking nodes.

Example 30 includes the subject matter of Example 29, and optionally, wherein a node-specific parameter setting of the one or more node-specific parameter settings comprises at least one of a Priority Flow Control (PFC) setting for one or more ingress ports, an Explicit Congestion Notification (ECN) setting for one or more egress ports, or a maximal buffer queue size setting for the one or more egress ports.

Example 31 includes the subject matter of Example 29 or 30, and optionally, wherein a node-specific parameter setting of the one or more node-specific parameter settings comprises at least one QoS setting.

Example 32 includes the subject matter of any one of Examples 1-31, and optionally, wherein the network-configuration setting comprises a routing setting of a routing topology to route the data flows from the plurality of network inputs to the plurality of network outputs.

Example 33 includes the subject matter of any one of Examples 1-32, and optionally, wherein the network configuration controller is configured to determine the at least one target E2E performance parameter based on input from a user.

Example 34 includes the subject matter of any one of Examples 1-33, and optionally, wherein the at least one target E2E performance parameter comprises a Job Completion Time (JCT).

Example 35 includes the subject matter of any one of Examples 1-34, and optionally, wherein the at least one target E2E performance parameter comprises a usage efficiency corresponding to a usage efficiency of the network.

Example 36 includes the subject matter of any one of Examples 1-35, and optionally, wherein the at least one target E2E performance parameter comprises at least one of an E2E Quality of Experience (QoE), an E2E Quality of Service (QOS), an E2E delay, an E2E bandwidth, or an E2E power consumption of the network.

Example 37 includes the subject matter of any one of Examples 1-36, and optionally, wherein the network comprises a network connecting between a plurality of processors of an Artificial Intelligence (AI) training cluster.

Example 38 includes the subject matter of any one of Examples 1-37, and optionally, wherein the network comprises a communication network to communicate content between one or more content providers and a plurality of end users.

Example 39 includes the subject matter of Example 38, and optionally, wherein the network configuration controller is configured to monitor Quality of Experience (QoE) information corresponding to the plurality of end users, and to the determine the network-configuration setting based on the QoE information corresponding to the plurality of end users.

Example 40 includes the subject matter of Example 38 or 39, and optionally, wherein the at least one target E2E performance parameter corresponds to the E2E performance of the plurality of data flows over the communication network comprising a first communication network managed by a first network manager and a second communication network managed by a second network manager, the network configuration controller is configured to determine the network-configuration setting comprising a first network-configuration setting for the first network manager and a second network-configuration setting for the second network manager.

Example 41 includes the subject matter of any one of Examples 1-40, and optionally, wherein the network comprises a Clos network, or a scheduled-fabric network.

Example 42 includes the subject matter of any one of Examples 1-41, and optionally, wherein the network comprises a lossless network.

Example 43 includes the subject matter of any one of Examples 1-42, and optionally, wherein the flow information comprises information according to at least one of an Internet Protocol Flow Information Export (IPFIX) protocol, a net-flow (NETFLOW) protocol, or a Sampled Flow (SFLOW) protocol.

Example 44 includes a system comprising a network comprising a plurality of networking nodes connecting between a plurality of network inputs of the network and a plurality of network outputs of the network; a network configuration controller comprising one or more processors configured to monitor a plurality of node-related flow information sets based on flow information corresponding to a plurality of data flows between a first plurality of endpoints and a second plurality of endpoints via the network, the plurality of node-related flow information sets corresponding to the plurality of networking nodes, wherein a node-related flow information set corresponding to a networking node of the plurality of networking nodes comprises information corresponding to traffic communicated via the networking node; and determine a network-configuration setting to configure the network based on the plurality of node-related flow information sets and at least one target End to End (E2E) performance parameter, the at least one target E2E performance parameter corresponding to an E2E performance of the plurality of data flows between the first plurality of endpoints and the second plurality of endpoints; and a network controller configured to control the network based on the network-configuration setting.

Example 45 includes the subject matter of Example 44, and optionally, any of the described features of any of Examples 1-43.

Example 46 includes an apparatus comprising means for performing any of the described operations of any of Examples 1-45.

Example 47 includes a machine-readable medium that stores instructions for execution by a processor to perform any of the described operations of any of Examples 1-45.

Example 48 comprises a product comprising one or more tangible computer-readable non-transitory storage media comprising instructions operable to, when executed by at least one processor, enable the at least one processor to cause a device and/or system to perform any of the described operations of any of Examples 1-45.

Example 49 includes an apparatus comprising a memory; and processing circuitry configured to perform any of the described operations of any of Examples 1-45.

Example 50 includes a method including any of the described operations of any of Examples 1-45.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a network configuration controller comprising one or more processors configured to:
monitor a plurality of node-related flow information sets based on flow information corresponding to a plurality of data flows between a first plurality of endpoints and a second plurality of endpoints via a network, the plurality of node-related flow information sets corresponding to a plurality of networking nodes connecting between a plurality of network inputs of the network and a plurality of network outputs of the network, wherein a node-related flow information set corresponding to a networking node of the plurality of networking nodes comprises information corresponding to one or more data flows communicated via the networking node; and
determine a network-configuration setting to configure the network based on the plurality of node-related flow information sets and at least one target End to End (E2E) performance parameter, the at least one target E2E performance parameter corresponding to an E2E performance of the plurality of data flows between the first plurality of endpoints and the second plurality of endpoints; and
an output to provide output information based on the network-configuration setting.

2. The apparatus of claim 1, wherein the node-related flow information set comprises source address information to identify a network input of the plurality of network inputs corresponding to a data flow, destination address information to identify a network output of the plurality of network outputs corresponding to the data flow, source port information to identify an ingress port of the networking node corresponding to the data flow, destination port information to identify an egress port of the networking node corresponding to the data flow, length information to identify a data length corresponding to the data flow, and next-hop information to identify a next-hop networking node corresponding to the data flow.

3. The apparatus of claim 1, wherein the network configuration controller is configured to monitor the flow information, and to update the network-configuration setting based on a detected real-time change in the plurality of node-related flow information sets.

4. The apparatus of claim 3, wherein the detected real-time change in the plurality of node-related flow information sets comprises a change indictive of an expected degradation in the at least one target E2E performance parameter.

5. The apparatus of claim 1, wherein the network configuration controller is configured to determine a first network-configuration setting based on a first plurality of node-related flow information sets corresponding to first flow information related to a first time frame, and to determine a second network-configuration setting, different from the first network-configuration setting, based on a second plurality of node-related flow information sets, different from the first plurality of node-related flow information sets, corresponding to second flow information related to a second time frame subsequent to the first time frame.

6. The apparatus of claim 1, wherein the network configuration controller is configured to determine a predicted state of the plurality of data flows via the network based on the plurality of node-related flow information sets, and to determine the network-configuration setting based on the predicted state of the plurality of data flows via the network and the at least one target E2E performance parameter.

7. The apparatus of claim 1, wherein the network configuration controller comprises a Machine Learning (ML) engine trained to generate ML output information based on an ML input, which is based on the plurality of node-related flow information sets, wherein the network-configuration setting is based on the ML output information.

8. The apparatus of claim 7, wherein the network configuration controller is configured to determine network topography information corresponding to a network topography of the network based on the plurality of node-related flow information sets, wherein the ML input information is based on the network topography information.

9. The apparatus of claim 8, wherein the network configuration controller is configured to determine size-reduced network topography information by reducing a size of the network topography information based on a size of the ML input, wherein the ML input is based on the size-reduced network topography information.

10. The apparatus of claim 9, wherein the size-reduced network topography information comprises network topography information corresponding to a subset of networking nodes, the ML output information corresponding to the subset of networking nodes.

11. The apparatus of claim 7, wherein the ML engine comprises a Deep Reinforcement Learning (DRL) engine configured to generate the ML output information comprising action information based on the ML input comprising observation information and reward information, wherein the observation information is based on the plurality of node-related flow information sets, the reward information is based on the at least one target E2E performance parameter, the network-configuration setting is based on the action information.

12. The apparatus of claim 1, wherein the network configuration controller is configured to determine network topography information corresponding to a network topography of the network based on the plurality of node-related flow information sets, and to determine the network-configuration setting based on the network topography information.

13. The apparatus of claim 12, wherein the network topography information comprises a topography map to map statistical data flow sizes to a plurality of ingress-egress port pairs, the plurality of ingress-egress port pairs corresponding to a plurality of ingress ports of the plurality of networking nodes and a plurality of egress ports of the plurality of networking nodes.

14. The apparatus of claim 13, wherein the network topography information comprises a plurality of statistical ingress data sizes corresponding to the plurality of ingress ports, and a plurality of statistical egress data sizes corresponding to the plurality of egress ports, wherein a statistical ingress data size corresponding to an ingress port is based on statistical data flow sizes mapped to ingress-egress port pairs comprising the ingress port, wherein a statistical egress data size corresponding to an egress port is based on statistical data flow sizes mapped to ingress-egress port pairs comprising the egress port.

15. The apparatus of claim 12, wherein the network configuration controller is configured to determine network topology information corresponding to a network topology of the network based on the plurality of node-related flow information sets, and to determine the network topography information based on the network topology information, wherein the network topology information comprises routing information corresponding to active data flow routes between the plurality of networking nodes.

16. The apparatus of claim 1, wherein the network configuration controller is configured to determine the network-configuration setting comprising at least one ingress-port setting, the at least one ingress-port setting comprising at least one of an Explicit Congestion Notification (ECN) setting or a maximal buffer queue size setting, wherein the at least one ingress-port setting is configured such that any Priority Flow Control (PFC) event based on a PFC setting is not to occur before an ingress-port event based on the at least one ingress-port setting.

17. The apparatus of claim 1, wherein the network-configuration setting comprises one or more node-specific parameter settings corresponding to one or more networking nodes of the plurality of networking nodes.

18. The apparatus of claim 17, wherein a node-specific parameter setting of the one or more node-specific parameter settings comprises at least one of a Priority Flow Control (PFC) setting for one or more ingress ports, an Explicit Congestion Notification (ECN) setting for one or more egress ports, or a maximal buffer queue size setting for the one or more egress ports.

19. The apparatus of claim 1, wherein the at least one target E2E performance parameter comprises a Job Completion Time (JCT).

20. The apparatus of claim 1, wherein the at least one target E2E performance parameter comprises at least one of a usage efficiency corresponding to a usage efficiency of the network, an E2E Quality of Experience (QoE), an E2E Quality of Service (QOS), an E2E delay, an E2E bandwidth, or an E2E power consumption of the network.

21. The apparatus of claim 1, wherein the network comprises a network connecting between a plurality of processors of an Artificial Intelligence (AI) training cluster.

22. A system comprising:
a network comprising a plurality of networking nodes connecting between a plurality of network inputs of the network and a plurality of network outputs of the network;
a network configuration controller comprising one or more processors configured to:
monitor a plurality of node-related flow information sets based on flow information corresponding to a plurality of data flows between a first plurality of endpoints and a second plurality of endpoints via the network, the plurality of node-related flow information sets corresponding to the plurality of networking nodes, wherein a node-related flow information set corresponding to a networking node of the plurality of networking nodes comprises information corresponding to traffic communicated via the networking node; and
determine a network-configuration setting to configure the network based on the plurality of node-related flow information sets and at least one target End to End (E2E) performance parameter, the at least one target E2E performance parameter corresponding to an E2E performance of the plurality of data flows between the first plurality of endpoints and the second plurality of endpoints; and
a network controller configured to control the network based on the network-configuration setting.

23. The system of claim 22, wherein the network configuration controller comprises a Machine Learning (ML) engine trained to generate ML output information based on an ML input, which is based on the plurality of node-related flow information sets, wherein the network-configuration setting is based on the ML output information.
